(19) United States
(12) Patent Application Publication
(10) Pub. No.: US 2025/0318480 A1
(43) Pub. Date: Oct. 16, 2025

(54) CULTIVATION MEMBER, CULTIVATION SYSTEM AND PLANTING METHOD

(71) Applicant: Makoto MIHARA, Tokyo (JP)

(72) Inventor: Makoto MIHARA, Tokyo (JP)

(21) Appl. No.: 19/250,071

(22) Filed: Jun. 26, 2025

Related U.S. Application Data
(63) Continuation of application No. PCT/JP2023/042749, filed on Nov. 29, 2023.

(30) Foreign Application Priority Data
Dec. 28, 2022 (JP) 2022-211395
May 8, 2023 (JP) 2023-076949

(51) Int. Cl. A01G 24/44; A01C 1/04; A01C 11/02; A01G 9/029; A01G 24/22; A01G 24/35

(52) U.S. Cl. CPC A01G 24/44; A01C 1/04; A01C 11/02; A01G 9/0291; A01G 24/22; A01G 24/35

(57) ABSTRACT

A cultivation member including an insertion part that forms a storage structure including a flexible water-shielding film and is inserted into the inside of a planting furrow in a cultivating place. The insertion part of the cultivation member forms a storage structure, at least a part of the storage structure is surrounded by a wall and has a non-planar bottom region. By having a part of the wall of the storage structure in an open state, or by having a sliding mechanism on a part of the wall, it is possible to deform the shape of at least the upper part of the external shape defined by the storage structure. An array of a plurality of water penetration channels is in the bottom region of the storage structure. Cultivating soil is filled inside the insertion part, and a plant is planted in the cultivating soil.

### TECHNICAL FIELD

The present invention relates to a cultivation member for cultivating plants for agroforestry and greening in arid or saline areas, etc., a cultivation system for cultivating plants using the cultivation member and natural water, and a planting method for plants suitable for this cultivation system.

### BACKGROUND ART

In agroforestry and greening in barren areas such as arid and saline areas, there is a need for technology to grow plants with a minimum amount of irrigation. It is known that in arid areas, there is a soil layer (hereafter referred to as the “stable soil layer”) with a stable temperature and moisture content throughout the year at a certain depth below the surface. However, in order to allow the plant root systems of plants planted in the stable soil layer of arid areas to grow and take root, a large amount of irrigation is required. As an example, there is a report that the amount of water introduced to a depth of 60 cm or more in the soil layer is 60 to 90 liters per planted plant (see Non-Patent Literature 1).

In irrigated agricultural areas in arid regions, salts contained in irrigation water accumulate at high concentrations in the top 30-50 cm of the soil, due to evaporation of the irrigation water and other factors. As a result, the area of land affected by salinity, which makes agriculture difficult, has continued to expand since the beginning of irrigated agriculture. Therefore, in order to grow plants in arid and saline areas, there is a need for a plant cultivation technique that prevents the horizontal penetration and diffusion of irrigation water and the penetration of salts into the cultivating soil near the surface of the ground, and allows the plant root system to quickly grow and take root in the stable soil layer with a small amount of irrigation.

For example, Patent Literature 1 discloses isolation materials with perforations for easy tearing of the film when isolation is no longer necessary, which enables growth control by blocking moisture. Patent Literature 2 discloses seedling pots with a pair of overlapping biodegradable sheets, the left and right ends and lower end of which are joined by welding or other means in a discontinuous manner.

However, in the invention described in Patent Literature 1, the location of the perforations is not specified, and if the perforations are formed on the side of the container other than the lower end, the ability to control plant growth will be reduced due to moisture permeating through the perforations on the side. Furthermore, in the invention described in Patent Literature 1, the plant root system extends beyond the sides, so there is the issue that the plant root system does not necessarily extend downward selectively. In addition, in the invention described in Patent Literature 2, when the lower end of the sheet and the left and right ends are joined on three sides, there is the issue that it is necessary to prepare different seedling pots for each different planting furrow width.

### CITATION LIST

### Patent Literature

[Patent Literature 1] Patent Publication No. 2006-238874
[Patent Literature 2] Utility Model Registration No. 3177890

### Non-Patent Literature

[Non-Patent Literature 1] Kazuhiro Asami, “2017 Project to Disseminate Forest Regeneration Techniques in Developing Countries: Demonstration Experiment 2-Development of Afforestation Techniques Using Nursery Block Methods in Uzbekistan's Arid Lands”, Mar. 20, 2018, [Retrieved Dec. 19, 2022], Internet URL: https://jifpro.or.jp/wp-content/uploads/2018/03/5_trial-report_OYO.pdf

### SUMMARY OF INVENTION

### Technical Problem

In order to solve the problems of the conventional technology described above, the present invention is intended to provide a cultivation member that is easy to insert into any shape of planting furrow, including cases where the aspect ratio D/W defined by the depth D and the furrow width W is high, and has an insertion part that is difficult to rupture due to the expansion of the cultivating soil caused by the growth of the plant root system, in which the plant root system of the planted plant selectively extends downward with a small amount of irrigation, a cultivation system that uses this cultivation member to cultivate plants, and furthermore, a planting method suitable for this cultivation system. As will be explained later, in the present invention, “furrow width W” refers to the dimension measured as the narrowest width on the cross-section of the planting furrow cut in the vertical direction. Therefore, the present invention aims to provide a cultivation member with an insertion part that is inserted into a planting furrow of various shapes, including cylindrical shapes, a cultivation system that uses the cultivation member, and a planting method that is suitable for the cultivation member and cultivation system.

### Solution to Problem

In order to achieve the above-mentioned purpose, the first aspect of the present invention is a cultivation member comprising an insertion part that forms a storage structure made of a flexible water-shielding film and is inserted into an inside of a planting furrow formed by digging in a cultivating place. The insertion part of the cultivation member according to the first aspect forms a storage structure, at least a part of the storage structure is surrounded by a wall, and has a non-planar bottom region. And, by having a part of the wall of the storage structure in an open state or a sliding mechanism on a part of the wall, at least the top of the external shape defined by the storage structure can be deformed without increasing the in-plane stress of the flexible water-shielding film, thereby increasing its internal volume. Furthermore, a plurality of water penetration channels is arranged one-dimensionally in the bottom region of the storage structure. The interior of the insertion part of the cultivation member according to the first aspect is filled with cultivating soil, and a plant is planted in the filled cultivating soil and this plant is grown.

The second aspect of the present invention is a cultivation system that has a ground in which a planting furrow is formed by digging so that the opening of the planting furrow is located at the level of the lower end of the slope in a cultivating place with a sloping surface, and an insertion part of a cultivation member that is inserted in the interior of the planting furrow to form a storage structure. In the second aspect of the present invention, the planting furrow of the cultivation system has a depth that is at least five times greater than the furrow width, which is measured as the furrow's narrowest width on a cross-section cut vertically. Furthermore, the insertion part has a sliding mechanism on part of the wall, or part of the wall is open, so that the shape of at least the upper part of the external shape defined by the storage structure can be deformed without increasing the in-plane stress of the flexible water-shielding film, thereby increasing the internal volume. In the cultivation system according to the second aspect of the present invention, cultivating soil is filled inside the insertion part, and plants are planted in the filled cultivating soil and allowed to grow.

The third aspect of the present invention is a planting method that includes the steps of (a) digging a planting furrow so that the opening is located at the level of the lower end of the slope in a cultivating place with a sloping surface, (b) inserting an insertion part having a storage structure made of a flexible water-shielding film into the planting furrow, (c) filling the cultivating soil into the inside of this insertion part, (d) seeding or planting seeds and seedlings in this cultivating soil, and (e) irrigating on the planted seeds and seedlings. In the planting method according to the third aspect of the present invention, the planting furrow has a depth that is at least five times greater than the furrow width, which is measured as the narrowest width on a vertical cross-section, and the insertion part has a sliding mechanism on part of the wall or part of the wall is open, so that the shape of at least the upper part of the external shape defined by the storage structure can be deformed without increasing the in-plane stress of the flexible water-shielding film, and the internal volume can be increased.

The fourth aspect of the present invention is a planting method that includes the steps of (p) preparing an insertion part that forms a storage structure, at least a part of the storage structure is surrounded by a wall made of a flexible water-shielding film, and has a one-dimensional array of a plurality of water penetration channels in the bottom region of this storage structure, (q) elevating and rotating an auger having a drill tip and a hollow part that can be opened and closed, inserting the auger into the ground of the planting site, and forming the planting furrow in the ground; (r) storing the insertion part filled with cultivating soil in the hollow part from the open insertion part located on the opposite side of the bottom region, (s) removing the auger from the ground while leaving the insertion part inside the planting furrow, and (t) planting seeds and seedlings in the cultivating soil, irrigating through the opening, and allowing some of the irrigation (water) to leak outside through a plurality of water penetration channels. In the planting method according to the fourth aspect of the present invention, the insertion part has a sliding mechanism on a part of the wall, so that the shape of at least the upper part of the external shape defined by the storage structure can be deformed without increasing the in-plane stress of the flexible water-shielding film, and the internal volume can be increased.

### Effect of the Invention

According to the present invention, it is possible to provide a cultivation member that is easy to insert into any shape of planting furrow, including those with a high aspect ratio, and that has an insertion part that is difficult to rupture due to the expansion of the cultivating soil caused by the growth of the plant root system, a cultivation system that uses this cultivation member to cultivate plants, and a planting method for plants that is suitable for this cultivation system.

### BRIEF DESCRIPTION OF THE DRAWINGS

FIG. 1A is a perspective view of the cultivation member pertaining to the first embodiment of the present invention, showing the structure of the insertion part of the cultivation member, which is formed by bending one flexible water-shielding film.

FIG. 1B is a exploded view of FIG. 1A before bending.

FIG. 2A is a perspective view of the cultivation member pertaining to the third embodiment of the present invention, showing the structure of the insertion part of the cultivation member formed from two flexible water-shielding films.

FIG. 2B is a exploded view corresponding to FIG. 2A.

FIG. 3A is a perspective view of the cultivation member of the fourth embodiment of the present invention, showing the structure of the insertion part of the cultivation member formed from four flexible water-shielding films.

FIG. 3B is a exploded view corresponding to FIG. 3A.

FIG. 4A is a perspective view of the cultivation member for the fifth embodiment of the present invention, showing the structure of the insertion part of the cultivation member formed from one flexible water-shielding film.

FIG. 4B is a step view corresponding to FIG. 4A.

FIG. 5 is a schematic view illustrating the cultivation system for plants using natural water for the first embodiment of the present invention, showing a configuration with a laying member for one-side inclined body.

FIG. 6A is a schematic view illustrating a plant cultivation system using natural water that is related to another embodiment (the second embodiment) of the present invention, showing a cultivation system configuration with laying members on the both-sides inclined body.

FIG. 6B is a schematic view illustrating a plant cultivation system using natural water that is related to a variant of the second embodiment of the first embodiment, showing a cultivation system configuration with laying members on the both-sides inclined body.

FIG. 7A is a schematic view illustrating the cultivation members of the second embodiment of the present invention and the cultivation system using these cultivation members.

FIG. 7B is a schematic view illustrating the cultivation system for plants of the first variant of the second embodiment.

FIG. 7C is a schematic view illustrating the cultivation system for plants of the second variant of the second embodiment.

FIG. 8 is a schematic view illustrating the structure of the mobile planting apparatus used in the planting method of the 5th embodiment of the present invention.

FIG. 9A is a schematic view illustrating the process of descending the auger of the mobile planting apparatus while rotating it to dig the ground in a vertical direction.

FIG. 9B shows the state of the auger being removed upwards from the state in FIG. 9A.

FIG. 10A is a schematic view illustrating the state of the cultivation members used in the buckwheat cultivation test being stored in the planting box.

FIG. 10B is a schematic view illustrating the state of the cultivation members used in the comparative example 1 being stored in the planting box.

FIG. 10C is a schematic view illustrating the test cultivation area of the comparative example 2 as a buckwheat cultivation test that does not use cultivation members.

FIG. 11A is a perspective view from the upper front of the cultivation member of the first variant of the 5th embodiment of the present invention.

FIG. 11B is a view explaining the shape of one flexible water-shielding film that consists the cultivation member of the first variant of the 5th embodiment.

FIG. 11C is an magnified view of part A of the cultivation member of the first variant of the fifth embodiment shown in FIG. 11A.

FIG. 11D is a side view of the cultivation member of the first variant of the 5th embodiment shown in FIG. 11A.

FIG. 12A is a bottom view of the cultivation member of the first variant of the 5th embodiment, FIG. 12B is a bottom view of the cultivation member of the second variant of the 5th embodiment, FIG. 12C is a bottom view of the cultivation member of the third variant of the 5th embodiment, and FIG. 12D is a bottom view of the cultivation member of the fourth variant of the 5th embodiment.

FIG. 13A is a perspective view from the upper front showing the case where cultivating soil is filled inside the cultivation member from the state shown in FIG. 11A.

FIG. 13B is a side view showing the case where cultivating soil is filled inside the cultivation member from the state shown in FIG. 11D.

FIG. 13C is a bottom view showing a part of the bottom surface when cultivating soil is filled inside the cultivation member.

FIG. 14 is a magnified view of part of FIG. 13C.

FIG. 15 is a cross-section view showing an example of the use of a cultivation member with the same structure as the cultivation member of the first variant of the 5th embodiment of the present invention.

FIG. 16 is a perspective view showing an example of the use of a cultivation member with the same structure as the cultivation member of the first variant of the 5th embodiment of the present invention.

FIG. 17 is a perspective view of the cultivation member of the first variant of the 5th embodiment of the present invention, seen from the upper front side.

FIG. 18A is a perspective view showing an example of the use of a cultivation member in the 6th embodiment of the present invention.

FIG. 18B is a cross-section view of the cultivation member in FIG. 18A viewed from the A-A direction.

FIG. 18C is a cross-section view showing another example of the use of a cultivation member in the 6th embodiment of the present invention.

FIG. 19 is a perspective view showing an example of the use of a cultivation member in the first variant of the 5th embodiment of the present invention.

FIG. 20 is a perspective view of the cultivation member of the 5th embodiment of the present invention.

FIG. 21A is a perspective view of an example of the use of the cultivation member of the first variant of the 6th embodiment of the present invention.

FIG. 21B is a cross-section view of the cultivation member of the first variant of the 6th embodiment of the present invention viewed from the A-A direction of FIG. 21A.

FIG. 21C is a cross-section view of an example of the use of the cultivation member of the first variant of the 6th embodiment of the present invention.

FIG. 22 is a perspective view showing an example of the use of a cultivation member related to a second variant of the 6th embodiment of the present invention.

FIG. 23A is a perspective view of a cultivation member related to the 7th embodiment of the present invention.

FIG. 23B is a exploded view of a cultivation member related to the 7th embodiment of the present invention.

FIG. 23C is an magnified view of part A of FIG. 23B rotated.

FIG. 23D is a perspective view of FIG. 23C.

FIG. 24 is a schematic view illustrating a method of constructing a long connecting cultivation member by superimposing a plurality of cultivation members in a cultivation system of the 7th embodiment of the present invention.

FIG. 25A is a schematic view of a cultivation member of a variant of the 7th embodiment of the present invention.

FIG. 25B is a view illustrating the two flexible water-shielding films used as raw materials for the cultivation member of the variant of the 7th embodiment shown in FIG. 25A.

### DESCRIPTION OF EMBODIMENTS

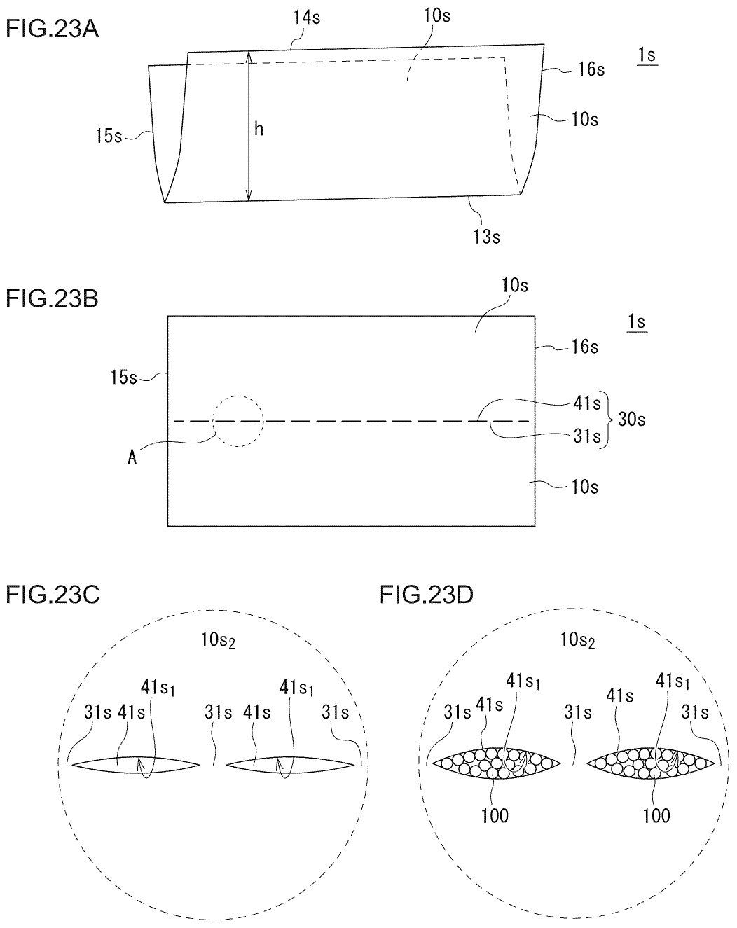

The following is a detailed explanation of the first to 7th embodiments of the present invention and some variant examples of the embodiments, with reference to the drawings. In this document, the expression “storage structure” is used as a concept that may include a structure in which the both ends are open and the object is held and stored in a manner similar to a two-fold folder (document holder). Therefore, if the structure is capable of storing objects such as cultivating soil when inserted into the planting furrow, and at least part of the structure for storing the object is enclosed by a wall, it shall be deemed to mean a “storage structure”. Embodiments 1 to 6 describe a storage structure that is similar to a bag and stores the target cultivating soil, but 7th embodiment, which will be described later, describes a storage structure that has an open structure with a U-shaped window at the left side end 15s and right side end 16s, as shown in FIG. 23A. In other words, in this document, even if the structure has open ends as shown in FIG. 23A, it is referred to as a “storage structure” in the broad concept.

The flexible water-shielding film used in the insertion part described in the following embodiments 1 to 7 and related embodiment variations (hereinafter referred to as “embodiments 1 to 7, etc.”) is a film that has passed a water resistance test using either JIS L 1092A (low water pressure method), International Organization for Standardization (ISO) 811, or American Association of Textile Chemists and Colorists (AATCC) 127, if it has a water resistance (hydrophobicity) of 400 mmH20 (=3.9 kPa) or more, and preferably 800 mmH20 (=5.9 kPa) or more. The thickness of the flexible water-shielding film used for the insertion part of the cultivation member described in embodiments 1 to 7, etc., is 10 to 250 μm, preferably 40 to 100 μm thick. If the thickness is 250 μm or more, as is the case with sheets referred to as “sheets” in JIS and Europe and America, it becomes difficult to deform the insertion part when inserting it into planting furrows of various sizes and shapes, including planting furrows with an aspect ratio D/W of 5 or more, and it is difficult to insert it into the planting furrow. On the other hand, if the flexible water-shielding film is 10 μm or less thick, the strength of the insertion part decreases.

There are no particular restrictions on the flexible water-shielding film used for the insertion part of the cultivation member as described in the following embodiments 1 to 7, etc., as long as it is 3.9 kPa or more in a water resistance test. For example
(1) A single water-shielding film (hereinafter referred to as “single water-shielding film”) made by film forming of hydrophobic resin such as polyolefin, polydiene, polyisoprene, polyvinyl chloride, polylactide, or aliphatic polyester using the inflation method or T-die method
(2) A composite water-shielding film in which the hydrophobic resin film described in (1) is laminated to a plant fiber base material made from paper, non-woven fabric, or woven fabric made from wood pulp, recycled paper, hemp fiber, cotton fiber, bagasse fiber, palm fiber, banana fiber, corn leaf fiber, or other plant tissue (hereinafter referred to as a “laminated composite water-shielding film”); and
(3) A composite water-shielding film in which the plant fiber base material described in (2) above is coated or impregnated with liquid hydrophobic materials such as natural rubber latex, poly-diene latex, acrylic emulsion, ethylene-vinyl acetate emulsion, wax emulsion, silicone oil, and fluorine-based solvents (hereinafter referred to as a “coating/impregnation composite water-shielding film”); and
(4) A composite water-shielding film made by adding the liquid hydrophobic material described in (3) to the water-dispersed slurry of the plant fibers that consists of the plant fiber base material described in (2) and then making paper from it (hereinafter referred to as “internally added paper composite water-shielding film”), can be used. The “laminated composite water-shielding film” can be either a single-sided laminated water-shielding film with a two-layer structure or a three-layer structure.

In this specification, the hydrophobic resins such as polyolefin, polydiene, polyisoprene, polyvinyl chloride, polylactide, or aliphatic polyester described above are referred to as “hydrophobic materials of Category 1”. In addition, liquid hydrophobic materials such as natural rubber latex, poly-diene latex, acrylic emulsions, ethylene-vinyl acetate emulsions, wax emulsions, silicone oil, and fluorine-based solvents are referred to as “Category 2 hydrophobic materials”. Other known additives such as fillers, lubricants, antioxidants, surfactants, and paper strength enhancers can be added to hydrophobic materials or plant fiber substrates. Among the hydrophobic materials in Category 1, biodegradable materials are preferable, and examples include polyisoprene, polylactic acid, fatty acid polyesters, polyolefins to which metal salts of fatty acids have been added, and hydrolyzable polyolefins. Among the hydrophobic materials in the second category, biodegradable materials are preferred, and examples include natural rubber, beeswax, Japan wax, carnauba wax, candelilla wax, rice bran wax, palm wax, jojoba oil, and paraffin wax with a carbon number of 20 to 36.

As biodegradable materials for the composite water-shielding film, known synthetic biodegradable materials or biodegradable materials of natural origin from plants or animals can be used. Synthetic biodegradable materials are broadly classified into hydrolytic and oxidative degradation types based on their biodegradation mechanism, but either type of material can be used. Hydrolytic biodegradable materials include polylactic acid, modified starch, and aliphatic polyesters, while oxidative biodegradable materials include polyolefin composites with added fatty acid metal salts, etc. Natural material-based biodegradable materials include fibers, paper, and films made primarily from starch and cellulose. When the insertion part with a composite water-shielding film made of biodegradable material is used for planting, the composite water-shielding film is biodegraded after a certain period of time and does not remain in the ground 200, so the environmental load can be reduced.

The chemical material of the hydrophobic layer of the composite water-shielding film of the insertion part of the cultivation member of embodiments 1 to 7 may include cis-1,4 polyisoprene. Cis-1,4 polyisoprene is a main component of natural rubber, natural rubber latex, synthetic polyisoprene, epoxidized polyisoprene, and vulcanized rubber thereof (hereinafter collectively referred to as “isoprene rubber (IR)”). IR has the flexibility derived from its double bonds and the hydrophobicity derived from its non-polar polymer, and can be used as a raw material for a composite water-shielding film that are biodegradable in a certain period of time in ground 200. Composite water-shielding film can be obtained either as a single water-shielding film made from natural rubber or synthetic polyisoprene, or as a composite water-shielding film with a substrate made of natural rubber latex. The plants that produce natural rubber latex, such as Para rubber trees, guayule, and Russian dandelions, absorb carbon dioxide during plant growth. The composite water-shielding film obtained by soaking the natural rubber latex sap collected from these producing plants in a plant fiber base material can be used in the manufacture of insertion parts in low-environmental load steps, as containers that can be “degraded over time,” and for biodegradation after the mission is complete.

In the following drawings, the same or similar parts are marked with the same or similar symbols. However, it should be noted that the drawings are schematic and the ratios of the dimensions of the various parts differ from the actual dimensions. Therefore, the dimensions of the specific structure, etc., should be determined by referring to the following explanations. Of course, the drawings also include parts that differ in terms of the relationship and ratio of their dimensions to each other. In addition, the first to seventh embodiments of the present invention and their variant examples shown below are examples of the structure and method of the article to embody the technical idea of the present invention, and the technical idea of the present invention does not specify the material, shape, structure, arrangement, etc. of the constituent parts as follows. The technical idea of the present invention can be modified in various ways within the technical scope described in the scope of the claims.

### First Embodiment

### =Cultivation Member=

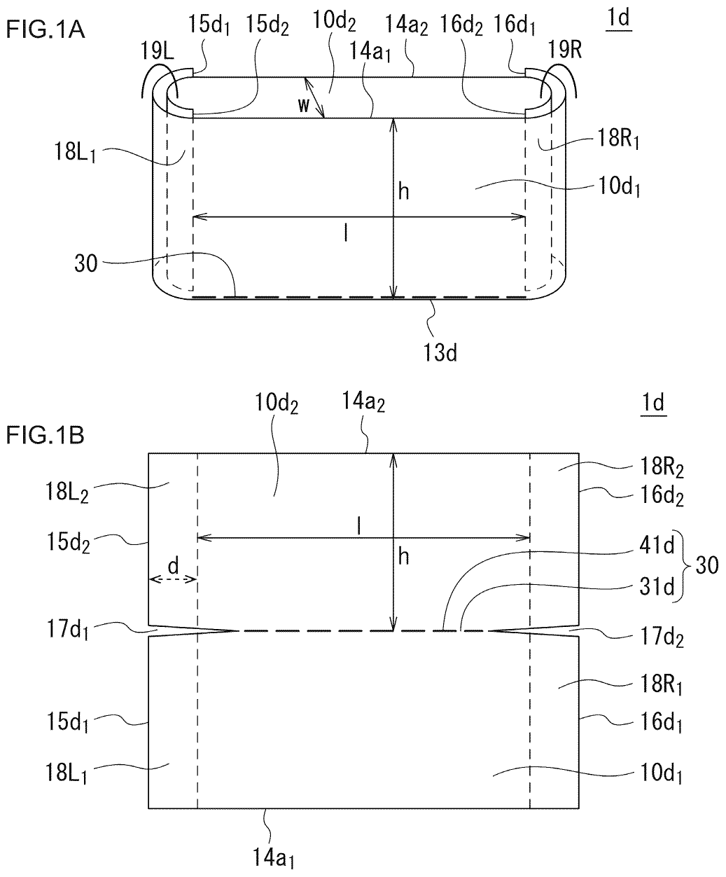

In the first embodiment of the present invention, the insertion part 1d of the cultivation member is, before the cultivating soil 100 is filled into the insertion part 1d, consisted of a single flexible water-shielding film, which is folded into a V-shape at the lower end 13d as shown in FIG. 1A, or folded into a U-shape so that the lower end 13d becomes the center line, to form part (the main part) of the storage structure. The flexible water-shielding film can be either the single water-shielding film or the composite water-shielding film described at the beginning of this document. In FIG. 1A, the V-shape or U-shape is not clearly shown, but in the structure folded into a V-shape or U-shape, the upper end of the first main wall surface 10d₁ and the upper end of the second main wall surface 10d₂ are configured to face each other. The face-to-face distance w is defined between the upper end 14a₁ of the first main wall 10d₁ and the upper end 14a₂ of the second main wall 10d₂, which is almost parallel to the upper end 14a₁. Even if the structure is folded into a V shape, when the cultivating soil 100 is filled into the insertion part 1d, the V shape becomes a U shape.

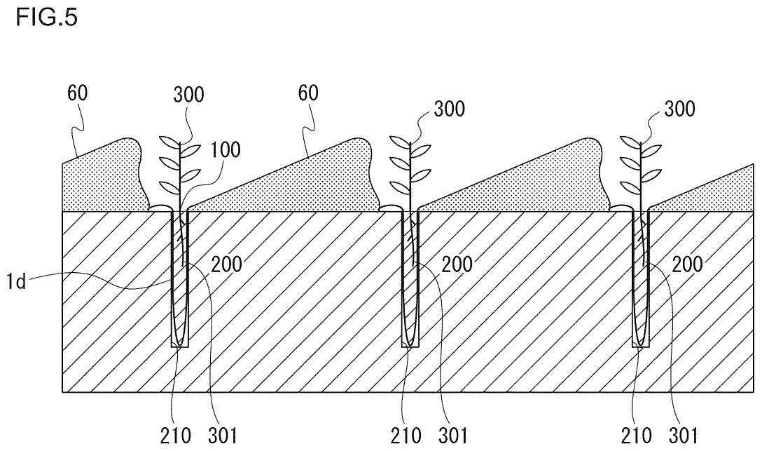

Therefore, except in cases where the V-shaped folded structure is strictly distinguished, the folded structure of the insertion part 1d of the cultivation member of the first embodiment is referred to collectively as a U-shaped structure (also referred to as a “U-shaped structure”) in the following. The cultivation member of the first embodiment has a U-shaped structure in which the upper end 14a₁ and 14a₂ are opposite each other with a face-to-face distance w, the main part of the insertion part 1d, and the shape of the storage structure is formed by adding auxiliary pieces 18L₁, 18L₂, 18R₁, and 18R₂ to this main part. The insertion part 1d, which has the main part of the U-shaped structure, is inserted into the inside of a planting furrow 210, etc., formed by digging in a cultivating place, as illustrated in FIG. 5, etc. In this specification, the term “planting furrow” is also used to refer to the hole that is close to a cylindrical shape, as explained in the following fifth embodiment. The insertion part 1d is composed of a superimposed surface structure in which the two superimposed curved surfaces intersect each other from opposite directions, by combining and superimposing the auxiliary pieces 18L₁, 18L₂, 18R₁, and 18R₂ on each side of the U-shaped structure that is part of the wall that defines the storage structure. This superimposed surface structure forms a sliding mechanism in which the superimposed curved surfaces slide against each other, and the action of the sliding mechanism forms a means of making the internal volume of the insertion part 1d variable.

In other words, because the insertion part 1d has a sliding mechanism, it is possible to increase the internal volume without causing significant tension in the plane direction of the flexible water-shielding film. Because the increase in internal volume does not cause significant tension, the in-plane stress in the plane direction of the flexible water-shielding film (hereinafter referred to as “in-plane stress”) does not increase to a significant level that induces rupture. Because the insertion part 1d has a sliding mechanism, the deformation of at least the upper end of the storage structure consumes the volume of the gap space set between the planting furrow 210 and the insertion part 1d, without increasing the in-plane stress to a significant level. In this specification, the term “structure-supported stress-free variability” is used to refer to the function or feature of being able to change the internal volume without increasing the in-plane stress of the film, due to the feature of the storage structure itself or the action of a special mechanism added, in order to clearly distinguish it from the case where a flexible film changes the internal volume with an increase in in-plane stress.

As shown in FIG. 1B, the insertion part 1d of the cultivation member of the first embodiment has a structure in which one flexible water-shielding film is folded into a U-shaped, for the sake of convenience, in the folded structure, and the insertion portion 1d has a first main wall surface 10d₁ and a second main wall surface 10d₂, which are defined as two main wall surfaces, as the main parts of the insertion portion 1d. FIG. 1A shows schematically that the upper sides of the first main wall 10d₁ and the second main wall 10d₂, which form the main part, face each other to form a U-shaped opposing structure. The storage structure shown in FIG. 1A is a structure in which the opening that occurs on the left side end of the U-shaped opposing structure is closed by the left closing mechanism 19L, which functions as a sliding mechanism, and the opening that occurs on the right side end is closed by the right closing mechanism 19R, which functions as a sliding mechanism. Although it is difficult to understand from the expression in FIG. 1A, the bottom region that makes up the storage structure of the insertion part 1d of the cultivation member of the first embodiment is non-planar because it is folded in a V-shape or U-shape with the lower end 13d as the starting point or center.

When planting and growing plant 300, it is necessary to consider that the internal volume of the insertion part 1d of the cultivation member of the first embodiment has three different sizes and that the internal volume has structure-supported stress-free variability. That is, as shown in FIG. 5, when the insertion part 1d is inserted into the inside of the planting furrow 210, the internal volume is referred to Vᵢₙₛₑᵣₜ, and the internal volume when the insertion part 1d is inserted into the planting furrow 210 and the cultivating soil 100 is filled into the insertion part 1d is referred to V_{charge}, and the internal volume caused by the expansion of the cultivating soil 100 due to the growth of the plant root system 301 after the plant 300 is planted in the cultivating soil 100 filled into the insertion part 1d is referred to V_{growth}. It is preferable that these three types of internal volume satisfy the following equation:

$${V}_{i n s e r t} < {V}_{c h a r g e} < {V}_{growth} \qquad ( 1 )$$

The internal volume Vᵢₙₛₑᵣₜ is not the internal volume of the empty insertion part 1d, but may be filled with a small amount of cultivating soil 100 as a weight.

In other words, because it has a structure that supports variable stress due to the sliding mechanism, if the internal volume of the insertion part 1d is set to Vᵢₙₛₑᵣₜ<V_{charge}, so that it is smaller than the width W and length L of the planting furrow 210 in the initial state, the work of inserting the insertion part 1d into the planting furrow 210 becomes easier and more sure, and work efficiency increases. Here, “furrow width W” is the dimension measured as the narrowest width on a cross-section of the planting furrow 210 cut in the vertical direction. If the planting furrow 210 is a rectangle (rectangular) consisting of a long side and a short side, the width measured in the short side direction of the rectangle is the furrow width W, and the “furrow length L” is the length measured in the long side direction of the rectangle of the planting furrow 210. Considering the structure supported stress-free variability, by setting the internal volume of the insertion part 1d as Vᵢₙₛₑᵣₜ<V_{charge} in formula (1), a gap space is generated between the inner wall of the planting furrow 210 and the outer wall of the insertion part 1d. After inserting the insertion part 1d into the inside of the planting furrow 210, part of the gap space is filled by filling the insertion part 1d with cultivating soil 100 and by irrigation.

The condition of V_{charge}<V_{growth} in formula (1) is an inevitable consequence of the growth of the plant root system 301 of the plant 300, but because the insertion part 1d has a structure-supported stress-free variability” due to the sliding mechanism, it is easy to increase the internal volume of the insertion part 1d so that it consumes the volume of the remaining gap space between the inner wall of the planting furrow 210 and the outer wall of the insertion part 1d after filling with cultivating soil 100 or after irrigation it is easy to increase the internal volume of the insertion part 1d so that it consumes the volume of the remaining gap space after filling the cultivating soil 100 or after watering. Therefore, in the process of increasing the internal volume of V_{charge}→V_{growth} using structure-supported stress-free variability, the insertion part 1d can be prevented from rupture, and the reliability of the insertion part 1d can be improved. As can be seen in FIG. 5, etc., There is a gap space between the planting furrow 210 and the insertion part 1d, and depending on the filling of the cultivating soil 100, irrigation, or the growth of the plant root system 301, the increase in V_{charge}→V_{growth} progresses moment by moment, and the volume of the gap space is gradually run out.

The insertion part 1d has an intermittent joint 30 that selectively and over time (temporarily) ruptures (hereinafter referred to as “selective temporal rupture”) at the position of the folding line corresponding to the bottom region intermittent joint 30 is provided. The “intermittent joint 30” refers to a joint (repeated structure) that intermittently joins the first main wall surface 10d₁ and the second main wall surface 10d₂ at the position of the folding line (bottom region).

In the bottom region (position of the folding line), the first main wall surface 10d₁ and the second main wall surface 10d₂ are continuous, and the bonded part (continuous part) 31d that bonds the first main wall surface 10d₁ and the second main wall surface 10d₂ to each other, and the non-bonded part 41d separated by dot-like or slit-like perforation, are alternately arranged in a one-dimensional manner and are continuous. A selective rupture process progresses moment by moment from the opening of the flexible water-shielding film provided in the non-bonded part 41d to the periphery of the opening of the non-bonded portion 41d. This selective rupture around the perforation progresses over time as water from irrigation penetrates the plant fiber base material exposed at the perforation of the non-bonded part 41d, and after a predetermined period of time, the intermittent joint 30 ruptures. The selective temporal rupture of the intermittent joints 30 has the effect of promoting the selective downward extension of the plant root system of the planted plant with a small amount of irrigation.

The flexible water-shielding film that enables selective temporal rupture can be any of the following: a single water-shielding film, a laminate composite water-shielding film, a coating-impregnation composite water-shielding film, or an internal-mixing paper composite water-shielding film, as described at the beginning of the embodiment. Even if the insertion part 1d is consist of a single film of hydrophobic material (a single water-shielding film), it is possible to rupture selectively the intermittent joint 30 of the insertion part 1d over time using the following temporal rupture mechanism. That is, through the cultivating soil 100 filled inside the insertion part 1d by irrigation, water leaks from the non-bonded part 41d of the intermittent joint 30 into the soil below over time. The plant root system 301 of the planted plant then follows the water due to the moisture-sensitivity of the plant root system 301, enters the non-bonding part 41d of the intermittent joint 30, and expands the opening area of the non-bonded part 41d by causing the plant root system 301 to grow and expand. As a result of the expansion of the opening area of the non-bonding part 41d, the bonded parts 31d (depending on the bonding method) shrinks and tears the bonded part 31d, and the intermittent joint 30 selectively ruptures over time. In each of the non-bonded parts 41d provided as break lines in the intermittent joints 30, plant root systems 301 which have a thin tip and grow thicker over time, cause selective temporal rupture by thickening the penetration diameter of the non-bonded part 41d such as drill or trimmer. The effect of selectively causing intermittent joints 30 to rupture over time, even in the case of a single water-shielding film, is referred to in this specification as the “root hydrotropism expansion effect”.

As described above, in the case of flexible water-shielding film that consists of the insertion part 1d, it is possible to selectively cause intermittent joints 30 to rupture over time whether they are composite water-shielding films or single-layer films of hydrophobic materials.

In the case where the insertion part 1d is made of a composite water-shielding film, the selective, temporal rupture of the intermittent joints 30 occurs more efficiently due to the root hydrotropism expansion effect of the plant root system 301 being added to the effect of the decrease in the hydrogen bonding force of the plant fibers that consist of up the composite water-shielding film. The method of perforating through-holes that become the non-bonded parts 41d of the intermittent joints 30 can be, for example, a method of cutting along the lower end 13d, which is the part of one piece composite water-shielding film that is to be folded, in a break line by using a rotary cutter with intermittent blades around its circumference, perforating with a sewing machine, or a method of perforating by a laser beam. The perforated cut area by a rotary cutter with an intermittent blade around the circumference becomes a non-bonded part 41d, and the non-cut area becomes a plurality of bonded part 31d, and the non-bonded part 41d and bonded part 31d are arranged in a one-dimensional array in an alternating manner.

For a rotary cutter with intermittent blades, the ratio of the length of the blade groove between the blades to the circumference can be changed, and the ratio of the length of the lower end 13d measured in the longitudinal direction to the non-bonded part 41d and the bonded part 31d can be adjusted. The ratio of the length of the non-bonded part 41d and the bonded part 31d, measured in the longitudinal direction of the lower end 13d, can be adjusted to control the rupture resistance of the lower end 13d and the starting time at which selective temporal rupture begins. From the perspective of the rupture resistance of the lower end 13d and the starting for selective temporal rupture, it is preferable that the ratio of the length of the non-bonded part 41d and the bonded part 31d measured in the longitudinal direction of the lower end 13d is longer than the length of the bonded part 31s. Here, “length” refers to the distance between adjacent non-bonded part 41d and bonded part 31d. For example, the length of the non-bonded part 41s is 2 or more, preferably 10 or more, compared to the length of the bonded part 31s, which is 1. The periodic structure of the intermittent joint, in which the length of the non-bonded part 41d is longer than the length of the bonded part 31d, can be achieved by making the deletion length around the blade of the rotary cutter longer than the remaining length. In the intermittent joint with a periodic structure in which the length of the non-bonded part 41d is longer than the bonded part 31d, the plant root system 301 is easily able to push open and enlarge the void of the non-bonded part 41d, and the selective downward extension of the plant root system 301 is not inhibited.

As explained at the beginning of the section on the first embodiment, the expression “storage structure” is used in this document to refer to a concept that includes structures that are not strictly bags. The non-bonded parts 41 constitute of the penetration channel for water along the vertical direction. Since a penetration channel is provided for a small amount of irrigation water to leak in the vertical direction from each of the plurality of non-bonded parts 41d arranged in a one-dimensional direction, this is also a structure that cannot be said to be a completely sealed bag. Therefore, in this document, the storage structure is also referred to as a “pseudo-sack”. In addition, a pseudo-sack that lacks a flat bottom is referred to as a “pseudo-sack with a missing bottom”, and this expresses the feature of the structure having a non-flat bottom region of the insertion part 1d.

In other words, in the structure of the insertion part 1d of the cultivation member of the first embodiment, the main wall surface that is folded and positioned on the far side of FIG. 1A is defined as “second main wall surface 10d₂” for convenience, and the storage surface that has a rectangular flat surface with a height h and width l positioned on the near side is defined as “first main wall surface 10d₁” for convenience. In FIG. 1B, the surface of the flexible water-shielding film located above the folding line (center line) becomes the apparent second main wall surface 10d₂, which includes the rectangular area of h×l, and the surface of the flexible water-shielding film located below becomes the apparent first main wall surface 10d₁. The band region that includes the folding line in FIG. 1B as its central line is defined as the “bottom region” in the insertion part 1d of the cultivation member pertaining to the first embodiment. Within the band region with a width of Δh that is less than 10% of the height h shown in FIG. 1B, the first bottom region is defined on the first main wall surface 10d₁ on the upper side of the folding line, and the second bottom region is defined on the second main wall surface 10d₂ on the lower side of the folding line.

The insertion part 1d of the cultivation member in the first embodiment is characterized by being composed of a single flexible water-shielding film that is folded. In other words, the insertion part 1d of the cultivation member in the first embodiment is consist of one flexible water-shielding film that is folded at the lower end 13d shown at the bottom of FIG. 1A, and has a structure in which the film is the structure is based on an apparent opposing structure. The first main wall 10d₁ and the second main wall 10d₂ are opposed by folding in a U-shape, and the curved part of this U-shape corresponds to the bottom region of the insertion part 1d. Therefore, the insertion part 1d of the cultivation member of the first embodiment has a structure with a non-planar bottom region.

The second main wall surface 10d₂ of the insertion part 1d of the cultivation member of the first embodiment has a lower end 13d that forms a folding line, a third side end 15d₂ that is perpendicular to the longitudinal direction of this lower end 13d, and a fourth side end 16d₂ that is separated from one end defined by the third side end 15d₂ and is the other end that is parallel to and opposite to this one end, and a hexagonal thin film surface that includes a rectangular area with a height of h and a width of 1. Since the rectangular area of h×l occupies the main area of the second main wall surface 10d₂, if the right-angled trapezoidal auxiliary pieces 18L₁, 18L₂, 18R₁, and 18R₂, which have tapered sides on the lower side at both ends, are approximated as rectangles, the second main wall surface 10d₂ can be approximated as an approximately rectangular area. The first main wall 10d₁ shown in FIG. 1A has a first side end 15d₁ that is opposite to the third side end 15d₂ of the second main wall 10d₂ and is separated from the third side end 15d₂. Furthermore, the first main wall 10d₁ is in the state shown in FIG. 1A and is opposite the fourth side end 16d₂ of the second main wall 10d₂, separated from the first side end 15d₁, and has a second side end 16d₁ that is parallel to the first side end 15d₁. The first main wall surface 10d₁ is a thin film surface of the same shape and size as the second main wall surface 10d₂, as shown in FIGS. 1A and 1B.

The first left auxiliary piece 18L₁ of the first main wall 10d₁ is a right-angled trapezoidal strip piece (hereinafter referred to as an “auxiliary wall”) that is curved and is planned to be rolled in, with the first side end 15d₁ as the upper base and a height of d, and is arranged on the left side of the first main wall 10d₁, and the first right auxiliary piece 18R₁ is a right-angled trapezoid auxiliary wall with the second side end 16d₁ as its upper base and a height of d, positioned to the right of the first main wall 10d₁, and is in a mirror image relationship with the first left auxiliary piece 18L₁. On the other hand, the second left auxiliary piece 18L₂, which is provided on the second main wall 10d₂, is a right-angled trapezoid auxiliary wall with the third side end 15d₂ as its upper base and is a right-angled trapezoid auxiliary wall with a height of d and located on the left side of the second main wall 10d₂, and the second right auxiliary piece 18R₂ is a right-angled trapezoid auxiliary wall with a height of d and located on the right side of the second main wall 10d₂, with the fourth side end 16d₂ as the upper base, and is in a mirror image relationship with the second left auxiliary piece 18L₂.

Furthermore, in the exploded view of FIG. 1B, there are two isosceles triangles cut from both sides of the break line indicating the intermittent joint 30 provided in the bottom region, and the vertices of the isosceles triangles are located at both ends of the break line in the center of the bottom region. The lower oblique side of the isosceles triangle on the left is extended to the oblique side of the right-angled trapezoid that consist of the first left auxiliary piece 18L₁, and the upper oblique side is extended to the oblique side of the right-angled trapezoid that consist of the second left auxiliary piece 18L₂, forming an enlarged isosceles triangle cutout. The lower oblique side of the isosceles triangle on the right is extended to the oblique side of the right-angled trapezoid that consist of the first right auxiliary piece 18R₁, and the upper oblique side is extended to the oblique side of the right-angled trapezoid that consist of the second right auxiliary piece 18R₂, forming an incised parts of an enlarged isosceles triangle (hereinafter referred to as “enlarged isosceles triangle”).

The process of selective rupture of the flexible water-shielding film also progresses over time from the cut part of the enlarged isosceles triangle, and assists in the selective, temporal rupture of the intermittent joint 30. In other words, if the flexible water-shielding film that consist of the insertion part 1d is made of a composite water-shielding film with a hydrophobic material on the inner wall side of the insertion part 1d, water from irrigation will penetrate the plant fiber base material exposed in the enlarged isosceles triangle cutout, as shown on both sides of the center of FIG. 1B. As the water from irrigation penetrates over time, it moves towards the apex of the enlarged isosceles triangle, i.e. the direction of the fold line in the center of FIG. 1B, and this causes the hydrogen bonding force of the plant fibers that consist of the composite water-shielding film to decrease, so after the preset time has elapsed, the intermittent joint 30 rupture selectively. It is also possible to cut off the first left auxiliary piece 18L₁, the second left auxiliary piece 18L₂, the second right auxiliary piece 18R₂ and the second left auxiliary piece 18L₂, which are auxiliary trapezoidal walls, from both sides of the h×l rectangular area by a length of d, and use them as auxiliary walls for reinforcement. In order to prevent the left closing mechanism 19L and right closing mechanism 19R from rupture, the left closing mechanism 19L and right closing mechanism 19R can be constructed by stacking additional reinforcement auxiliary walls on the left closing mechanism 19L and right closing mechanism 19R, thereby creating a sliding mechanism with a superimposed surface structure of three or more layers.

In FIG. 1B, the enlarged isosceles triangle cut in from the left of the dashed line in the center of the bottom region gives the first left auxiliary piece 18L₁ and the second left auxiliary piece 18L₂ the freedom to be wound independently of each other. For this reason, the left closure mechanism 19L, which comprises a sliding mechanism that slides the superimposed surfaces in opposite directions, is constructed by having the first left auxiliary piece 18L₁ and the second left auxiliary piece 1812 wind to form part of a cylindrical curved surface with approximately the same curvature, and then superimposing them so that they cross each other, and then constructing a sliding mechanism that slides the superimposed surfaces in opposite directions, thereby closing the opening at the left end. Similarly, the enlarged isosceles triangle cut into the right side of the dashed line in the center of the bottom region in FIG. 1B gives the first right auxiliary piece 18R₁ and the second right auxiliary piece 18R₂ the freedom to be wound independently of each other, and the first right auxiliary piece 18R₁ and the second right auxiliary piece 18R₂ are wound in so that they form part of a cylindrical curved surface with approximately the same curvature, and a sliding mechanism is formed that slides the superimposed surface in opposite directions, so that the right closure mechanism 19R is formed, are wound so as to form part of a cylindrical curved surface of approximately the same curvature, and by forming a sliding mechanism that slides the superimposed surfaces in opposite directions, the opening at the right end is closed.

The superimposed surface structure of the first left auxiliary piece 18L₁ and second left auxiliary piece 18L₂ that consist of the left closing mechanism 19L, and the superimposed surface structure of the first right auxiliary piece 18R₁ and second right auxiliary piece 18R₂ that consist of the right closing mechanism 19R, can employ dry surface contact due to surface forces such as static electricity, or wet surface contact such as liquid adhesives. Examples of liquid adhesives include glycerin, silicone grease, and biodegradable viscous substances. Furthermore, a structure of mechanical surface contact may be adopted in which elongated guide grooves are provided along the circumference of the cylindrical shape shown in FIG. 1A in the first left auxiliary piece 18L₁ and the first right auxiliary piece 18R₁, and a rivet-like slider fixed to the second left auxiliary piece 18L₂ and the second right auxiliary piece 18R₂ slides along the elongated guide grooves. In other words, like a rivet that has become thicker at both ends after being crimped, a sliding element with a shaft having a diameter almost the same as the width of the guide groove and flanges at both ends larger than the width of the guide groove can be prepared, and the shaft of this sliding element can be slid in the outer circumference direction within the guide groove.

Alternatively, a structure that achieves mechanical contact can be realized by opening two guide grooves along the outer circumference in the upper and lower parts of each of the first left auxiliary piece 18L₁ and the first right auxiliary piece 18R₁. That is, the sewing thread that penetrates each of the second left auxiliary piece 18L₂ and the second right auxiliary piece 18R₂ penetrates the upper guide groove, the outer surfaces of the first left auxiliary piece 18L₁ and the first right auxiliary piece 18R₁ each descend vertically, penetrate the lower guide groove, and then return to the second left auxiliary piece 18L₂ and the second right auxiliary piece 18R₂, respectively, and this ring may be configured to slide along the outer circumference in the two guide grooves above and below in a mechanical surface contact. Through such dry surface contact, wet surface contact, and mechanical surface contact, it is possible to cause a gap between the surfaces through autonomous sliding movement along the curved surfaces that are in close contact with each other. The sliding mechanism may be configured by combining dry surface contact and mechanical surface contact, or by combining wet surface contact and mechanical surface contact. When the insertion part 1d is inserted into the interior of the planting furrow 210, the generation of in-plane stress on the wall due to the pressure exerted when the cultivating soil 100 is filled inside the insertion part 1d, or the pressure exerted due to the expansion of the cultivating soil 100 due to irrigation or the growth of the plant root system 301, can be reduced by shifting the superimposed area in the direction of reducing the sliding mechanism, which slides in opposite directions, and the rupture of the wall of the insertion part 1d can be suppressed.

We have already used formula (1) to explain that there are three types of internal volume for the insertion part 1d of the cultivation member in the first embodiment: Vᵢₙₛₑᵣₜ, V_{charge}, and V_{growth}. The shape of the insertion part 1d shown in FIG. 1A can be approximated as a flattened cylindrical shape similar to a rounded rectangle (oval) in a cross-section perpendicular to the circumferential axis. The outer circumference length c^{hc}(t) of the flattened cylinder is the length of the outer circumference of the rounded rectangle, so using the width l of the rectangular area defined in FIG. 1A and the distance w(t) between the opposing surfaces of the first main wall 10d₁ and the second main wall 10d₂, and can be expressed approximately as a function of time t as follows:

$${c}^{h c} ( t ) = 2 l + π w ( t ) + 2 Δ {l}^{h c} ( t ) \qquad ( 2 a )$$

In the case where the outer circumference length c^{hc}(t) shown in Formula (2a) increases as a function of time t, the change in the in-plane tension of the flexible water-shielding film that compose of the insertion part 1d can be ignored due to the sliding mechanism. Therefore, there is no accompanying increase in in-plane stress due to the generation of tension in the first main wall 10d₁ and second main wall 10d₂, which are made of flexible water-shielding film.

The second term on the right side of Formula (2a) is approximated as a semicircle when the first left auxiliary piece 18L₁, second left auxiliary piece 18L₂, first right auxiliary piece 18R₁ and second right auxiliary piece 18R₂ are viewed from the direction of the circumferential axis, and the radius of the semicircle is assumed to be w(t)/2. The third term on the right side of Formula (2a) represents a correction term for cases where the radius of the semicircle extends beyond w(t)/2 in the longitudinal direction of the planting furrow 210, but it is preferable to make Δl^{hc}(t)→0 or a negative value. Assuming that the first left auxiliary piece 18L₁ and the first right auxiliary piece 18R₁ are folded almost perpendicularly to the first main wall surface 10d₁, and the second left auxiliary piece 18L₂ and the second right auxiliary piece 18R₂ are folded almost perpendicularly to the second main wall surface 10d₂, the outer circumference length c^{hc}(t) shown in FIG. 1A of the right-angle approximation becomes the length of the outer circumference of a rectangle, so

$${c}^{r a} ( t ) = 2 l + w ( t ) + 2 Δ {l}^{r a} ( t ) \qquad ( 2 b )$$

and can be expressed approximately as a function of time t. Under conditions where the right-angle approximation is valid, the first left auxiliary piece 18L₁ and the first right auxiliary piece 18R₁ slide against each other as a plane, and the second left auxiliary piece 18L₂ and the second right auxiliary piece 18R₂ also slide against each other as a plane.

The third term on the right side of Formula (2b), Δl^{ra}(t), represents a correction term in the case where the first left auxiliary piece 18L₁ and the second left auxiliary piece 1812 are offset so as to create a gap on the left side of the intermittent joint 30, and the second right auxiliary piece 18R₂ and the second left auxiliary piece 1812 are offset so as to create a gap on the right side of the intermittent joint 30. At the initial condition t=t₀ before inserting the insertion part 1d into the planting furrow 210, it is preferable to set the correction term Δl^{ra}(t₀) to 0. After the second left auxiliary piece 1812 and second right auxiliary piece 18R₂ are folded almost perpendicularly to the second main wall surface 10d₂ and reached the first main wall surface 10d₁, they are further folded almost perpendicularly to the first main wall surface 10d₁ so that they are wound to the inner side of the first main wall surface 10d₁, Similarly, the first left auxiliary piece 18L₁ and the first right auxiliary piece 18R₁ may be folded at an angle almost perpendicular to the first main wall 10d₁, and after reaching the second main wall 10d₂, fold at an angle almost perpendicular to the second main wall 10d₂ to enclose part of the back side of the second main wall 10d₂.

The opposing surface interval w(t) is a function of time t, and the opposing surface interval w(t₀) at the initial condition t=t₀ is set to a value smaller than the planting furrow width W. In other words, under the assumption of a semi-circular approximation, at t=t₀ before inserting the insertion part 1d into the planting furrow 210, by making the values of the gap ΔW(t₀) in the direction of the furrow width at the time of insertion and the gap ΔL^{hc}(t₀) in the direction of the furrow length at the time of insertion

$$Δ W ( {t}_{0} ) = W - w ( {t}_{0} ) \qquad ( 3 )$$

$$Δ {L}^{h c} ( {t}_{0} ) = L - ( 1 + w ( {t}_{0} ) ) \qquad ( 4 a )$$

By making ΔL^{hc}(t₀) sufficiently large, the work of inserting the insertion part 1d into the inside of the planting furrow 210 can be made easier and more reliable. In formula (4a), the correction term Δl^{hc}(t)=0 is assumed. In the case of a right-angle approximation,

$$Δ {L}^{r a} ( {t}_{0} ) = L - ( 1 + w ( {t}_{0} ) ) . \qquad ( 4 b )$$

In equation (4b), the correction term Δl^{ra}(t)=0 is also assumed.

Corresponding to the internal volumes Vᵢₙₛₑᵣₜ, V_{charge} and V_{growth} shown in formula (1), there are also three types of outer circumference length c approximated by formula (2a) or formula (2b). That is, since the circumference of the semicircular parts changes due to the sliding mechanism when viewed from the direction of the circumferential axis, the outer circumference length cᵢₙₛₑᵣₜ when inserting the insertion part 1d into the planting furrow 210 can be defined as c^{hc}(t₀)>cᵢₙₛₑᵣₜ>c^{ra}(t₀). Furthermore, when the insertion part 1d is inserted into the planting furrow 210 and then the cultivating soil 100 is filled into the insertion part 1d, the outer circumference length c_{charge} is defined as c_{hc}(tₓ)>c_{charge}>c^{ra}(t₁), and after the plant 300 is planted in the cultivating soil 100 filled into the insertion part 1d, the outer circumference length c_{growth}, which is caused by the expansion of the cultivating soil 100 as the plant root system 301 grows, is defined as c^{hc}(tₓ)>c_{growth}>c^{ra}(tₓ), so a total of three types can be defined. These three types of outer circumference lengths are

$${c}_{i n s e r t} < {c}_{charge} < {c}_{growth} \qquad ( 5 )$$

The outer circumference length cᵢₙₛₑᵣₜ is not the outer circumference length measured when the inside of the insertion part 1d is empty, but may be the outer circumference length measured when a small amount of cultivating soil 100 is filled in as a weight. In the case of a structure of an insertion part composed of a flexible water-shielding film with longitudinal folds or wrinkles, such as the insertion part 1q of the fifth embodiment of the fifth variant of the present invention described below, the outer circumference length cᵢₙₛₑᵣₜ is defined in the state with the longitudinal folds or wrinkles formed, and formula (5) is applied. In other words, initially, by setting the outer circumference of the insertion part 1d to be smaller than the inner circumference of the planting furrow 210, cᵢₙₛₑᵣₜ<c_{charger} the work of inserting the insertion part 1d into the planting furrow 210 becomes easier. Then, by using a sliding mechanism, when the cultivating soil 100 is filled, the outer circumference cᵢₙₛₑᵣₜ can be lengthened to become the outer circumference c_{charge}.

In addition, the condition of c_{charge}<c_{growth} in formula (5) is an inevitable consequence of irrigation of the cultivating soil 100 and the growth of the plant root system 301 of the plant 300. However, because the insertion part 1d is comprise a sliding mechanism, even if the outer circumference length c_{charge} is lengthened to the outer circumference length c_{growth}, there is no accompanying increase in the in-plane stress of the first main wall surface 10d₁ and the second main wall surface 10d₂, and the rupture of the insertion part 1d can be prevented. In the state of c_{charge} and c_{growth} in formula (5), it can be presumed that the assumption of a semicircular approximation reflects the actual situation more than a right-angle approximation, so the outer circumference length after the insertion part 1d is filled with cultivating soil 100 shall be explained using a semicircular approximation. The maximum value of the outer circumference length c_{growth} due to the expansion of the cultivating soil 100 is the inner circumference length of the planting furrow 210. If the planting furrow 210 has a rectangular flat pattern of W×L, then the adjacent flat inner walls of the planting furrow 210 are orthogonal and composed of four inscribed ridges, so there is a gap between the four inscribed ridges of the planting furrow 210 and the outer wall composed of the curved surface of the insertion part 1d. Therefore, assuming that w(t)=W at t=t₁, the approximate semicircular outer circumference length c^{hc}(t) can be expressed as

$${c}^{h c} ( t ) = 2 l + Δ {l}^{h {c}^{⋆}} ( t ) + 4 r ( t ) > 2 l + π W \qquad ( 6 )$$

The 4r(t) term in formula (6) represents the component that increases the outer circumference length c^{hc}(t) of the insertion part 1d, so as to fill the gap space that occurs at the four internal edges of the planting furrow 210. The Δl^{hc}*(t) term in formula (6) is a component that contributes to the increase in the outer circumference length c^{hc}(t) corresponding to ΔL^{hc}(t) explained in formula (2a), and it shows a contributing component that takes into account the case where the first left auxiliary piece 18L₁, second left auxiliary piece 18L₂, first right auxiliary piece 18R₁, and second right auxiliary piece 18R₂ are flattened into a U-shape and extend in the longitudinal direction of the planting furrow 210, rather than in the case of a semicircular approximation. However, if Δl^{hc}*(t) increases due to the insertion part 1d extending in the direction of the furrow length L, holes will open directly below the U-shape protrusions at both ends of the insertion part 1d, and there is a probability that cultivating soil 100 with a grain diameter smaller than the hole will fall through the holes, which is undesirable. Therefore, as in the case of ΔL^{hc}(t), it is preferable to make Δl^{hc}*(t)→0 or a negative value.

When Δl^{hc}*(t) has a significant positive value, the superimposed structure of the first left auxiliary piece 18L₁ and the second left auxiliary piece 18L₂, and the superimposed structure of the first right auxiliary piece 18R₁ and the second right auxiliary piece 18R₂, flatten out in a U-shape and protrude further than the semicircle. If a hole opens directly below the U-shaped protruding part at both ends of the insertion part 1d, additional support pieces to fill this hole must be added to the bottom region at both ends of the hole, so that superimposed areas occur around the hole. One side of the additional support piece that becomes the anti-falling support piece may be fixed or semi-fixed to the bottom region using sewing, staples, etc. Alternatively, the lower ends of either the first left auxiliary piece 1811 or the second left auxiliary piece 1812, and the lower ends of either the first right auxiliary piece 18R₁ or the second right auxiliary piece 18R₂, may be fixed or semi-fixed to the bottom region side using sewing or staples, etc., so that a right-angle approximation can be maintained without a gap occurring on the lower end. Even if one of the lower end is sewn to the bottom region, if only the superimposed part can slide so that the width of the superimposed part is reduced, or if the other auxiliary piece is flexible, it is possible to slide between the first left auxiliary piece 18L₁ and the second left auxiliary piece 1812, or between the first right auxiliary piece 18R₁ and the second right auxiliary piece 18R₂. Furthermore, it is also possible to fill the bottom region with cultivating soil 100 with a grain diameter larger than the holes at the beginning.

Formula (6) shows that the shape of the insertion part 1d, which is flexible and has a sliding property, will deform until the gap space that occurs in the four inscribed ridges of the planting furrow 210 is filled. The outer circumference length c_{growth} reaches its maximum value cₘₐₓ=c^{hc}(tₓ) at time t=tₓ when the insertion part 1d has a rectangular flat pattern. From Formula (6), it can be seen that the lengths d of the first left auxiliary piece 18L₁, second left auxiliary piece 18L₂, second right auxiliary piece 18R₂ and second left auxiliary piece 18L₂, as shown in FIG. 1B, should preferably be longer than (ΔL^{hc}(tₓ)+4r(tₓ))/2. As shown in Formula (6), ΔL^{hc}(tₓ)+4r(tₓ)>πW. If the flat pattern of the planting furrow 210 is a rectangle of W×L, the maximum value cₘₐₓ=2(W+L), so the length d required for the insertion part 1d when the maximum value cₘₐₓ is reached is equal to W+L−1, or it is preferable to be slightly longer than W+L−1

In a storage structure (pseudo-sack with a missing bottom) having a non-planar bottom region in which the first left auxiliary piece 18L₁ and the second left auxiliary piece 18L₂, and the first right auxiliary piece 18R₁ and the second right auxiliary piece 18R₂ are fixed by means of an adhesive or sewing, etc., it is difficult to prevent rupture due to the expansion of the cultivating soil 100 caused by the growth of the plant root system 301. In contrast, if a sliding mechanism is provided that allows the internal volume and outer circumference of the closing mechanism (19L, 19R) to expand in response to the expansion of the cultivating soil 100, and if the relative positions of each layer along the surface direction can be autonomously slid, the rupture of the bottom-missing pseudo-sack can be suppressed. Therefore, by adopting a structure that allows autonomous sliding movement of the relative positions, it is possible to solve the two contradictory issues of preventing irrigation and outflow of the cultivating soil 100 from the pseudo-sack with a missing bottom and preventing rupture of the pseudo-sack with a missing bottom. After the outer circumference length C_{growth} reaches its maximum value due to the expansion of the cultivating soil 100, the increase in the internal volume V_{growth} becomes a force in the depth direction. The force in the depth direction due to the increase in internal volume V_{growth} becomes a force that causes intermittent joints 30 to erupture selectively over time. Furthermore, by adopting a structure that allows autonomous sliding movement of the relative position along the sliding direction of the sliding mechanism that slides in opposite directions, it is possible to freely expand the internal volume of the pseudo-sack with a missing bottom when inserting the insertion part 1d into the planting furrow 210 with a different width W and length L, thereby suppressing the rupture of pseudo-sack with a missing bottom and at the same time maintaining the outflow prevention of irrigation and cultivating soil 100.

In FIG. 1A, the first left auxiliary piece 18L₁ forms part of the outer cylindrical surface, and the second left auxiliary piece 18L₂ forms part of the inner cylindrical surface, but this is just an example, and the left closing mechanism 19L may be formed by superimposing the first left auxiliary piece 18L₁ to form part of the inner cylindrical surface and the second left auxiliary piece 1812 to form part of the outer cylindrical surface. Similarly, the structure in which the first right auxiliary piece 18R₁ forms part of the outer cylindrical surface and the second right auxiliary piece 18R₂ forms part of the inner cylindrical surface is shown in FIG. 1A, but this is just an example. The right closing mechanism 19R may be formed by superimposing the first right auxiliary piece 18R₁ to form part of the inner cylindrical surface and the second right auxiliary piece 18R₂ to form part of the outer cylindrical surface.

The insertion part 1d of the cultivation member of the first embodiment is inserted into the interior of each of the planting furrows 210 formed by digging in a plurality of places in the ground 200 of the cultivating place, and it is also possible for one planting furrow 210 to be dug in one place on the ground 200 of the cultivating place, and for one insertion part 1d to be inserted inside one planting furrow 210. Then, cultivating soil 100 can be filled in each of the insertion parts 1d, and seeds and seedlings of plants 300 can be planted in each of the filled cultivating soils 100, and irrigation can be performed on the insertion parts 1d to allow the seeds and seedlings of plants 300 to grow. Examples of seeds and seedlings of plants 300 that can be grown include seeds, seedlings, cuttings, and stolons. In the following, seeds, seedlings, cuttings, and stolons are collectively referred to as “seeds and seedlings”.

When using the insertion part 1d of the cultivation member of the first embodiment to raise seedlings, suitable plants are those that have deep plant root systems that grow deep into the ground, in terms of reducing the amount and frequency of irrigation by making use of deep, stable soil water, and increasing the amount of stored carbon in the plant root system. Suitable plants for raising seedlings using the insertion part 1d of the cultivation member of the first embodiment are specifically as follows (i) to (iv).
(i) In the woody plant category, pine, eucalyptus, acacia, willow, crown-of-thorns, haloxylon, tamarisk, seaberry, saeberrysassy, ephedra, datepalm, sheoak, ghaf, summer, cedar, salum, garata, malta, atreplex, gum karaya, shea butter, baobab, nutmeg, dry mahogany, moringa, henna, argan, gum arabic, frankincense, neem, pongamia pinnata, sago palm, hamiltonia, Indian sandalwood, melia, sterculia verescoral, jojoba, almond, agave, mesquite,
(ii) herbaceous plants: alfalfa, carega, clover, dandelion, guineay, pigeon pea, pearl millet, sorghum, quinoa, amaranth, kanza, bengoa, candela, lupine, cowpea, grass family plants,
(iii) For plants that use root systems, yam, licorice, Asian ginseng, periwinkle, psycho, golden lace, Chinese milk vetch, and ephedra,
(iv) For spores, mycorrhiza, and seeds that are parasitic on plants, cistanchis herb, sandalwood, truffle, and matsutake, or plants of the same genus as those listed in (i) to (iv) above, but these are not limited to these.

The insertion part 1d of the cultivation member of the first embodiment can be applied to permanent planting sites, temporary planting sites, fields, rice paddies, forest land, roads, sloping land, sea walls, coastal forests, erosion control forests, river banks, wasteland, arid land, mine sites, sites where harmful substances such as salt accumulated, drip irrigation plant cultivation sites, etc. In addition, the insertion part 1d of the cultivation member of the first embodiment can be used to guide the downward extension of the plant root system of the planted seeds and seedlings, to improve the survival rate and growth rate of the planted plants by making effective use of water and fertilizer through vertical penetration of irrigation, and to reduce the amount and frequency of irrigation by limiting the horizontal diffusion penetration of irrigation. Furthermore, planting in saline areas by shielding the salt deposition layer near the surface of the ground, environmental remediation technology (phytoremediation) using the elongation absorption of the plant root system of planted plants in the harmful substance layer at a specific depth underground, prevention of weed plant root system invasion, prevention of plant root system-feeding pests and harmful pathogens, root system-utilizing plant root system shape control, use of the container for raising seedlings from seeds or grafting as a container for permanent planting, or planting methods for preventing landslides on slopes, etc. are listed as specific examples of the use of insertion part 1d, but these are not limited to these.

The cultivating soil 100 that fills the insertion part 1d of the first embodiment includes at least one of natural soil, peat moss, coco peat, bark compost, lignite, fir bark, charcoal, charcoal powder, perlite, vermiculite, rock wool, zeolite, and pumice, and also includes molded cultivating soil that has had its shape stabilized by a binder or by its own pressurized heat, such as powdered, granular, or fiber-like, etc. of any shape, including molded cultivating soil that has been stabilized using a binder or by applying pressure and heat to it. It is not necessary to use molded cultivating soil for all of the cultivating soil 100 that is filled into the insertion part 1d. It is also possible to place it at the intermittent joint 30 or the top of the insertion part 1d and fill the space between them with cultivating soil 100 of any shape. It is also possible to fill the first left auxiliary piece 18L₁, second left auxiliary piece 1812, first right auxiliary piece 18R₁ and second right auxiliary piece 18R₂ shown in FIG. 1A with cultivating soil of a particle size that will not fall through the semicircular holes on either side of the intermittent joint 30, and then fill with the amorphous cultivating soil 100. By arranging the molded cultivating soil in the intermittent joints 30 and then filling them with the amorphous cultivating soil, it is possible to prevent the amorphous cultivating soil from falling out of the intermittent joints 30 and the holes on both sides of the intermittent joints 30, and to improve the retention time of irrigation by the blocking effect of the irrigation water by the molded cultivating soil. By transplanting nursery plug seedlings grown in formed cultivating soil into a cultivating soil-filled insertion bag before the plant root system 301 reaches the intermittent joint 30 of the molded cultivating soil, it is possible to transplant the plant without damaging the plant root system 301 or causing the roots to curl.

Molded cultivating soil can be made by
(a) binding materials such as heat-sealed fibers to bind the cultivating soil base material;
(b) heating or compressing the cultivating soil base material in a mold;
(c) packaging and restraining it in a paper container, etc.;
(d) removing the root ball grown from the seedling container.

For example, when binding the cultivating soil base material with a binder material such as heat-melt fibers, the cultivating soil can be made by combining a core of fibers that do not have a melting point or have a melting point of 60 degrees or higher, and a sheath of a binder that is mainly composed of cis-1,4 polyisoprene.

Fibers that form the core include plant and animal fibers obtained from cotton, coconut husks, hemp, banana leaves, wool, silk, etc., as well as synthetic fibers made from polyester, nylon, vinylon, polyvinyl alcohol, polylactic acid, etc. Fibers here include single fibers as well as twisted yarns. Composite core-sheath fibers can be obtained by immersing core fibers in a natural rubber latex solution and then drying them. By adding natural rubber latex at a solid content of 70% or more and less than 30% of preservatives, cross-linking agents, surfactants, anti-mold agents, etc., a binder with cis-1,4 polyisoprene as its main component can be obtained. By mixing single core-sheath fibers or composite core-sheath fibers with cultivating soil base material and filling it into a molding machine and heating it, a molded cultivating soil can be obtained in which the single core-sheath fibers or composite core-sheath fibers restrain the cultivating soil base material. The melting point of cis-1,4 polyisoprene is around 40 degrees, so it can be heated at low temperatures, and cultivating soil with a high binding force can be created in a short time and with low energy consumption. By using the cultivating soil as the cultivating soil 100 for the insertion part 1a, the shape retention of the cultivating soil can be used to make the insertion part 1a stand on its own, or the elastic force of the cultivating soil can be used to reinforce the ground in planting methods to prevent landslides on slopes.

### =Connecting Insertion Part=

The first left auxiliary piece 18L₁ and the second left auxiliary piece 18L₂ are not wound each other in a curved shape. In the case of a planting furrow 210 with a longitudinal length, it is possible to select a plurality of insertion parts 1d that conform to the longitudinal length of the planting furrow 210 and connect the plurality of insertion parts 1d to form an connecting insertion part with a U-shaped structure that can fit into a planting furrow 210 of any length. In order to connect plurality of insertion parts 1d, instead of winding the first left auxiliary piece 18L₁ and the second left auxiliary piece 18L₂ each other in a curves shape as in FIG. 1A, the first right auxiliary piece 18R₁ and the second left auxiliary piece 18L₁ can be superimposed in a flat shaped plate, and the first right auxiliary piece 18R₂ and the second left auxiliary piece 18L₂ of the right side insertion part 1d can be superimposed in a flat shaped plate.

If the longitudinal length of the planting furrow 210 is not an integer multiple of the length 1 of the insertion part 1d, the length 1 of a particular insertion part 1d can be adjusted so that the longitudinal length of the planting furrow 210 and the length of a plurality of successive insertion parts 1d are compatible. Thus, by superimposing the first right auxiliary piece 18R₁ and the second left auxiliary piece 18L₁ to connect the pseudo-sack with a missing bottom to each other, and by superimposing the first right auxiliary piece 18R₂ and the second left auxiliary piece 18L₂ to connect the pseudo-sack with a bottom-missing to each other, any length of the planting furrows 210 can be filled with the insertion parts of cultivation members connected in series.

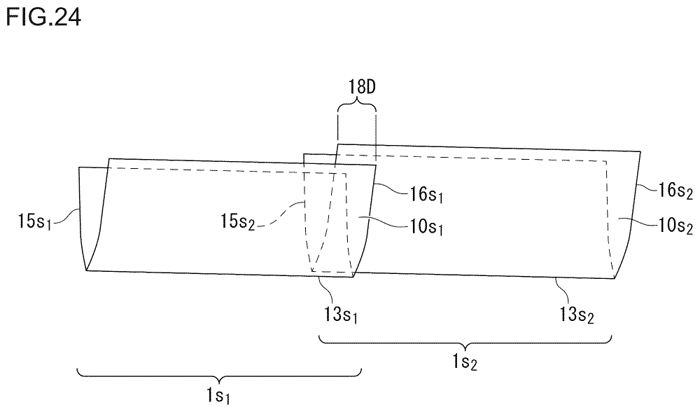

When planting soil 100 is filled into the interior of the storage structure consist of an insertion part connecting a plurality of insertion parts 1d of the cultivation member of the first embodiment shown in FIG. 1A, planting soil 100 is filled into each insertion part 1d of the connecting body so that it pushes and spreads against the walls of the planting furrow 210. Therefore, the superimposed surfaces connecting the insertion part connecting bodies are tightly closed against each other (hereinafter referred to as “superimposed surface tightly closed”) by the mutual pressure of the filled cultivating soil 100 and the wall of the planting furrow 210. Both ends of the insertion part connecting multiple insertion parts 1d are closed by the left closing mechanism 19L of the insertion part 1d located on the leftmost side and the right closing mechanism 19R of the insertion part 1d located on the rightmost side. As the length of the insertion parts inserted into the furrow increases due to an increase in the number of films, the shielding effect of the closure of both side ends of the insertion parts from the external soil becomes negligible in practical use compared to the shielding effect of the entire insertion part. As shown in FIG. 24 below, even in a structure with open ends, as the number of joints increases and the length of the insertion part increases, the shielding effect of the insertion part from the external soil becomes negligible compared to the shielding effect of the entire insertion part. The connecting insertion part with both ends closed is effective, for example, in the planting step of seeds and seedlings in saline areas, to block the particularly harmful penetration of pests and soil salts into the cultivating soil 100 filled inside the connecting insertion part.

In the connecting insertion part consisting of a plurality of insertion parts 1d of the cultivation member according to the first embodiment, the bottom region of each of the plurality of insertion parts 1d is closed by end-face bonding of opposing surfaces that form part of a intermittent joint. On the other hand, at the side end of each of the plurality of insertion parts 1d, the first right auxiliary piece 18R₁ of the left side insertion part 1d and the first left auxiliary piece 18L₁ of the right side insertion part 1d are superimposed flat, and the second right auxiliary piece 18R₂ of the left side insertion part 1d and the second left auxiliary piece 18L₂ of the right side insertion part 1d are superimposed flat and tightly closed at the face. Here, “end-face bonding of opposing surfaces,” which is part of the U-shaped structure, refers to the closing method in which the end faces of the film surfaces on the side in contact with the inserted cultivating soil 100 are fixed together with the same or different material as the film surfaces to bond them. On the other hand, the “superimposed surface tightly closed” is an closing method in which the film surfaces in contact with the cultivating soil 100 and the film surface not in contact with the cultivating soil 100 are not fixed, but are pressed tightly together by external pressure to close the film surfaces.

Where the bottom region that forms part of the U-shaped structure is end-face bonding between intermittent opposing surfaces, the non-bonded 41d and bonded 31d are arranged in one dimension to form an intermittent joint 30. Therefore, in the bottom region of the insertion part, the penetration of the irrigation and plant root system 301 are allowed, and the expansion pressure of the cultivating soil 100 is concentrated in the intermittent joint 30, which extends the bonded part 31d and easily rupture it. In contrast, the superimposed surface closure is highly effective in blocking water due to the closure by surface contact, which uses mutual pressure of the cultivating soil 100 filled inside the insertion part coupling and the ground 200 outside the insertion part connecting body to contact the flexible film surfaces to each other. Therefore, when the cultivating soil 100 expands due to the expansion of the plant root system 301 accompanying plant growth, etc., the superimposed surfaces shift and absorb the expansion pressure at the point of superimposed surface contact closure, resulting in high rupture resistance. Where the bottom region of the insertion part 1d is intermittent joint at the end faces, expansion of the cultivating soil 100 due to the growth of the plant root system 301 causes to rupture the intermittent joint of the bottom region before the superimposed surfaces. Therefore, the plant root system 301 can selectively extend downward toward a position deeper than the lower end 13d of each of the insertion parts 1d that consist of the connecting insertion part.

### =Cultivation System=

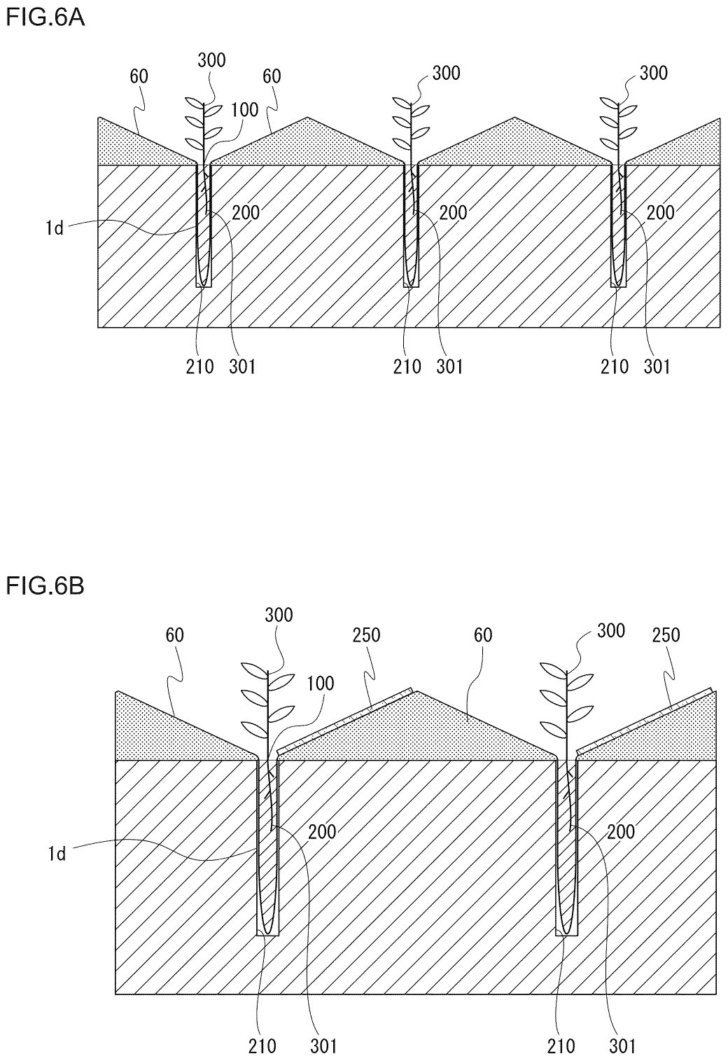

As shown in FIGS. 5, 6A and 6B, the cultivation system of the first embodiment of the present invention comprises a ground 200 of a cultivating place, a laying member 60 made of a hydrophobic material constituting a plurality of ridges having an inclined surface and laid periodically on the ground 200 of the planting place, an insertion part 1d of the cultivation member of the first embodiment inserted into each of a plurality of planting furrow 210 having a high aspect ratio D/W dug periodically in the ground 200 of the planting place, and cultivating soil 100 filled into each of the plurality of insertion part 1d, and is a cultivation system for cultivating plants using natural water. A plurality of the planting furrow 210 has a rectangular planar pattern, and the rectangular furrow extends in the longitudinal direction perpendicular to the paper surface of FIGS. 5, 6A and 6B.

The insertion part 1d of the cultivation member of the first embodiment presents a structure of a pseudo-sack with a U-shape on a cross section and an intermittent joint 30 that selectively ruptures over time in the bottom region of the insertion part 1d. The pseudo-sack with a missing bottom has a structure without a flat bottom at the bottom as shown in FIG. 1A. In the U-shaped intermittent joint 30, even if the opening length of the non-bonded 41d is larger than the diameter of the cultivating soil particles, there is only a slight outflow of the filled cultivating soil 100 from the non-bonded 41d due to the binding force between the flexible water-shielding films. Therefore, compared to a container with a bottom, the space between the flexible water-shielding films is narrower at the intermittent joint 30, and the filled cultivating soil 100 is densely piled up. Therefore, the rate of leakage of irrigation water from the non-bonded parts 41d is slow, and the irrigation water accumulated in the insertion part 1d takes time to penetrate into the filled cultivating soil 100, thereby improving the cultivating soil penetration rate.

In the cultivation system of the first embodiment, the aspect ratio D/W, defined on cross-section as the ratio of the depth D of the planting furrow 210 shown in FIGS. 5, 6A, 6B, etc. to the furrow width W, is preferably 5 or more. The depth D means the distance from the bottom of the planting furrow 210 to the ground surface. For example, if the furrow width W=10 cm, the minimum requirement is that the furrow depth D≥50 cm. If the aspect ratio D/W<5, irrigation spreads shallowly and widely near the ground surface, and the plant root system 301 also spreads shallowly due to root hydrotropism, making it difficult for the plant root system 301 to reach the stable soil layer that exists below a certain depth of the ground 200. If the plant root system 301 does not reach the stable soil layer or the deeper part of the ground 200 at an early stage, the risk of plant 300 death increases because the surface soil layer is more susceptible to surface temperature and sunlight during the dry season.

When the aspect ratio of the planting furrow 210 is D/W≥5, the plant root system 301 is forced to selectively guide and grow downward due to the function of the selective temporal rupture of the intermittent joint 30 of the insertion part 1d of the cultivation member of the first embodiment. Therefore, by setting the aspect ratio D/W≥5 of the 210 planting furrows, the plant root system 301 reaches the stable soil layer or the deeper part of the ground 200, which is less affected by the temperature and sunlight of the ground surface, at an early stage. As a result, the withering risk of plant 300 in the dry season is reduced. A planting furrow 210 with a furrow depth ofD≥50 cm can avoid salt intrusion by shielding the influence of the ground surface and the high salt concentration layer near the ground surface in saline areas. Considering the depth of existence of the stable soil layer, an aspect ratio D/W≥10 is more preferable. When the aspect ratio D/W≥5 in the conventional technology, the risk of the flexible member sticking in the middle of the 210 planting furrow during insertion was an obstacle to practical application. However, by filling the insertion part 1d with a small amount of cultivating soil 100 in advance and using the cultivating soil 100 as a weight of the insertion part 1d, the insertion part 1d can be inserted into the high aspect ratio planting furrow 210 without sticking. Furthermore, by using cultivating soil 100 as a weight of insertion part 1d and setting the internal volume of insertion part 1d to Vᵢₙₛₑᵣₜ<V_{charge} as shown in formula (1), a clearance space can be created between the inner wall of planting furrow 210 and the outer wall of insertion part 1d. Therefore, due to the synergistic effect of a weight and the smaller internal volume, the insertion part 1d can be easily and surely inserted into the planting furrow 210 with an aspect ratio D/W≥5, in high resulting work efficiency.

### [One-Side Inclined Body: The First Aspect]

In the example shown in FIG. 5, each of the laying member 60 made of a plurality of hydrophobic materials comprises an inclining surface of a one-side inclined body over the ground 200, laying a plurality of ridged structures in a periodic repetitive structure. The surface of the cultivating soil 100 filled into the insertion part 1d is set to be the lower end of the inclined surface. The shape of the laying member 60 shown in FIG. 5, which is inclined diagonally upward with the surface of the cultivating soil 100 filled in the insertion part 1d at the lower end, is hereinafter referred to as a “one-side inclined body”. In the cultivation system for the first embodiment of the present invention shown in FIG. 5, the laying member 60 having one main inclined surface and presenting an asymmetrical cross-section shape is used as ridges in the planting place, and a high aspect ratio D/W planting furrow 210 is dug between the ridges. An insertion part 1d is then inserted into each of the high aspect ratio D/W planting furrows 210. The inserted insertion part 1d is filled with cultivating soil 100, and plants 300 are planted in the filled cultivating soil 100, and plants 300 are grown using natural water such as rainwater and condensation water. In the plant cultivation system of the first embodiment, the position of the lower end of the main slope formed by the one-sided inclined body is the horizontal level of the surface of cultivating soil 100 filled into each of the insertion parts 1d placed on both sides of the laying member 60, which is made of hydrophobic material.

The laying member 60 made of hydrophobic material has the structure of a one-side inclined body ridge so that the surface of the cultivating soil 100 filled inside each of the plurality of repeatedly arranged insertion parts 1d becomes the lower end. Thus, the laying member 60 prevents evaporation of soil water in the ground 200 to the ground surface. Furthermore, by providing the laying member 60, which has the structure of ridges with a one-sided slope, natural water flows over the surface of the laying member 60, which is made of hydrophobic material, and collects and flows into the cultivating soil 100 filled into the insertion part 1d from the lower end of the slope, thus realizing an irrigation system using natural water. In conventional drip irrigation systems, the plant root systems 301 of cultivated plants grow only in the surface layer of the ground where drip water penetrates, and it is said that it is difficult for them to growth independently.

In contrast, according to the cultivation system shown in FIG. 5, by combining the insertion portion 1d of the cultivation member of the first embodiment with a laying member 60 made of a hydrophobic material, the presence of the insertion portion 1d restricts the diffusion of rainwater and filtered water collected by the laying member 60 in all directions at the surface of the soil base 200, and water including natural water and manual irrigation penetrates downward.

Therefore, according to the plant cultivation system shown in FIG. 5, the planted plant 300 also does not remain in the surface area of the ground 200 due to the hydrotropism of the plant root system 301, but the plant root system 301 selectively extends downward and the plant root system 301 can reach the stable soil layer that exists at a deeper position in the ground 200. The plant root system 301 reaching the stable soil layer allows the plant root system 301 to grow independently. In particular, a highly efficient natural water utilization system can be realized by digging a planting furrow 210 at the bottom of a valley whose cross section is asymmetrically shaped in a repeating structure with one-side inclined body as shown in FIG. 5, and placing an insertion part 1d in this planting furrow 210. In this case, the insertion part 1d placed in the bottom of the asymmetrically furrow is filled with cultivating soil 100, and a laying member 60 made of hydrophobic material is used such that water collection recess is provided corresponding to the arrangement of the 300 plants planted in the cultivating soil 100. Thus, according to the plant cultivation system for the first embodiment shown in FIG. 5, water collection recess are provided at the bottom of the asymmetrically furrow, enabling natural water falling uniformly on the surface to be collected in water collection furrows or recesses placed at predetermined arrangement points, thereby minimizing the amount of manually irrigation.

### [Both-Sides Inclined Body: The Second Aspect]

FIG. 6A schematically shows the cross-section structure of a laying member 60 used in a cultivation system for another form (the second aspect) of the first embodiment of the present invention. In the cultivation system for the second aspect of the first embodiment shown in FIG. 6A, a planting furrow 210 is formed at both bottom corner positions of the inverted V-shape cross section, and an insertion part 1d is inserted inside the planting furrow 210. The laying member 60, which is the inverted V-shape shown in FIG. 6A, is hereinafter referred to as the “both-sides inclined body”. The laying member 60 and the planting furrow 210 can be formed by either cutting or digging the ground 200 of the cultivating place, or by piling up the dug soil of the planting furrow 210 in an inverted V-shape on both sides. In either case, the location defining the aspect ratio D and W of the planting furrow 210 is the top of the planting furrow 210. A hydrophobic laying member 60 is laid on the surface of the ground 200 shown in FIG. 6A.

The hydrophobic laying member 60 can be any known material as long as it has a hydrophobicity of 3.9 kPa or more, more preferably 5.9 kPa in a water resistance test such as the JISL1092A method described above. It is also possible to make the height h of the insertion parts 1d greater than the depth D of the planting furrow 210, so that the protrusion of the insertion parts 1d into the ground surface inserted into the planting furrow 210 can be laid on the surface of the both-sides inclined body to cover at least part of the laying member 60. The laying member 60 made of hydrophobic material is laid on the ground surface of the ground 200 in the cultivating place so as to form the both inclined body, thereby preventing evaporation of moisture in the ground 200 to the ground surface.

In conventional irrigation systems, as shown in Non-Patent Literature 1, irrigation water diffuses and penetrates from the irrigation point to the three sides of the soil, requiring a large amount of irrigation to reach deeper areas. In the technology shown in Non-Patent Literature 1, when the salinity of irrigation water is high and the irrigation amount does not penetrate to the groundwater layer, the high salinity irrigation water evaporates and forms a salt deposit layer near the ground surface. In addition, in drip irrigation for the purpose of reducing irrigation amount, the 301 plant root system of planted plants stays near the irrigation discharge hole due to root hydrotropism, and independent growth without irrigation is not possible.

According to the plant cultivation system shown in FIG. 6A, the plant root system 301 of plant 300 planted in planting furrow 210 with high aspect ratio D/W does not stay on the surface of ground 200 due to the hydrotropism of plant root system 301, and plant root system 301 selectively extends downward. The plant root system 301 then reaches a stable soil layer that resides deeper in the ground 200, allowing the plant root system 301 to grow independently. Therefore, according to the plant cultivation system according to the second aspect of the first embodiment shown in FIG. 6A, by providing water collection recesses at the bottom of the V-shaped furrow, natural water falling uniformly on the surface can be collected to the collection recesses located at predetermined arrangement points, and a highly efficient irrigation water utilization system that can reduce the amount and frequency of irrigation.

### [Installation of Solar Panels: Variant of the Second Aspect]

In a plant cultivation system for a variant of the second aspect of the first embodiment of the present invention, as shown in FIG. 6B, at least part of the upper layer of the laying member 60 is equipped with solar panels 250. The plant cultivation system for the variant of the second aspect of the first embodiment uses laying members 60 with both-sides inclined body, as shown in FIG. 6A. By using the laying members 60 with both-sides inclined body, the rainwater and condensation water collected by the laying member 60 are configured to penetrate downward to a deeper position in the ground 200 via the 210 planting furrows with a high aspect ratio D/W, and the four-way diffusion at the surface layer of the ground 200 is constrained. The hydrotropism of the plant root system 301 of the planted plant 300 causes the plant root system 301 to selectively extend downward without remaining on the ground 200 surface. The plant root system 301 reaches the stable soil layer through the high aspect ratio D/W planting furrow 210, allowing the plant root system 301 to grow independently. In the repeating structure of laying members 60 with both-sides inclined body as shown in FIG. 6B, if planting furrow 210 with a deep aspect ratio D/W is placed at the bottom of the V-shape between laying members 60 with both-sides inclined body, and insertion part 1d is inserted into this planting furrow 210, a highly efficient natural water utilization system can be realized.

Solar panels 250 can be used as one of hydrophobic material films on at least part of the one side of the both-sides inclined body. Solar panels 250 made of inorganic materials such as glass and silicon (Si) are preferred as a condensation material for atmospheric moisture because they have a large thermal capacity and are difficult to heat up and cool down, thus easily creating a temperature difference from the atmosphere which warms up and cools down easily. For example, by using solar panels 250 on one side of the both-sides inclined body and solar reflectors on the other side, it is possible to utilize the solar energy irradiated on the inverted V-shaped both-sides inclined body. Rainwater and condensation water collected by the solar panels 250 flows into the cultivating soil 100 filled in the insertion part 1d through the water collection recesses between the ridges, enabling both solar power generation and an irrigation system using natural water. In the plant cultivation system for the second variant of the first embodiment, the upper end of the insertion part 1d of the cultivation member laid on the ground surface is covered by the lower end of the solar panel 250, so that the two ends constitute a superimposed surface. By covering the upper end of the insertion part 1d of the cultivation member with the lower end of the solar panel 250 and installing it, rainwater and condensation water on the solar panel 250 is collected in the insertion part 1d over a wide area via the solar panel 250, and the cleaning water for dust removal from the solar panel 250 can also serve as irrigation water. In addition, plants 300 growing in the insertion part 1d have the effect of suppressing the rise in soil temperature and atmospheric temperature, and the solar panel 250 becomes more efficient at generating electricity at lower temperatures, which contributes to improving the efficiency of solar power generation.

### =Planting Method=

The series of steps described as a typical planting method for the first embodiment of the present invention is as follows, but is not limited to the following series of steps.
(Preparation step) preparing an insertion part 1d having the structure as illustrated in FIG. 1A;
(Digging step) digging a planting furrow 210 having a high aspect ratio D/W in the ground 200 of the cultivating place;
(Insertion step) inserting the insertion part 1d inside the planting furrow 210, setting the internal volume Vᵢₙₛₑᵣₜ<V_{charge}
(Filling step) filling the cultivating soil 100 into the opposite side of the insertion part 1d;
(Planting step) seeding or planting seeds and seedlings 300 in the filled cultivating soil 100;
(Irrigation step) irrigating the planted seeds and seedlings 300

The planting furrows 210 to be dug in the digging step in the first embodiment should be formed in a recess in the cultivating place in order to collect rainwater and condensation water effectively. Therefore, it is desirable to place planting furrows 210 in the recess between ridges that form the one-side inclined body, as shown in FIG. 5, or between ridges that form the both-sides inclined body, as shown in FIG. 6A. Planting furrows 210 with a high aspect ratio D/W have a smaller surface area and cross-section area for the same amount of cultivating soil 100, reducing the amount of irrigation evaporation and horizontal penetration. Furthermore, the cultivating soil 100 filled in such a way that it is voraciously deposited from the bottom of the narrow planting furrow 210 improves the irrigation penetration rate, which is effective for the active growth of planted seeds and seedlings and the downward extension of the selective plant root system 301. The high aspect ratio planting furrow 210 can be dug with existing mobile planting equipment such as trenchers (ditch diggers). In the insertion step illustrated in the first embodiment of the planting method, it is desirable to pre-fill a small amount of cultivating soil 100 when inserting the insertion part 1d into the interior of the high-aspect-ratio planting furrow 210. The small amount of cultivating soil 100 filled in advance functions as a weight for the insertion part 1d, enabling the insertion part 1d to reach the bottom of the planting furrow 210 without stick in the middle of the narrow planting furrow 210 with a high aspect ratio.

In the filling step exemplified in the first embodiment of the planting method, the cultivating soil 100 to be filled inside the insertion part 1d inserted into the inside of the planting furrow 210 formed by digging in the planting place reaches the intermittent joint of the insertion part 1d and is deposited and retained. In the filling step of the first embodiment of the planting method, the filled cultivating soil 100 increases the internal volume V_{charge}→V_{growth} so that the flexible water-shielding film of the insertion part 1d, which is inserted into the planting furrow 210, is pushed open and adhered to the wall of the planting furrow 210. Therefore, no significant gap space is created between the insertion part 1d and the wall of the planting furrow 210, With the exception of the small gaps that occur on the four ridges of the planting furrow 210, and no soil backfill is required between the insertion part 1d and the planting furrow 210.

Therefore, unless the cultivating soil 100 filled in the insertion part 1d is pressed, the soil density of the cultivating soil 100 filled in the insertion part 1d is lower than the soil density of the wall of the planting furrow 210. By stopping the location of the surface level of the filling of the cultivating soil 100 in the filling step at a level lower than the surface of the cultivating place, coupled with the cultivating soil 100 filled at a low soil density, the runoff of irrigation water to the outer wall of the insertion part 1d is minimized and water saving is possible.

In the planting steps exemplified in the first embodiment of the planting method, seeds and seedlings, cuttings, stolons, etc. are collectively expressed as “seeds and seedlings, etc.”. In the irrigation step in the irrigation process exemplified in the first embodiment of the planting method, the lateral penetration of irrigation water is intercepted by the insertion part 1d of the cultivation member, so the irrigation water does not penetrate laterally but penetrates down the interior of the insertion part 1d. The irrigation water is temporarily stopped at the intermittent joints of the insertion part 1d. The water that is held back penetrates back up into the top of the cultivating soil 100 filled in the insertion part 1d, causing a pseudo-immersion-bottom irrigation. Therefore, according to the planting method of the first embodiment, it is possible to improve the rate of irrigation penetration of the cultivating soil 100 filled in the insertion part 1d and to significantly reduce irrigation water at the same time.

In irrigating the filled cultivating soil 100 in the irrigation step for the planting method of the first embodiment, the cultivating soil 100 deposited in the upper part from the intermittent joint of the insertion part 1d becomes a filtering filter. Therefore, the filtering filter temporarily holds the irrigation water. This allows irrigation water to leak out over time from the intermittent joints of the insertion part 1d. The plant root system 301 of the planted plant 300 can also follow the leaked water due to the root hydrotropism and selectively extend downward out of the insertion part 1d from the intermittent joint of the insertion part 1d.

As shown in FIGS. 1A and 1B, the one-dimensional array of intermittent joints in the bottom region of the storage structure formed by the insertion part 1d minimizes the number of penetrations outside the bottom region of the insertion part 1d, especially near the ground surface. By using the insertion part 1d of the cultivation member of the first embodiment, the traffic of moisture, salts, etc. between the cultivating soil 100 filled inside the insertion part 1d and the ground 200 outside the insertion part 1d is intercepted in the vicinity of the surface layer of the ground 200. According to the first embodiment of the planting method, irrigation water can form a vertical moisture penetration channel that leaks out from the intermittent joint at the lower end 13d of the insertion part 1d. Irrigation here includes rainwater, condensation water, etc. as well as manual irrigation in all forms unless otherwise specified.

### —Water Resistance Evaluation of Flexible Water-Shielding—

The following six flexible water-shielding film samples were used as examples for water resistance evaluation as flexible water-shielding films for insertion part 1d of the first embodiment of the cultivation member, and one flexible water-shielding film was prepared as a comparative example sample.
(Sample 1) Low-density polyethylene film of 60 μm film thickness
(Sample 2) Commercial kraft paper of 100 μm film thickness (source: S700KRFT from Shisei Corporation)
(Sample 3) Kraft paper of Sample 2 was impregnated with a 20% dilution of PC-518, a natural rubber latex pre-vulcanization preparation (source: REGITEX Co.
(Sample 4) Kraft paper of Sample 2 was impregnated with hot water molten wax from Seiwa Corporation, and dried naturally for 2 days and nights to obtain a composite water-shielding film flexible water-shielding film with a thickness of about 140 μm.
(Sample 5) Oil paper (commercial product (sold by (Sample 5) Oil paper (commercially available product (distributor: SOHO Tower Co., Ltd.) with wax (paraffin) on both sides on kraft paper)
(Sample 6) Biodegradable resin (film thickness: 80 μm, base resin: Novamont Mater-BI; source: Seedam Corporation Zebuas SBP201)

The results of the water resistance test evaluation based on JIS L 1092A for the examples 1 to 6 using the high water pressure water resistance tester MFP WP-1000K made by Daiei Scientific Instruments Manufacturing Co., Ltd. are shown in Table 1, compared with the comparison example of cooking paper.

TABLE 1

| | | Composition of | | |
|---|---|---|---|---|
| | | Water-Shielding | Thickness | Water |
| Samples | | Film | (μm) | resistance |
| Examples | Sample 1 | Low-pressure | 80 | 1372 |
| | | polyethylene | | |
| | Sample 2 | Kraft paper | 100 | 642 |
| | Sample 3 | Kraft paper + | Approx. 140 | 1246 |
| | | natural rubber | | |
| | Sample 4 | Kraft paper + | Approx. 160 | 812 |
| | | molten wax | | |
| | Sample 5 | Oil paper | 60 | 448 |
| | Sample 6 | Biodegradable | 80 | 1137 |
| | | resin (Mater-BI) | | |

| comparative | Cooking paper | 40 | 85 |
|---|---|---|---|
| example | (Commercially | | |
| | available) | | |

### —Buckwheat Cultivation Test Under Various Conditions in Cultivating Soil—

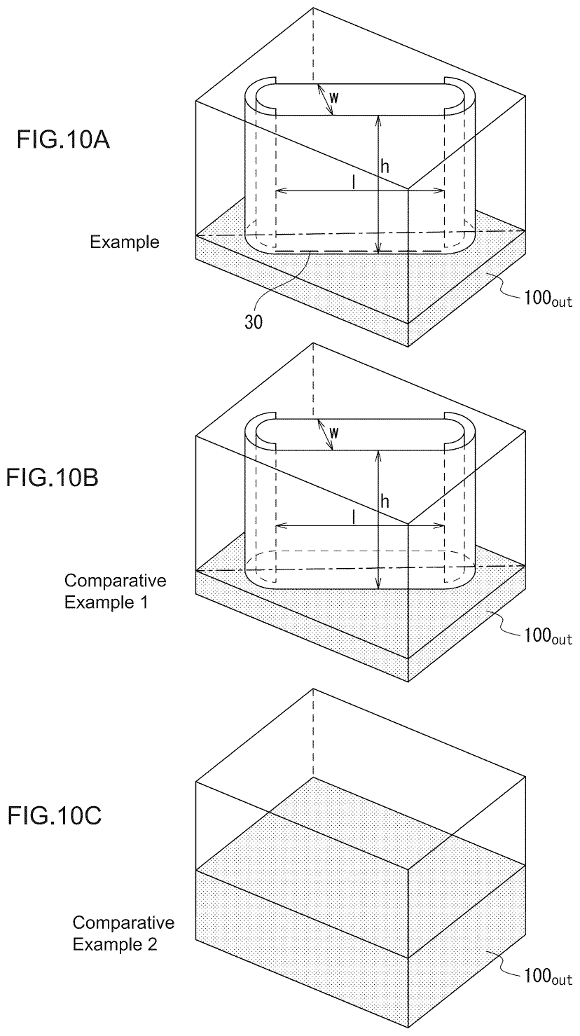

Next, based on the results of the water resistance evaluation of the flexible water-shielding film in Table 1, a buckwheat cultivation test was conducted, as shown in FIGS. 10A-FIG. 10C, with an inner diameter of 29 cm×29 cm and a height of 23 cm, with an open top and a bottom of A mesh planting box was prepared. This 10 planting box was placed on a wire net laid on a flat surface, and cultivating soil 100 with a moisture content of less than 3% was filled inside the planting box to a height of 5 cm. Then, the following test growing sites a through c were prepared.

(Test growing area a: Example): Made of flexible water-shielding film of 60 μm thick low-density polyethylene film of sample 1 in Table 1, 1=30 cm, h=12 cm, d=5 cm, w=3 to 5 cm, as defined in FIG. 1B, with the bottom perforated by ORFER Corporation with joint=1 mm and non-bonded part=2.7 mm. An insertion part 1d was prepared with intermittent joints 30 and the bottoms connected in a V-shape shown in FIG. 10A. On the other hand, a planting box as shown in FIG. 10A is prepared, 5 cm thick cultivating soil 100 is spread on the box, and the insertion part 1d is stored in the planting box so that the diagonal direction of the box is the longitudinal direction. The insertion part 1d is then filled with 720 cc of cultivating soil 100, and soil of the same height as the insertion part 1d is buried around the perimeter of the insertion part 1d to make a test growing area for the example.

(Test cultivation site b: Comparative example 1): An insertion part of a cultivation member made of flexible water-shielding film of low-density polyethylene film of 60 μm thickness, sample 1 in Table 1, with the shape shown in FIG. 10B, l=30 cm, h=12 cm, d=5 cm, w=3 to 5 cm and the bottom is open. On the other hand, 100 out of soil with a thickness of 5 cm is placed in a planting box as shown in FIG. 10B, and the insertion part is stored in the planting box so that the diagonal direction of the box is the longitudinal direction. The insertion part is then filled with 720 cc of 100 cultivating soil, and the same height of soil is buried around the perimeter of the insertion part to make a test growing area for comparative example 1.

(Test cultivation site c: Comparative example 2): The insertion part was not used, and the planting box was directly filled (additionally filled) with cultivating soil 100 out to a height of 15 cm, as shown in FIG. 10C, to make a test cultivation site pertaining to Comparative Example 3.

Then, two buckwheat seeds were seeded each at 1 cm intervals from the center on the diagonal line of each cultivating soil directly filled in the planting box, as shown in 100 filled in each insertion part prepared as test growing sites a and b, respectively, and test growing site c, Comparative Example 2. After seeding, the buckwheat seeds were lightly covered with soil and irrigated with 1,000 cc of water. The number of germinating buckwheat plants and the approximate length of above-ground growth of the germinated plants in the test cultivation sites a-d are shown in Table 2.

TABLE 2

| | Germinating | Length of above-ground |
|---|---|---|
| Test growing area | number | growth of the germinated plants |
| a (Example) | 16 | 13-15 cm × 14 |
| | | 3-5 cm × 2 |
| b (Comp. exam. 1) | 2 | 10-12 cm × 1 |
| | | 3-5 cm × 1 |
| c (Comp. exam. 2) | 4 | Approx. 7 cm × 4 |

Next, a 6-day test cultivation of buckwheat was conducted in the same manner as the test cultivation in Table 2, using samples 2-5 and a comparative impervious membrane instead of the low pressure method polyethylene film of sample 1 shown in Table 1. The results are shown in Table 3.

TABLE 3

| | | | Length of above- |
|---|---|---|---|
| | Composition of | | ground growth of |
| | Water-Shielding | Germinating | the germinated |
| | Film | number | plants |
| Examples | Sample 2 | 13 | 13-15 cm × 2 |
| | (Kraft paper) | | 10-12 cm × 9 |
| | | | 3-5 cm × 2 |
| | Sample 3 | 17 | 13-15 cm × 11 |
| | (Kraft paper + | | 10-12 cm × 3 |
| | natural rubber) | | 3-5 cm × 3 |
| | Sample 4 | 14 | 13-15 cm × 9 |
| | (Kraft paper + | | 10-12 cm × 3 |
| | molten wax) | | 3-5 cm × 2 |
| | Sample 5 | 10 | 3-15 cm × 6 |
| | (Oil paper) | | 10-12 cm × 4 |
| Comparative | Cooking paper | 2 | 3-5 cm × 2 |
| examples | | | |

### —Disruption of Hydrogen Bonds in Plant Fibers—

The flexible water-shielding film used in the insertion part 1d for the first embodiment of the present invention can be either a single water-shielding film or a composite water-shielding film, as described at the beginning of this article. Whether the composite water-shielding film has a three-layer laminate structure with a central layer of plant fibers sandwiched between surface layers of hydrophobic material on both sides, an impregnated or inner structure with hydrophobic material embedded in the plant fibers, the mechanism of the temporal disruption on hydrogen bonds is the same. When water penetrates the plant fibers that consist of the composite water-shielding film, the hydrogen bonds strength between the plant fibers decrease due to the disruption of the hydrogen bonds in the cellulose and hemicellulose that are the constituent molecules of the plant fibers. Therefore, the layers of plant fibers in the vicinity of the intermittent joint 30 are subjected to a pulling-off force due to the weight and expansion force of the filled cultivating soil 100, and selectively rupture over time in preference to the parts of the composite water-shielding film at a distance from the intermittent joint 30. The closing mechanisms (19L, 19R), which were restrained from sliding mechanism displacement at the intermittent joint 30, are unrestrained from sliding mechanism displacement by the selective temporal rupture of the intermittent joint 30, and each layer of the sliding mechanism can freely slide and displace along the plane direction. As a result, the in-plane stresses of the insertion part 1d at locations away from the intermittent joint 30 are reduced and the rupture resistance is improved. At the same time, selective downward extension of the plant root system 301 of the planted plant 300 is induced into the ground 200 at a level deeper than the position of the lower end 13d of the insertion part 1d inside the furrow 210, thereby preventing curling of the plant root system 301.

### <First Variation of the First Embodiment>

The insertion part 1q of the cultivation member for the first variation of the first embodiment of the present invention has a plurality of longitudinal folds formed in the flexible water-shielding film consisting of the insertion part 1q, as shown in FIG. 20. Here, “vertical” means a direction close to the vertical direction when the insertion part 1q is inserted into the interior of the 210 planting furrow. The other members, the connection relationship of the members, and the method of use are the same as those of the insertion part 1d of the cultivation member of the first embodiment. The longitudinal fold formation comprising the first and second main walls 10d₁ and 10d₂ can be obtained by passing the flexible water-shielding film through a pleating machine. In the case of a composite water-shielding film, the composite water-shielding film of the coating impregnation system, the composite water-shielding film of the internal paper attachment system, or the composite water-shielding film of the lamination system described at the beginning of the embodiment is either (a) passed through a pleating machine to form folds and then folded to form the opposite side, and then a intermittent joint is formed at the lower end, or (b) passed through a pleating machine to form the lower end of the opposite side, which is made of a flexible water-shielding film. (b) forming a member with an intermittent joint at the lower end of the facing surface, and then hanging the member on a pleating machine to form folds, etc., so that the composite water-shielding film can be made into a wavy film in a batch.

The longitudinal folds formed on the main wall 10q made of flexible water-shielding film are pleated and can be formed to any width by passing the flexible water-shielding film sheet, which is the material of the main wall 10q made of flexible water-shielding film, through a pleating machine. After forming longitudinal folds on the flexible water-shielding film that will be the material for the first and second main walls 10d₁ and 10d₂, which are made of flexible water-shielding film in sheet form, a pattern with repeated intermittent slits is formed by a rotary cutter with an intermittent blade along the folded line in a linear fashion. Then the flexible water-shielding film can be formed into a U-shaped basic storage structure similar to that shown in FIG. 1A. The number of folds should be 10 or more or the width of the folds should be 3 cm or less.

Regarding the insertion part 1q of the cultivation member for the first variant of the first embodiment, it is preferable to use it for 210 planting furrows, such as in a fixed planting site, whose circumference is shorter than the circumference when the longitudinal folds are extended. That is, the insertion part 1q shown in FIG. 20 is used by inserting it into the inside of the planting furrow 210 of the planting ground or the like while maintaining the longitudinal folds of the insertion part 1q shown in FIG. 20. The insertion part 1q can be used for either seedling or planting in the same way as the insertion part 1d of the cultivation member of the first embodiment. As shown in FIG. 20, the insertion part 1q of the cultivation member pertaining to the first variant of the first embodiment having longitudinal folds on the entire circumference increases the vertical stiffness and facilitates insertion into the interior of the planting furrow 210 of the planting site or the like. Furthermore, the corrugation of the folds improves rupture resistance against expansion of the cultivating soil 100 due to the growth and enlargement of the plant root system 301, etc., through a process of gradual resolution of the corrugation over time. The longitudinal folds of insertion part 1q function similarly to the ribs (striations) and slits in a forestry seedling contraption, in that the insertion part 1q inhibits the curling of the plant root system 301. Therefore, the longitudinal folds act as an expansion buffer when the root pot grows and expands inside the insertion part 1q, thereby improving the rupture resistance of the insertion part 1q.

### <Second Variation of the First Embodiment>

The insertion part 1d of the cultivation member for the second variation of the first embodiment of the present invention is an insertion part 1d in which the intermittent joint 30 of the insertion part 1d is filled with superabsorbent resin as one of the cultivating soils 100. The location of the filling arrangement of the superabsorbent resin can be selected at any time, but at least it should be placed in the non-bonded parts 41d of the intermittent joint 30. The superabsorbent resin placed in the non-bonded parts 41d expands with irrigation water to seal the non-bonded parts 41d, thereby reducing dropout and leakage of the filled cultivating soil 100 and irrigation water from the non-bonded parts 41d, thereby improving the water storage function of the cultivating soil 100. In addition, the rate of water volatilization is slower in hydrous superabsorbent resin than in moisturized ordinary cultivating soil 100. For this reason, a higher moisture concentration gradient is formed downward in the cultivating soil 100 filled inside the storage structure. As a result, selective downward elongation of the plant root system 301 of the planted plant 300 is promoted by the moisture flexion due to moisture penetrating the intermittent joint 30, and root curling of the plant root system 301 is prevented.

The superabsorbent resin used for the insertion part 1d of the cultivation member pertaining to the second variation of the first embodiment can be any known superabsorbent resin, such as polyacrylic soda, PVA-based, starch, polyamino acid, polysaccharide-based, etc. cross-linked by cross-linking agents or electron beams. The resins can be used.

### <Third Variation of the First Embodiment>

The insertion part 1d of the cultivation member for the third variation of the first embodiment has a structure in which a seed, spore, or mycorrhiza is inserted into the insertion part 1d together with the cultivating soil 100. Useful parasitic plants are known to parasitize the 301 plant root system of a particular host plant and grow by obtaining nutrients from the host plant. For example, the cistanche which parasitizes the haloxylon and the mountain alder, the sandalwood which parasitizes the grass family asteraceae, the family of bamboo acacia, pongamia pinnata, and the like, the matsutake which parasitizes the red pine, For artificial propagation, seeds, spores, and mycorrhizas of these useful parasitic plants are planted at a certain depth near the host plant, or are planted together with the host plant. The method of inserting a component with seeds, spores, mycorrhizae, etc. of useful parasitic plants at a certain depth of the filled cultivating soil 100 into the interior of the 210 planting furrow formed by digging near the growth site of the host plant and parasitizing the host plant that has been extended by the collapse of the composite water-shielding film is possible. The combined placement of superabsorbent resin, fertilizer, etc. around seeds, spores, mycorrhizae, etc. of useful parasitic plants at a certain depth of the filled cultivating soil 100 can be an inducing factor for the plant root system 301 of the host plant.

It is possible to plant host seeds and seedlings by mixing fungi, etc. into the cultivating soil 100 filled inside the storage structure of the insertion part 1d, and then filling it with additional cultivating soil. Alternatively, the host seeds and seedlings can be planted by enclosing the bacteria in a bag made of water-soluble or biodegradable film, attaching the bag containing the bacteria to a predetermined position on the inside or outside of the opposite side that forms part of the U-shaped structure, filling the inside of the storage structure with the cultivating soil 100, and planting the host seeds and seedlings. It is also possible to place the superabsorbent resin in close proximity to the fungus, etc., to attract the plant root system 301 of the host plant to the moisture of the superabsorbent resin that has absorbed moisture. In the insertion part 1 of the cultivation member for the third variant of the first embodiment, workability is improved by simultaneously planting the host plant seeds and seedlings and the parasitic inoculum, etc. Also, by controlling the degradability of the film of the bag containing the fungus, etc., it is possible to control the time for the 301 plant root system of the host plant to reach the fungus, etc. by extension.

### Second Embodiment

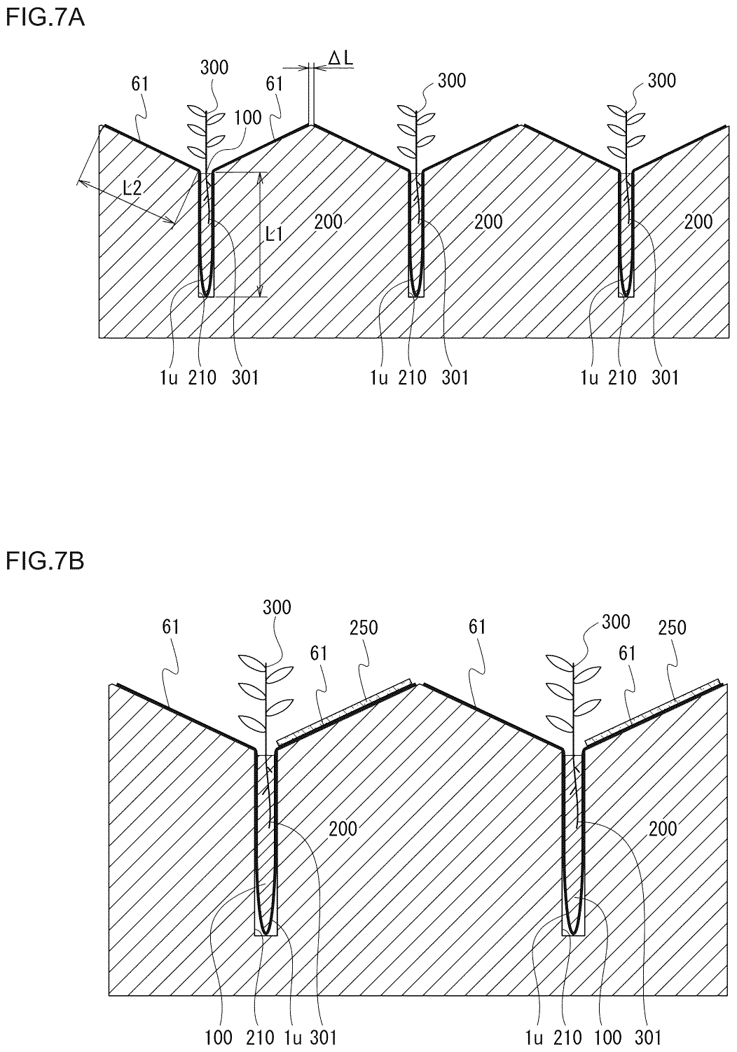

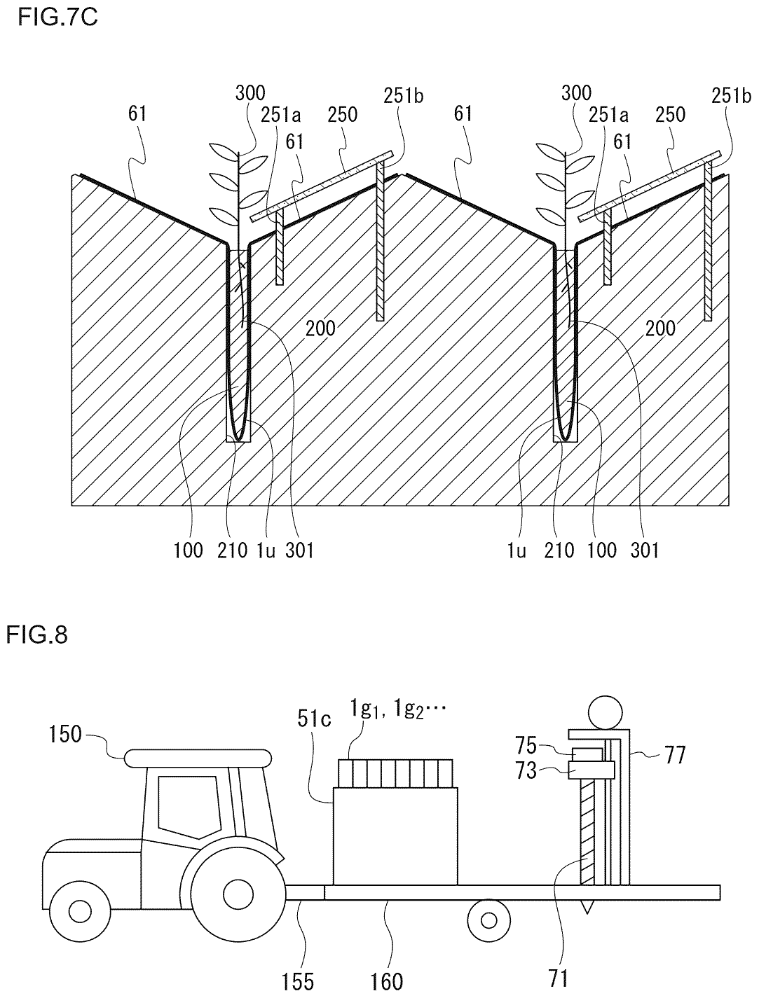

As shown in FIG. 7A, the cultivation member of the second embodiment of the present invention has an insertion part 1u of length L1, which is inserted into the interior of a formed by digging planting furrow 210 in a ground 200 of a planting place, and an extension part 61 of length L2, which is connected to the upper end of the insertion part 1u in a continuous manner. Although FIG. is omitted, the extension part 61 is similar to the insertion part 1d of the first embodiment of the cultivation member shown in FIG. 1B, in that it is commonly consist of one flexible water-shielding film, but the first main wall 10d₁ shown on the lower side of FIG. 1B is extended further down as a rectangle of length L2, and the second main wall 10d₂ shown on the upper side extends further upward as a rectangle of length L2.

The flexible water-shielding film can be either a single water-shielding film or a composite water-shielding film, similar to the insertion part 1d of the cultivation member of the first embodiment. The insertion part 1u shown in FIG. 7A has a storage structure that is at least partially surrounded by walls made of flexible water-shielding film so that it has a non-planar bottom region. As in FIG. 1A, the first left auxiliary piece and the second left auxiliary piece are entrained to form part of a cylindrical curved surface of nearly identical curvature on the front side of the paper in FIG. 7A, constituting a sliding mechanism that allows the superimposed surfaces to slide in opposite directions of each other. Furthermore, the first right auxiliary piece and the second right auxiliary piece are wound to form a part of the cylindrical curved surface of almost identical curvature at the back side of the paper surface in FIG. 7A, and constitute a sliding mechanism that allows the superimposed surfaces to slide in opposite directions of each other.

Thus, by having a sliding mechanism on part of the wall surface, the feature of structurally assisted stress-free variability, which allows the shape of at least the upper part of the outer shape defined by the storage structure to be deformed without increasing in-plane stress of the flexible water-shielding film and enables the internal volume to be increased, is similar to the structure of the insertion part 1d of the cultivation member in the first embodiment. In FIG. 7A, a plurality of water penetration channels are arranged one-dimensionally in the bottom region of the insertion part 1u, although detailed illustrations are omitted in FIG. 7A. Thus, as shown in FIG. 7A, in the state of being inserted inside the planting furrow 210, the insertion part 1u is filled with cultivating soil 100, plants 300 are planted in the filled cultivating soil 100, and the plants 300 are allowed to grow. When the plant 300 is grown by irrigation, the feature of having a structure in which a part of the bottom region in the vicinity of the penetration channel of the insertion part 1u is selectively temporal rupture by irrigation is the same as the structure of the insertion part 1d of the cultivation member in the first embodiment. That is, when the insertion part 1u is consist of a single water barrier membrane, the intermittent joint 30 ruptures selectively over time due to the hydrotropism expansion effect of the plant root system 301, and when it is consist of a composite water-shielding film, the selective temporal rupture becomes more efficient due to the cumulative effects of both the root hydrotropism expansion effect and the disruption effect of the hydrogen bond of the plant fiber that constitutes the composite water-shielding film.

The second embodiment of the plant cultivation system has a wavy (serrated) planting place ground 200 with ridges of s both sides inclined body at the top, and a plurality of planting furrows 210 dug periodically between the ridges of the ground 200. An insertion part 1d, which is a storage structure of length L1 with a non-planar bottom region, is inserted into each of the plurality of planting furrows 210. Each of the plurality of insertion parts 1d is filled with cultivating soil 100. The cultivation member of the second embodiment is consist of an extension part 61 made of flexible water-shielding film and an insertion part 1u made of flexible water-shielding film connected continuously to the lower end of the extension part 61 as a single unit. The extension part 61, which forms part of the second embodiment of the cultivation member, covers the inclined side body closer to the insertion part 1u of each of the plurality of ridged parts of the both-sides inclined body as the upper structure of the ground 200, as shown in FIG. 7A, and the ends of the extension part 61 are secured with pegs, soil etc. Since the extension part 61 can collect irrigation and condensation water widely and pour it into the interior of the insertion part 1d inserted into the 210 planting furrows at the bottom (lowest part) of the recession, it is possible to achieve both the contradictory conditions of suppression of evaporative water by the insertion part 1d inserted into the 210 planting furrows with a small surface area and high aspect ratio and collection of rainwater and filtered water widely.

In the plant cultivation system for the second embodiment, the extension part 61 continuous with the insertion part 1u surrounds the insertion part 1u as an integral member, covering the both-sides inclined body consist of each of the plurality of ridges. Therefore, in addition to the effect obtained by the insertion part 1d of the cultivation member for the first embodiment, rainwater in the cultivating place is efficiently collected by the extension part 61 and can descend into the interior of the insertion part 1u. Therefore, according to the plant cultivation system of the second embodiment, an irrigation system that effectively utilizes rainwater is realized.

### <First Variant of the Second Embodiment>

The plant cultivation system according to the first variant of the second embodiment of the present invention has solar panels 250 placed on at least a part of the extension part 61 of the cultivation member, as shown in FIG. 7B. Although the structure of the both-sides inclined body is illustrated in FIG. 7B, the solar panels 250 can be applied to both one-side inclined body and both-sides inclined body, and the effective incline on which the solar panels 250 can be placed should be selected according to the sunlight conditions. As shown in FIG. 7B, the solar panel 250 can be used as one of the hydrophobic material films on at least part of either the main o secondary incline of the one-side inclined body, or at least part of the one side of the both-sides inclined body. Solar panels 250 made of inorganic materials such as glass and Si are preferred as a condensation material for atmospheric moisture because they have a large heat capacity and are difficult to heat up and difficult to cool down, thus easily creating a temperature difference with the atmosphere, which warms up and cools down easily. For example, by using a solar panel 250 on the one side of the both-sides inclined body and a solar reflector on the other inclined side, it is possible to combine solar power generation with irrigation systems that use natural water.

### <Second Variation of the Second Embodiment>

The plant cultivation system for the second variation of the second embodiment of the present invention is shown in FIG. 7C, in which solar panels 250 are arranged above at least part of the extension part 61 of the cultivation member using lower and upper pillars 251a and 251b. Although FIG. is omitted, it is also possible to adjust the angle of the solar panels 250 and use the reflected light from the solar panels 250 for photosynthesis of the planted plants by adding an angle adjustment function for the solar panels 250 to the lower and upper pillars 251a and 251b, respectively. Although the structure of the both-sides inclined body is illustrated in FIG. 7C, the solar panels 250 can be applied to both one-side inclined body and both-sides inclined body, and the effective inclined side where the solar panels 250 can be placed should be selected according to the sunlight conditions. Since solar panels 250 have a large thermal capacity and are difficult to heat up and cool down, a temperature difference is easily generated between the solar panels 250 and the atmosphere, which is easy to heat up and easy to cool down. Rainwater and condensation water collected by the solar panel 250 flows into the filled cultivating soil 100 of the insertion part 1u through the water collection holes between the ridges, enabling both solar power generation and an irrigation system using natural water from natural sources.

### Third Embodiment

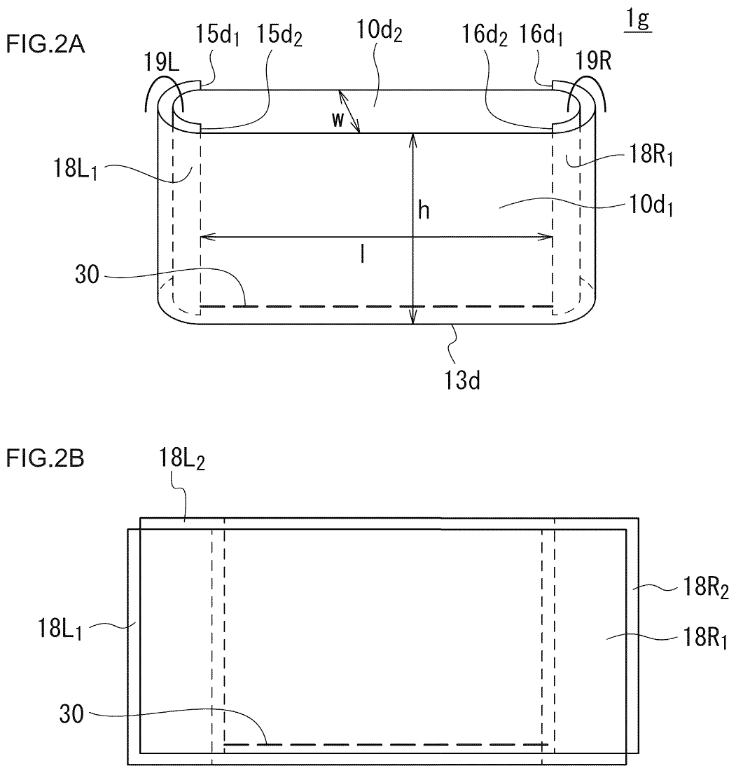

The insertion part 1g of the cultivation member of the third embodiment of the present invention consists of a first main wall 10d₁ and a second main wall 10d₂ made of flexible water shielding films that are independent (separated) from each other, as shown in FIG. 2A. The flexible water-shielding film can be either a single water shielding film or a composite water shielding film, similar to the insertion parts 1d and 1u of the cultivation members of the first and second embodiments. That is, as shown in FIG. 2B, the insertion part 1g of the cultivation member of the third embodiment has an intermittent joint 30 that selectively temporal ruptures in the center of the bottom region of each of the first main wall surface 10d₁ and the second main wall surface 10d₂, which are made of two flexible water shielding films, and forms the pseudo-sack with a missing bottom (storage body structure) in which the bottom region is closed like a beak and the upper end is an open. The selective temporal rupture of the intermittent joint 30 can promote selective downward elongation of the plant root system of planted plants with a small amount of irrigation, and has the effect of preventing root curling of the plant root system 301. That is, as shown in FIG. 2A, the insertion part 1g of the cultivation member of the third embodiment has a storage structure with a non-planar bottom region. Furthermore, since the insertion part 1g has a sliding mechanism that allows the superimposed surfaces to slide in opposite directions on some of the walls that form the storage structure, at least the upper end of the storage structure can be deformed to consume the volume of the gap space set between the planting furrow 210 and the insertion part 1g without increasing the in-plane stress of the flexible water-shielding film. That is, the insertion part 1g of the cultivation member of the third embodiment is similar to the insertion part 1d of the cultivation member of the first embodiment in that it has a first main wall surface 10d₁ and a second main wall surface 10d₂, each made of a flexible water-shielding film, opposed to each other, a left closing mechanism 19L and a right closing mechanism 19R made of sliding mechanisms on both sides of the U-shaped opposing structure, and realizes a structure supported stress-free variability with the pseudo-sack with a missing bottom. However, it differs from the insertion part 1d of the cultivation member for the first embodiment in that the two flexible water-shielding films, independent of each other, are the first main wall 10d₁ and the second main wall 10d₂.

“Intermittent joint 30” refers to a repeating structure of alternating one-dimensional arrays of joining the bonding part of the first main wall 10d₁ and the second main wall 10d₂ to each other and non-bonded parts separating the first main wall 10d₁ and the second main wall 10d₂ without being joined, which are continuous. The non-bonded part comprise a one-dimensional array of plurality of penetration channels for moisture along the vertical direction to form the intermittent joint 30. In the intermittent joint 30, the intermittently bonded part correspond to the points where the first main wall 10d₁ and the second main wall 10d₂ are joined to each other by hand sewing, thread sewing with a sewing machine, or by binding with a stapler needle. In thread sewing or binding with a stapler needle, the bonded part and the non-bonded part between adjacent bonded parts are alternately arranged in one dimension to form a continuous repeating structure, and the bottom regions of the first and second main walls 10d₁ and 10d₂ are joined on opposite sides. In the suture or binding of the composite water-shielding film, it is possible to expose the plant fibers of the composite water-shielding film at the penetration of the suture or stapler needle. Similar to the insertion part 1d of the cultivation member of the first embodiment, the insertion part 1g of the cultivation member of the third embodiment is inserted inside each of the 210 formed by digging a plurality of planting furrow in the ground 200 of the cultivating place. The insertion part 1g can then be applied to a cultivation system in which each of the insertion part 1g is filled with cultivating soil 100, plant 300 is planted in each of the filled cultivating soil 100, and the plant 300 is irrigated with natural water to cultivate each plant 300. In the cultivation system of the third embodiment, the structure of the insertion part 1g of the cultivation member of the third embodiment, as well as the insertion part 1d of the cultivation member of the first embodiment, because it is a structure in which a small amount of water to leak out along the vertical direction from the intermittent joint 30 and cannot be a completely sealed bag, is also called a “pseudo-sack”. Furthermore, a pseudo-sack lacking a flat bottom is called a “pseudo-sack with a missing bottom” to describe the structure of the insertion part 1d with a non-planar bottom region.

That is, in the structure of the insertion part 1g of the third embodiment of the cultivation member, the storage surface located at the back side of FIG. 2A is defined as “second main wall 10d₂” for convenience, and the storage surface with a rectangular flat part of height h and width l located at the front side is defined as “first main wall 10d₁” for convenience. In the exploded view in FIG. 2B, the face of the flexible water-shielding film located at the back side becomes the second main wall 10d₂ including the rectangular area of h×l, and the face of the flexible water-shielding film located at the front side becomes the first main wall 10d₁. In the assembly view in FIG. 2A, the first bottom region is based on the height h defined between the bottom 13d and the top of the first main wall 10d₁ located in the front, and the band of width Δh, which is less than 10% of this height h and has the bottom 13d as its lower end. In the partial view (exploded view) of FIG. 2B, a height h can be defined between the lower end 13d and the upper end 14a₂ of the second main wall 10d₂ located on the upper side, and a band of width Δh that is less than 10% of the width of this height h is the second bottom side region. At a position included in each of these regions, there is an intermittent joint 30 that selectively rupture over time so as to close the bottom region in a beak shape.

The intermittent joint 30 shown schematically as a single break line in the center of the bottom region of the development of the insertion part 1d of the cultivation member of the first embodiment shown in FIG. 1B corresponds to the extreme limit of Δh→0 of the insertion part 1g of the cultivation member of the third embodiment. However, in the structure of the insertion part 1g of the cultivation member for the third embodiment, a finite width Δh is required to configure the intermittent joint 30 by thread sewing or stapler binding so as to achieve a joint of a certain strength. Therefore, Δh=0 is impossible, and a minimum Δhₘᵢₙ of about 0.5 mm is required.

As shown in FIG. 2B, the first left auxiliary piece 18L₁ of the first main wall 10d₁ is an entrapment auxiliary wall that is planned to be placed on the left side of the first main wall 10d₁ as a rectangle with the first side end 15d₁ shown in FIG. 2A as one of its long sides and to be wound in a curved shape. The first right auxiliary piece 18R₁, shown in FIG. 2B, is a rectangle with the second side 16d₁ shown in FIG. 2A as one of its long sides, is located on the right side of the first main wall 10d₁, and is a wrapping auxiliary wall that is a mirror image of the first left auxiliary piece 18L₁. On the other hand, the second left auxiliary piece 1812 on the second main wall 10d₂ is an entrapment auxiliary wall placed on the left side of the second main wall 10d₂ as a rectangle with the third side 15d₂ as one of the long sides in FIG. 2A, and the second right auxiliary piece 18R₂ is a rectangle with the fourth side 16d₂ as one of the long sides, with height d, and is a mirror image of the second main wall 10d₂. The second right auxiliary wall 18R₂ is a wall that is positioned on the right side of the second main wall 10d₂ with the fourth side 16d₂ as one of the long sides, and is a mirror image of the second left auxiliary wall 18L₂. The first left auxiliary piece 18L₁, the first right auxiliary piece 18R₁, the second left auxiliary piece 18L₂ and the second right auxiliary piece 18R₂ may be right-angled trapezoids with tapered sides similar to the insertion part 1d of the cultivation member in the first embodiment.

In FIG. 2A, the left side end of the pseudo-sack with a missing bottom is closed by a sliding mechanism in which the first left auxiliary piece 18L₁ is part of the outer cylindrical surface and the second left auxiliary piece 18L₂ is part of the inner cylindrical surface superimposed on each other, but this is only an example. The left closing mechanism 19L may be configured by a stacked structure in which the first left auxiliary piece 18L₁ forms part of the inner cylindrical surface and the second left auxiliary piece 18L₂ is superimposed so that they form part of the outer cylindrical surface, so that the two pieces can be slid in close contact with each other. Similarly, a structure that closes the right side of the pseudo-sack with a missing bottom by a sliding mechanism in which the first right auxiliary piece 18R₁ forms part of the outer cylindrical surface and the second right auxiliary piece 18R₂ forms part of the inner cylindrical surface superimposed on each other is shown in FIG. 2A and is only an example. The right closing mechanism 19R may be configured with a stacked structure in which the first right auxiliary piece 18R₁ forms part of the inner cylindrical surface and the second right auxiliary piece 18R₂ forms part of the outer cylindrical surface, so that the two pieces can be slid in close contact with each other. The superimposed surface structure of the first left auxiliary piece 18L₁ and the second left auxiliary piece 18L₂ and the superimposed surface structure of the first right auxiliary piece 18R₁ and the second right auxiliary piece 18R₂ can autonomously slide the surfaces in close contact by dry surface contact, wet surface contact or mechanical surface contact, as described in the first embodiment. The sliding mechanism may be consist of a combination of dry surface contact and mechanical surface contact, or a combination of wet surface contact and mechanical surface contact. In the same way in the situation where the insertion part 1g is inserted inside the 210 planting furrow, the pressure from the inside to the outside of the pseudo-sack with a missing bottom when the insertion part 1g is filled with cultivating soil 100 will cause the surfaces of the two flexible water-shielding films to stick together to form a sliding surface structure.

Holes occur directly below the area where the superimposed surface structure of the first left auxiliary piece 18L₁ and the second left auxiliary piece 18L₂ protrudes in the left direction, and also directly below the area where the superimposed surface structure of the first right auxiliary piece 18R₁ and the second right auxiliary piece 18R₂ protrudes in the right direction. Cultivating soil 100 may fall through these holes on both sides. To eliminate the problem of falling, it is preferable to prepare a fall prevention auxiliary piece that is larger than the area (size) of the holes and can fill the holes, and to add a fall prevention auxiliary piece to each of the holes at both ends of the bottom region, so that a superimposed area occurs around the holes. The ends of the anti-fall prevention auxiliary pieces may be semi-fixed or fixed to both ends of the bottom region by sewing, stapler needle, glue, etc. As shown in FIGS. 2A and 2B, an intermittent joint 30 that selectively temporal rupture is provided in the central bottom side region, excluding the part that constitutes the left closing mechanism 19L, which is the folding and closing mechanism on the left side end of the pseudo-sack with a missing bottom, and the part that constitutes the right closing mechanism 19R, which is the folding and closing mechanism on the right side end. By providing the intermittent joint 30, the first main wall 10d₁ and the second main wall 10d₂, which were independent of each other as the original material, are processed integrally as a pseudo-sack with a missing bottom, and the insertion part 1g of the cultivation member in the third embodiment is configured.

As already mentioned, the insertion part 1g of the cultivation member pertaining to the third embodiment differs from the insertion part 1d of the cultivation member of the first embodiment in that it consists of two flexible water-shielding films. That is, in the insertion part 1g of the cultivation member of the third embodiment, the second main wall 10d₂ on the far side and the first main wall 10d₁ on the front side are arranged opposite each other with the horizontal position of the respective lower end 13d shown on the lower side of FIG. 2B as a reference position. The two independent flexible water-shielding films made of independent materials intermittently join the first bottom region and the second bottom region to achieve the structure of a beak-shaped, folded, pseudo-sack with a missing bottom. Accordingly, the bottom of the insertion part 1g is folded into a beak-shape by intermittently joining the first bottom side region and the second bottom side region of the strip with a width of Δh≤h/10, respectively, facing each other in the state shown in FIG. 2A, with the position of the respective lower end 13d as a common reference position.

As shown in FIG. 2A, the second main wall 10d₂ of the insertion part 1g of the third embodiment of the cultivation member has a second bottom region having the lower end 13d, a third side end 15d₂ orthogonal to the longitudinal direction of this second bottom region, a third side end 15d₂ perpendicular to the longitudinal direction of the second bottom region, and a fourth side end 16d₂ which is the other end spaced apart from and facing parallel to the third side end 15d₂, and is a rectangular thin film surface including a rectangular area of h×l. The first main wall 10d₁ shown in FIG. 2A has a first side end 15d₁ opposite and spaced apart from the third side end 15d₂ of the second main wall 10d₂. Furthermore, the first main wall 10d₁ has a second side end 16d₁ opposite the fourth side end 16d₂ of the second main wall 10d₂, separated from the first side end 15d₁, and parallel to the first side end 15d₁, in the state shown in FIG. 2A. The first main wall 10d₁ is a thin-film surface of the same shape and size as the second main wall 10d₂, as shown in FIGS. 2A and 2B. The first bottom region of the first main wall 10d₁ faces parallel to the longitudinal direction of the second bottom region in the state shown in FIG. 2A. Along the longitudinal direction of the second bottom region, there are intermittent joint at plurality of locations that intermittently join with a part of the first bottom region. The intermittent joint 30 is consist of a repeating structure along the one-dimensional direction of a plurality of intermittently one-dimensionally arranged bonded part and a non-bonded parts between a plurality of intermittently one-dimensionally arranged bonded parts.

In the cultivation system of the third embodiment, at the time of planting or initial irrigation, in order to selectively extend downward the plant root system 301 of the plant 300 planted in the cultivating soil 100 in the insertion part 1g and prevent the insertion part 1g from rupture due to enlargement and growth, it is preferable to close the intermittent joints 30 of the insertion part 1g. Then, after the planting of plant 300 has taken root, it is preferable for the intermittent joint 30 to selectively rupture over time or selectively biodegrade over time and open earlier than other parts of the water-shielding film. In order for the intermittent joint 30 to selectively rupture or selectively degrade over time, the water-shielding film at the joint should be thinner. In the structure of the insertion part 1g of the third embodiment of the cultivation member shown in FIG. 2A, the water-shielding film layer is two layers, the first main wall 10d₁ and the second main wall 10d₂, but since the cultivating soil 100 is filled between the two layers of water-shielding film, it is essentially a combination of (one layer of the first main wall 10d₁)+(cultivation soil 100)+(10d₂ of the second main wall), which makes it easier for facilitates selective rupture or selective biodegradation over time to occur.

When the insertion part 1g consists of a single water-shielding film, the intermittent joint 30 is selectively rupture over time due to the root hydrotropism expansion effect of the plant root system 301. When the insertion part 1g is consisted of a water-shielding film, selective temporal rupture occurs efficiently due to the cumulative effects of root hydrotropism expansion and disruption of hydrogen bonds of the plant fibers that make up the water-shielding film. In particular, the water-shielding film is cut through by sewing threads or stapler needles, exposing the plant fibers. Irrigation in the irrigation step does not penetrate the plant fiber base material laminated with hydrophobic resin film, but water penetrates and diffuses through the slightly formed exposed parts of the plant fiber base material. The water penetrates and diffuses through the exposed areas of the plant fibers in the penetrating cut. Therefore, the slight exposed plant fibers at the through-cut joint 30 are subjected to a pulling-off force due to the weight and expansion force of the filled cultivating soil 100, and selectively rupture over time in preference to the water-shielding film part at a distance from the intermittent joint 30.

In order to perform selective temporal rupture by exposure of plant fibers at a few penetration points more efficiently, “idiot hole sewing,” in which a through hole larger than the diameter of the sewing thread is made in advance at the penetration point of the sewing thread and a sewing thread thinner than the diameter of the through hole is passed through the through hole, is preferred. The through-hole sewing is an intermittent joining method similar to threading a string through the dovetail (lacing hole) of a shoe. The through hole larger than the diameter of the sewing thread allows water to permeate and diffuse toward the exposed parts of the plant fiber with higher efficiency. Similarly, “idiot hole sewing, etc.” will be referred to below as including the case where a through hole larger than the diameter of the stapler needle is made in advance at the penetration point of the stapler needle and a stapler needle thinner than the diameter of the through hole is passed through the through hole. Another way to design the intermittent joint 30 so that it ruptures selectively over time due to irrigation is to use water-soluble fibers for the sewing thread. In this case, the thickness of the sewing thread that ruptures at the desired time should be selected in advance through preliminary experiments. When water-soluble fibers are used for the sewing threads, a single water-shielding may be used instead of a composite water-shielding film.

The left closing mechanism 19L and the right closing mechanism 19R, which were restrained from shifting the relative position of the two stacked water-shielding film by the intermittent joint 30, are released from the shifting restraint by the selective temporal rupture of the intermittent joint 30, and the relative position of the two water-shielding films can be freely slid and shifted along the face direction. The relative position of the two water-shielding films of the cross-laminated part of the closing mechanism (19L, 19R) can slide freely along the plane direction, and the volume of the pseudo-sack with a missing bottom can be changed. This reduces the in-plane stress and improves the rupture resistance of the pseudo-sack with a missing bottom, since the intermittent joint 30 is selectively rupture over time, the plant root system 301 of the plant 300 can extend into the ground 200 deeper than the intermittent joint 30 in the planting furrow 210. Thus, the selective downward extension of the plant root system 301 is made possible and root curling of the plant root system 301 is prevented.

### Fourth Embodiment

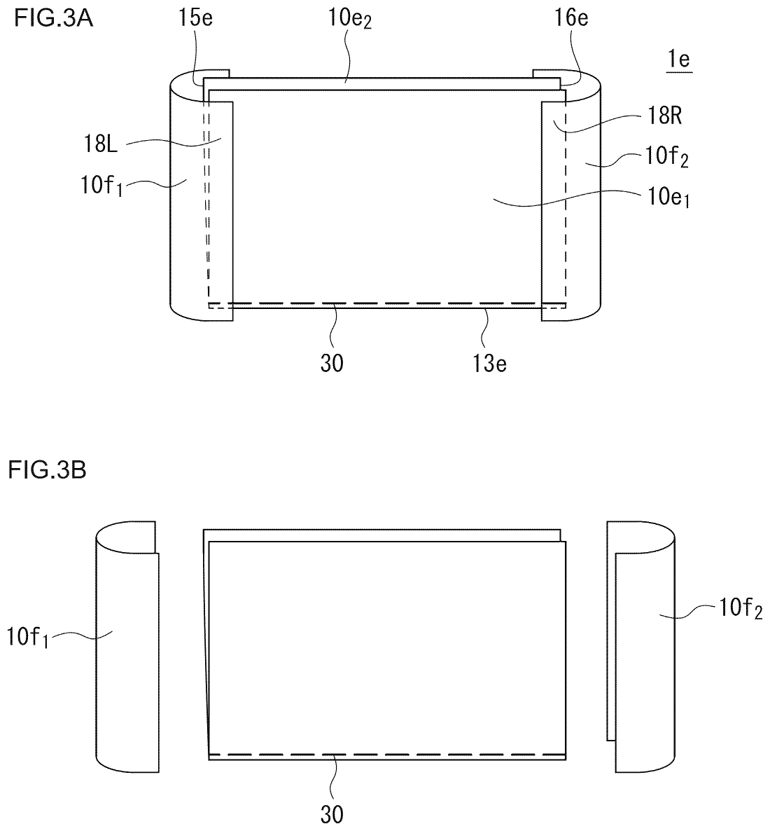

The insertion part 1e of the cultivation member of the 4th embodiment of the present invention consists of four flexible water-shielding films, the first main wall 10e₁, the second main wall 10e₂, the left auxiliary wall 10f₁ and the right auxiliary wall 10f₂, which are independent (separated) each other, as shown in FIG. 3A, as the original material (raw material). The flexible water-shielding film can be either a single water-shielding film or a composite water-shielding film, as with the insertion parts 1d, 1e, 1u, 1f, and 1g of the cultivation members of the first through third embodiments. In the exploded view of the pre-assembly stage shown in FIG. 3B, the first main wall 10e₁ and the second main wall 10d₂, which are rectangular flat plates of the same size as each other, face each other in parallel. The left auxiliary wall 10f₁, a U-shaped curved surface, is placed on the left side of the parallel-opposed structure of the first and second main walls 10e₁ and 10d₂ as a covering for the closing mechanism on the left side end, and the right auxiliary wall 10f₂, a U-shaped curved surface in mirror image relationship with the left auxiliary wall 10f₁, is placed on the right side end of the parallel-opposed structure of the first and second main walls 10d₁ and 10e₂. 10f₂ is arranged as a covering for the closing mechanism on the right side end. As shown in FIG. 3A, the insertion part 1e of the 4th embodiment of the cultivation member has a non-planar bottom region to form a storage structure. Furthermore, the insertion part 1e has a sliding mechanism in a part of the wall that forms the storage structure and can deform at least the upper part of the storage structure to consume the volume of the gap space set between the planting furrow 210 and the insertion part 1e without increasing the in-plane stress of the flexible water-shielding film, thus providing structure-supported stress-free variability. As shown in FIG. 3B, the distance between the both side ends of the left auxiliary wall 10f₁ is slightly larger than the spacing between the parallel opposed structures of the first and second main walls 10e₁ and 10e₂, and is located outside the left side end of the parallel opposed structures. Therefore, the left auxiliary wall surface 10f₁ constitutes a left closing mechanism that functions as a sliding mechanism by being sandwiched from the outside in close proximity to the left side end of each of the first and second main walls 10d₁ and 10e₂ that form parallel opposed structures so that they can slide together. Both side ends of the right auxiliary wall 10f₂ are located outside the right side end of the parallel opposed structure of the first and second main walls 10e₁ and 10e₂, and are sandwiched from the outside in close proximity to each right side end of the first and second main walls 10e₁ and 10e₂, which form a parallel opposed structure, to function as a sliding mechanism.

The insertion part 1e of the cultivation member according to the 4th embodiment has the first main wall 10e₁ and the second main wall 10e₂ facing each other and an intermittent joint 30 that selectively rupture over time in the bottom region of each of the first main wall 10d₁ and the second main wall 10d₂. As in the case of the cultivation members of the first through third embodiments, when the insertion part 1e consists of a single water-shielding film, the intermittent joints 30 are selectively ruptured over time by the root hydrotropism expansion effect of the plant root system 301. If the insertion part 1e consists of a water-shielding film, selective temporal rupture occurs efficiently due to the cumulative effects of hydrotropism expansion and the disruption in hydrogen bonds of the plant fibers that make up the water-shielding film. The selective temporal rupture of the intermittent joint 30 has the effect of promoting selective downward elongation of the plant root system of planted plants with a small amount of irrigation. The feature shown in FIG. 3B, which constitutes a pseudo-sack with a missing bottom by closing the bottom region in a beak shape, is similar to the insertion part 1g of the cultivation member of the third embodiment. That is, the insertion part 1e of the cultivation member for the 4th embodiment is similar to the insertion part 1g of the cultivation member for the third embodiment in that the first main wall 10e₁ and the second main wall 10e₂, each made of flexible water-shielding film, face each other to form a loincloth-like pseudo-sack with open ends on both side ends. However, two mutually independent flexible water-shielding films, the first main wall 10e₁ and the second main wall 10e₂, are opposed to each other, with one left auxiliary wall 10f₁ constituting a left-side end closing mechanism and closing the left side end in a sliding manner, and one right auxiliary wall 10f₂ constituting a right-side end closing mechanism and closing the right side end in a sliding manner, In total, four flexible water-shielding films are used, which differs from the 1g insertion part of the cultivation member of the third embodiment.

The “intermittent joint 30” is similar to the insertion part 1g of the cultivation member for the third embodiment in that the “intermittent joint 30” is a repeating structure part in which the bonded part bonding the first main wall 10e₁ and the second main wall 10e₂ to each other and the non-bonded part between adjacent bonded part is arranged one dimensionally alternately and continuously. The non-bonded part comprises a plurality of permeation channels along the vertical direction of moisture and the like, arranged in a one-dimensional array of intermittent joint 30. Like the insertion part 1d and 1g of the cultivation member of the first and third embodiments, the insertion part 1e of the cultivation member of the 4th embodiment is also inserted into the interior of each of the 210 formed by digging a plurality of planting furrows in the ground 200 of the cultivating place, for example as shown in FIGS. 5 and 6A, etc. The insertion part 1e of the cultivation member of the 4th embodiment can then be applied to a cultivation system in which the interior of each of the insertion parts 1e is filled with cultivating soil 100, plants 300 are planted in each of the filled cultivating soil 100, and the plants 300 are irrigated with natural water. The structure of the insertion part 1e of the cultivation member according to the 4th embodiment is also called a “pseudo-sack” in the same way as the insertion parts 1d and 1g of the cultivation member according to the first and third embodiments, since leakage of a small amount of irrigation from the intermittent joint is planned along the vertical direction and the structure is not a completely sealed sack. Furthermore, a pseudo-sack with a missing bottom express the feature of the structure with a non-planar bottom region of the insertion part 1e of the cultivation member pertaining to the 4th embodiment.

Holes occur directly below the area where the left auxiliary wall 10f₁ protrudes in the left direction shown in FIG. 3A, and holes also occur directly below the area where the right auxiliary wall 10f₂ protrudes in the right direction. Cultivating soil 100 may fall through these holes on both sides. To eliminate the problem of falling, it is preferable to add fall prevention auxiliary pieces, which are larger than the area of the holes and can fill the holes, to the holes at both ends of the bottom region shown in FIG. 3A, respectively, so that a superimposing area occurs around the holes. Furthermore, the respective ends of the anti-fall prevention auxiliary pieces may be semi-fixed or fixed to both ends of the superimposed bottom region by sewing, stapling, gluing, or other means. In this case, a total of six flexible water-shielding films will make up the insertion part 1e. In the exploded view of FIG. 3B, the face of the flexible water-shielding film located at the rear side becomes the second main wall 10e₂ including the h×l rectangular area, and the face of the flexible water-shielding film located at the front side becomes the first main wall 10e₁. Then, in the assembly view in FIG. 3A, the band of width Δh, with the height h defined between the lower end 13d and the top of the first main wall 10e₁ located in the foreground and the width of 10% or less of this height h, will be the first bottom region. In the partial view (exploded view) of FIG. 3B, a height h can be defined between the lower end 13d and the upper end 14a₂ of the second main wall 10d₂ located on the upper side, and a band of width Δh that is less than 10% of the width of this height h is the second lower end region. The intermittent joint 30 is provided so as to close each of them in a beak shape.

The connection of the left end face of each of the first and second main walls 10e₁ and 10e₂, which constitute the left closing mechanism, with the left auxiliary wall 10f₁ is made by dry surface contact, wet surface contact or mechanical surface contact as described in the first embodiment, whereby the surfaces in close contact with each other can be autonomously displaced. Similarly, in the connection between the right side end of the first main wall surface 10d₁ and the second main wall 10d₂ constituting the right closing mechanism and the right auxiliary wall 10f₂, it is preferable that the opposing surfaces be configured to be shifted by autonomous sliding movement along the surface direction by dry surface contact, wet surface contact, mechanical surface contact, or the like as described in the first embodiment. When a force is generated from the inside to the outside of the pseudo-sack with a missing bottom that constitutes the insertion portion 1e, it is desirable that the size of the intersecting opposing surfaces of the sliding mechanism be an area that takes into consideration a margin sufficient to sufficiently accommodate autonomous slding, so that the connection by the sliding mechanism that slides the superimposing surfaces provided on the left and right closing in opposite directions can maintain the structure of the pseudo-bag with a missing bottom even if a sliding occurs due to sliding mechanism along the surface direction.

According to the insertion part 1e of the cultivation member of the 4th embodiment, since the relative positions of the proximity opposing surfaces in the sliding mechanisms of the left and right closing mechanisms, respectively, can freely slide and shift along the surface direction, the volume of the pseudo-sack with a missing bottom, of which the insertion part 1e is consisted, can change and the force from the inside to the outside of the pseudo-sack with a missing bottom can be weakened. Therefore, the in-plane stress of the pseudo-sack with a missing bottom part is reduced, and the rupture resistance is improved. Furthermore, according to the insertion part 1e of the cultivation member of the 4th embodiment, the plant root system 301 of the plant 300 planted in the planting furrow 210 can extend into the ground 200 at a deeper position than the intermittent joint 30, since the intermittent joint 30 is selectively and preferentially rupture over time. Therefore, selective downward extension of the plant root system 301 can be induced and root curling of the plant root system 301 can be prevented.

### 5th Embodiment

### =Cultivation Member=

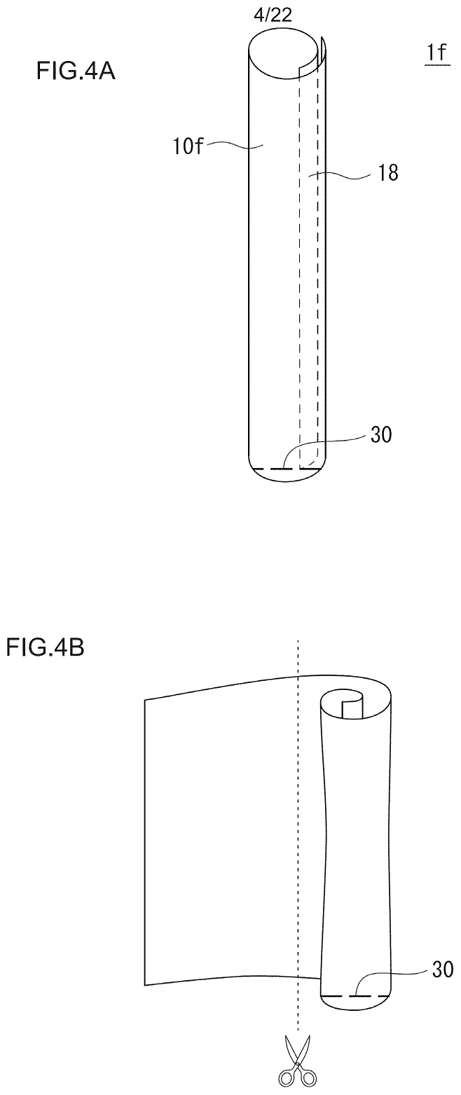

In the cultivation members for the first through 4th embodiments, examples are given for cases where the planar pattern of the planting furrow 210 is rectangular or rectangular with rounded corners, but the planar pattern of the planting furrow 210 may be circular. As explained at the beginning of the first embodiment, holes with a circular or nearly circular planar pattern are also referred to as “planting furrows” in this document. That is, the insertion part 1f of the cultivation member of the 5th embodiment of the present invention is inserted inside a planting furrow 210, which is made of a single flexible water-shielding film, the circumferential main wall 10f shown in FIG. 4B, is wound counterclockwise to form a cylindrical shape and having a circular planar pattern, as shown in FIG. 4A. The flexible water-shielding film can be either a single water-shielding film or a composite water-shielding film, similar to the 1d, 1u, 1g, 1e insertion parts of the cultivation members of the first through 4th embodiments. The basic structure is that one side face of the cylindrical circumferential main wall 10f is partially superimposed so that the other side face passes over it, and a sliding mechanism is provided at the superimposed point. That is, when one circumferential main wall 10f is wound around one circumferential main wall 10f by rollers or hand to form a cylindrical shape, the area near the other side face of the circumferential main wall 10f, which is located on the outer side of the cylindrical surface, is wound around the inner one side face more than once and in a counterclockwise direction. Thus, a part of the area on the cylindrical surface where the superimposed curved surfaces are in close proximity and opposition to each other functions as a sliding mechanism. As shown in FIG. 4A, the insertion part 1f has a non-planar bottom region and forms a cylindrical storage structure.

The insertion part 1f of the 5th embodiment of the cultivation member has a sliding mechanism on a part of the wall that forms the storage structure to achieve structure-supported stress-free variability. That is, by changing the outer circumference length of the cylinder with the sliding mechanism, at least the upper part of the storage structure can be deformed to consume the volume of the gap space set between the planting furrow 210 and the insertion part 1f, while suppressing the increase in in-plane stress of the flexible water-shielding film. If the planar pattern of the planting furrow 210 is rectangular, as described in the first through fourth embodiments of the cultivation member, the inner walls of the adjacent planes of the planting furrow 210 are orthogonal and constitute four inscribed ridges. In this case, since a gap space exists between each of the four inscribed ridges and the outer wall of the flat cylinder, the shape of the flexible and sliding insertion part 1d can be deformed until the gap space generated by the four inscribed ridges is filled. However, since the planar pattern of the planting furrow 210 into which the cultivation member of the 5th embodiment is inserted is circular, the outer circumference length c_{growth} becomes maximum when the diameter of the insertion part 1d is the diameter of the planting furrow 210.

On the other hand, as shown in FIG. 4A, the insertion part 1f of the 5th embodiment of the cultivation member locally presses the bottom region of the cylindrical body so as to constitute two opposite sides, producing two side ends facing each other in the bottom region and constituting an intermittent joint 30 that selectively rupture over time. The selective temporal rupture of the intermittent joint 30 has the effect of promoting the selective downward elongation of the root system of the planted plant with a small amount of irrigation. The “intermittent joint 30” are similar to the inserts 1g and 1e of the cultivation member of the third and fourth embodiments in that the bottom side region of the cylindrical circumferential main wall surface 10f is superimposed along a specific pressing direction, and a plurality of bonded parts that bond the faces of the bottom region that intersect and face each other, and non-bonded parts provided between adjacent bonded parts are alternately arranged in one dimension to form a continuous repeated structure. The non-bonded parts form a plurality of penetration channels along the vertical direction for moisture and the like. That is, the non-bonded parts are arranged in a one-dimensional direction a pseudo-sack with a missing bottom. If the height of the cylinder shown in FIG. 4A is h, a band of width Δh, which is less than 10% of the width of the height h, corresponds to the bottom region of the insertion part 1f of the cultivation member of the 5th embodiment. Therefore, the bottom region that forms the width of Δh is locally pressed so that the two opposing surfaces are intermittently joined, and the intermittent joint 30 is provided. As in the case of the cultivation members of the first through 4th embodiments, when the insertion part 1f is consist of a single water-shielding film, the intermittent joint 30 is selectively rupture over time by the root hydrotropism expansion effect of the plant root system 301. When the insertion part 1f is consist of a composite water-shielding film, selective rupture over time occurs efficiently due to the cumulative effects of the hydrotropism expansion and the disruption of hydrogen bond of the plant fibers that make up the composite water-shielding film. In particular, in the case where the insertion part 1f is composed of a composite water-shielding film, in order to allow water to penetrate and diffuse into the plant fibers at a slight exposed point to enable selective temporal rupture of the intermittent joint 30, a structure such as idiot hole sewing as described in the third embodiment can be adopted.

The structure of the superimposed surface (contact surface) where one side end surface of the circumferential main wall 10f is superimposed on the other side end surface can be adopted by dry surface contact, wet surface contact or mechanical surface contact as described in the first embodiment, which allows the surfaces in close contact to be displaced autonomously. The sliding mechanism may be consisted of a combination of dry surface contact and mechanical surface contact, or a combination of wet surface contact and mechanical surface contact. A sliding mechanism that allows the superimposed surfaces to slide in opposite directions to each other makes it possible to change the circumferential length of the cylinder due to misalignment caused by autonomous sliding movement of the opposing surfaces along the circumferential direction. The circumferential length of the superimposed surface by the sliding mechanism should be long enough to ensure that the structure of the pseudo-sack with a missing bottom can be maintained even if the position of the superimposed surface by the sliding mechanism shifts along the circumferential direction when a force from the inside to the outside of the pseudo-sack with a missing bottom, which constitutes the insertion part 1f, is generated. The length in the circumferential direction of the superimposed surface by the sliding mechanism should be long enough to ensure sufficient margin for autonomous misalignment.

According to the insertion part 1f of the cultivation member of the 5th embodiment, since the relative position of the superimposed surfaces can freely slide and shift along the circumferential direction, the volume of the pseudo-sack with a missing bottom, of which the insertion part 1f is a part, can change and the force from the inside to the outside of the pseudo-sack with a missing bottom is weakened. Therefore, the in-plane stress of the pseudo-sack with a missing bottom is reduced, and the rupture resistance is improved. Furthermore, according to the insertion part 1f of the cultivation member of the 5th embodiment, the selective and preferential selective temporal rupture of the intermittent joint 30 allows the plant root system 301 of the plant 300 planted in the planting furrow 210 to extend into the ground 200 at a deeper position than the intermittent joint 30. Therefore, the effect is that selective downward extension of the plant root system 301 is promoted and root curling of the plant root system 301 is prevented.

=Cultivation system=

Similar to the insertion parts 1d, 1g and 1e of the cultivation members of the first, third and 4th embodiments, the insertion part 1f of the cultivation member of the 5th embodiment, as in the examples shown in FIGS. 5 and 6A, for example, inserted into the interior of each of the planting furrow 210 with a high aspect ratio D/W formed by digging in a plurality of locations on the ground 200 of a cultivating place. As already explained in the first embodiment part, the “furrow width W” is a dimension measured as the narrowest width on a part of the planting furrow 210 cut in the vertical direction. If the planar pattern is a circular planting furrow 210, the narrowest width is the diameter of the circle. The D in the aspect ratio D/W is the depth of the planting furrow 210. In the cultivation system of the 5th embodiment of the present invention, a planting furrow 210 with an aspect ratio D/W≥5 is preferred, and more preferably, a planting furrow 210 with an aspect ratio D/W≥10. Then, a plurality of insertion parts 1f inserted into each of the planting furrows 210 with a high aspect ratio D/W can be filled with cultivating soil 100, a plant 300 can be planted in each of the filled cultivating soil 100, and the plant 300 can be irrigated with natural water or by annual irrigation to grow the plant 300. The plants 300 can be grown by irrigating the plants 300 with natural water or annual irrigation. The insertion part 1f has a structure in which a small amount of irrigation water is scheduled to leak along the vertical direction from the non-bonded parts of the intermittent joint 30 in the bottom region of the insertion part 1f. Therefore, since the insertion part 1f is not a completely sealed sack, the structure of the insertion part 1f of the cultivation member of the 5th embodiment as well as the insertion parts 1f, 1g, and 1e of the cultivation members of the first, third, and 4th embodiments are called “pseudo-sack”. Furthermore, a pseudo-sack lacking a flat bottom is called a “pseudo-sack with a missing bottom” to express the feature of a structure with a non-planar bottom region. In addition to the procedure of carrying the pre-prepared insertion part 1f to the planting site and inserting it inside the planting furrow 210 dug in the ground 200 at the planting site, it is also possible to make an insertion part 1f of a dimension that fits the circumference of the planting furrow 210 by winding it on site after the planting furrow 210 is dug in the ground 200 at the planting site (on-site). If the circumference of the planting furrow 210 is small, as shown in FIG. 4B, after forming the insertion part 1f, the unneeded parts of the rolled water-shielding film can be cut off and the cut parts collected to save on material costs.

### =Planting Method=

The planting method of the 5th embodiment of the present invention is applicable to a plant planting method in which a mobile planting apparatus as shown in FIG. 8 is used to insert the insertion parts 1a₁, 1a₂, . . . of the cultivation member of the 5th embodiment into each of a plurality of planting furrow 210 having a high aspect ratio D/W dug in a ground 200 of a planting site, the inside of each of the insertion parts 1a₁, 1a₂, . . . is filled with cultivating soil 100, plants 300 are planted in each of the filled cultivating soil 100, and the plants 300 are irrigated with natural water. By using the mobile planting apparatus as shown in FIG. 8, it is possible to dig plurality of planting furrows 210 with an aspect ratio D/W≥10, even if the furrow diameter W<10 cm, and the insertion parts 1a1, 1a2, . . . can be inserted into a plurality of planting furrow 210.

The mobile planting apparatus shown in FIG. 8 has, as the overall structure, a transport means 150, such as a tractor, a towing tool 155 connected to the rear of the transport means 150, and a wheeled cargo bed 160 connected to the towing tool 155. The mobile stationary planting apparatus shown in FIG. 8 further has a component storage box 51c loaded on the transport means 150 side of the cargo bed 160 and a stationary planting device (71, 73, 75, 77) mounted on the position side of the cargo bed 160 away from the transport means 150. The cargo bed 160 has an opening cart, and the auger 71 can be raised and lowered between the cargo bed 160 and the ground 200 through the opening cart. In the component storage box 51c, the insertion parts 1a₁, 1a₂, . . . of the cultivation member of the 5th embodiment shown in FIG. 4A are tightly bound and stored with the longitudinal direction (the direction in which the roots extend) as the vertical direction. At this point, the plurality of insertion parts 1a₁, 1a₂, . . . may be filled with a small amount of cultivating soil 100 to cause that the plurality of insertion parts 1a₁, 1a₂, . . . to drop, or may be filled with sufficient cultivating soil to grow seedlings, or may have seeds and seedlings already planted.

The mobile type planting apparatus shown in FIG. 8 has a lifting mechanism 77 provided on a cargo bed 160, an auger-mounting cylinder 73 fixed to the vertical axis of the lifting mechanism 77 and movable up and down on the vertical axis of the lifting mechanism 77, an auger 71 fixed to the auger-mounting cylinder 73, and a rotating mechanism 75 fixed to the auger-mounting cylinder 73. The auger 71 is fixed to the auger-mounting cylinder 73. An auger, also commonly referred to as an “earth auger”, is one of the machines used to dig the ground 200. The auger 71 has a hollow shaft through which the insertion parts 1a₁, 1a₂, . . . can pass, respectively, and the auger mounting cylinder 73 and the rotating mechanism 75 also have a hollow shaft through which the insertion parts 1a₁, 1a₂, . . . , etc. The opening and closing part are so-called “split heads”, which are divided head pieces on the circumference by a dividing line extending in the direction of the inverted conical hollow matrix. The divided head pieces are independently connected to a rotary shaft and a hinge, and can be opened and closed independently. A spiral screw is provided around the periphery of the auger 71 and the opening and closing parts.

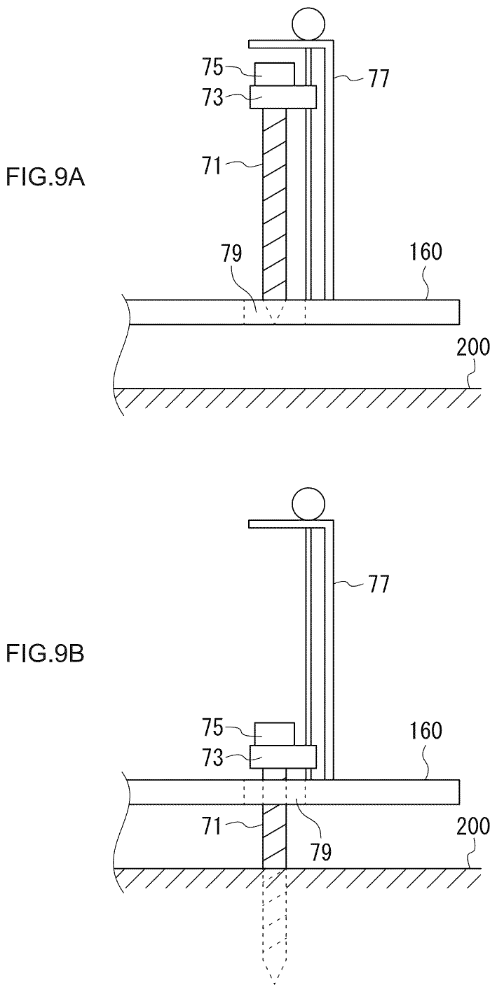

The opening/closing part takes the “closed state” shown in FIG. 9B when pressure is applied from the outside, and takes the “open state” shown due to its own weight when released from the outside pressure in FIG. 9A.

As shown in FIG. 9B, when the auger 71 is rotated in the first rotation direction by the rotation mechanism 75 and lowered by the lifting mechanism 77, the opening/closing part receives pressure from the soil layer 200 and, while remaining in the “closed state”, digs and inserts the ground 200 vertically, thereby digging a planting furrow 210 having an aspect ratio D/W≥5, preferably an aspect ratio D/W≥10.

When digging is completed to the depth of the desired aspect ratio, auger 71 is raised by lifting mechanism 77 while rotating in the second rotational direction, opposite to the first rotational direction by rotating mechanism 75, as shown in FIG. 9A. During this ascent, the opening and closing parts are in the “open” state, free from pressure of the ground 200, so when the insertion parts 1a is inserted through the auger mounting cylinder 73, it pass through the opening and is inserted into the planting furrow 210. The hollow auger 71 serves as an insertion guide for the insertion parts 1a₁, allowing the insertion parts 1a into the planting furrow 210 without collapsing the inner walls of the planting furrow 210.

Based on the above, the insertion parts 1a of the cultivation member of the 5th embodiment can be inserted into the interior of the planting furrow 210 of the ground 200 of the planting place using a mobile planting apparatus, generally by the following representative steps.

(p) The auger 71 is dug and inserted into the ground 200 of the cultivating place by lowering the lifting mechanism 77 and rotating the rotating mechanism 75 in the first direction to form a planting furrow 210 with an aspect ratio D/W≥5, preferably with an aspect ratio D/W≥10.

(q) The insertion parts 1a₁ filled with cultivating soil 100 is inserted into the hollow shaft of the auger 71.

(r) By rotating the rotating mechanism 34 in the second direction, which is the opposite of the first direction, and raising the lifting mechanism 33, the auger 71 is removed from the ground 200 of the cultivating place, leaving the insertion parts 1a.

(s) If necessary, additional soil 100 is added, and seeds or seedlings are planted in the insertion part 1a that have been filled with cultivating soil 100.

(t) The step (p) to (r) are repeated to plant the insertion part 1a₁, 1a₂, . . . , in the planting site respectively.
In step(s), if the insertion parts 1a that already contains seedlings are filled instead of the insertion parts 1a that are filled with cultivating soil 100, process (s) can be omitted.

### <First Variation of the 5th Embodiment>

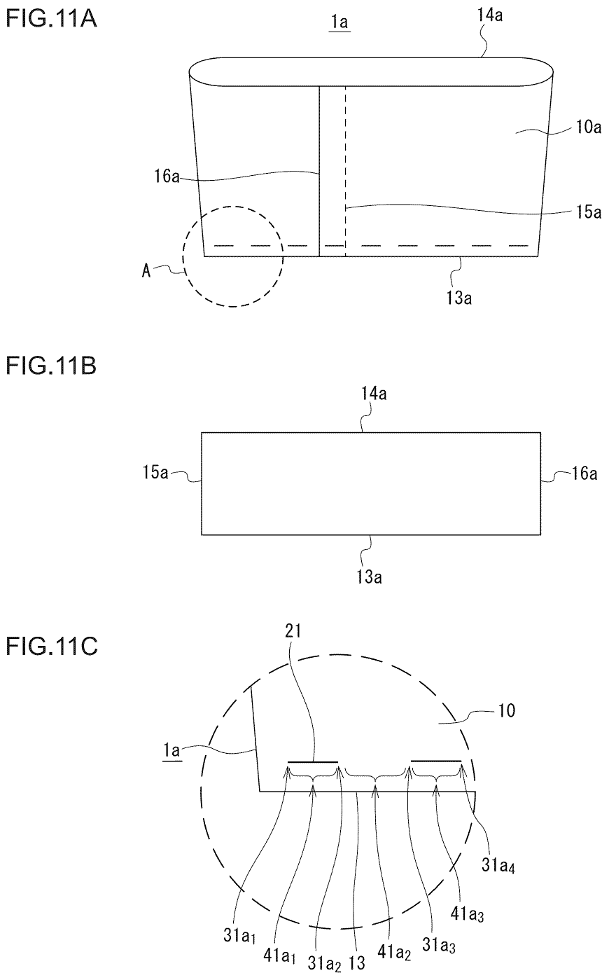

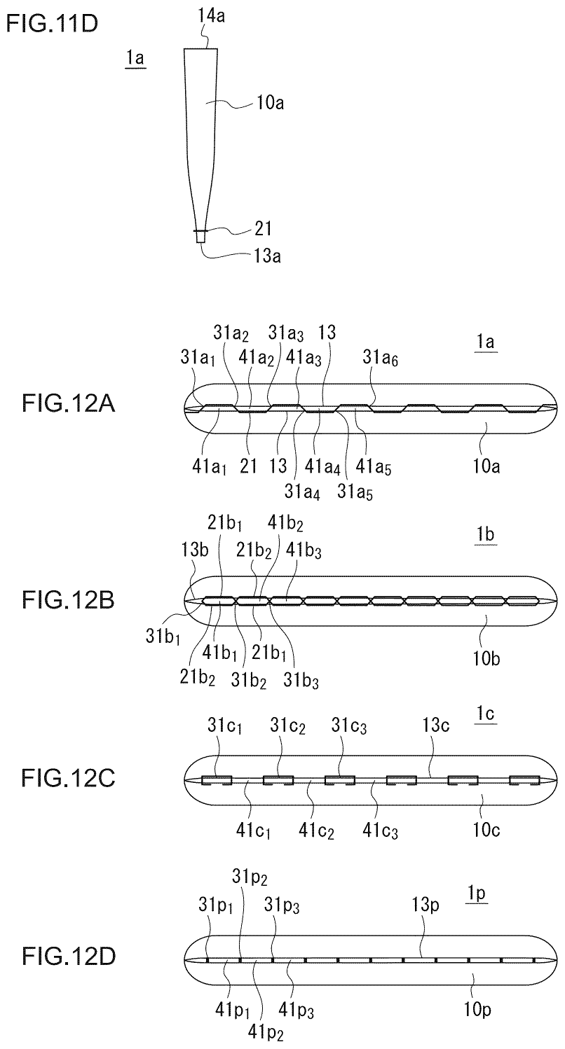

The insertion part 1a of the cultivation member for the first variation of the 5th embodiment of the present invention is provided with a circumferential main wall 10a made of a single flexible water-shielding film as shown in FIG. 11B. The circumferential main wall 10a is then wound clockwise direction to form a flattened cylindrical shape, as shown in FIG. 11A. The right side end 16a of the circumferential main wall 10a, which is wound around to form a flattened cylindrical shape in a clockwise direction, is superimposed on the left side end 15a, progressing in a left direction to pass over the left side end 15a, and a sliding mechanism is provided at the superimposed point, which is the basic structure of the wall. That is, when a single circumferential main wall 10a is wound in a clockwise direction by rollers or manual winding to form a flat cylindrical shape, the area near the right side end 16a of the circumferential main wall 10a, which is located outside the flat cylindrical surface after one or more laps, is wound around the area near the inner left side end 15a. The insertion part 1f shown in FIG. 4A has a cylindrical cross part perpendicular to the longitudinal direction that is close to a perfect circle, while the insertion part 1a shown in FIG. 11A has a flattened cylindrical cross section perpendicular to the circumferential axis that is close to a rounded rectangle. The feature of the insertion part 1a of the cultivation member for the first variant of the 5th embodiment is also the same as that of the insertion part 1f of the cultivation member for the 5th embodiment example, which, when not filled with cultivating soil 100, is a flexible pseudo-sack with an opening at the upper end 14a, which lacks a bottom part. Accordingly, as shown in FIG. 11D, the bottom region of the lower end 13a, which is the opposite side of the upper end 14a, is squeezed to form a beak (V-shape).

The insertion part 1a of the cultivation member for the first variant of the 5th embodiment consists of a sliding mechanism in which the left side end 15a side of the main wall 10 made of flexible water-shielding film comprising the storage structure is superimposed on the left side end 16a, which is toward the right direction, while the volume is variable when plants are grown and used. As shown in FIG. 11A, a sliding mechanism is provided on the circumferential surface to make the superimposed surfaces move in opposite directions to each other to achieve structure-supported stress-free variability. That is, the shape of at least the upper parts of the external shape defined by the storage structure can be deformed to conform to the shape of the inner wall of the planting furrow 210 by the action of the sliding mechanism, without increasing the in-plane stress of the flexible water-shielding film. That is, the shape of at least the upper part is deformable so as to consume the volume of the gap space created between the planting furrow 210 and the insertion part 1a. Then, in the bottom region defined on the lower end 13a, as shown in FIG. 11C, by arranging in a straight line (one-dimensional arrangement) a plurality of bonded parts (constrictions) 31a₁, 31a₂, . . . that intermittently contact opposing surfaces facing each other The pseudo-sack with an opening at the upper end 14a is realized by arranging (one-dimensionally arranging) a plurality of bonded parts (constrictions) 31a₁, 31a₂, in a straight line. The pseudo-sack is a pseudo-sack with a missing bottom. Between the plurality of bonded parts (constrictions) 31a₁, 31a₂, . . . , there are alternately a plurality of non-bonded parts 41a₁, 41a₂, . . . , which are complementary to the arrangement of the plurality of bonded parts (constrictions) 31a₁, 31a₂, . . . A2, . . . are repeatedly arranged in a straight line to form an intermittent joint in an alternating manner that is complementary to the arrangement of the plurality of non-bonded part 41a₁, 41a₂, . . . . Each of the plurality of non-bonded part 41a₁, 41a₂, . . . constitutes a permeation channel along the vertical direction for water and other substances. Thus, the insertion part 1a is not a complete sack.

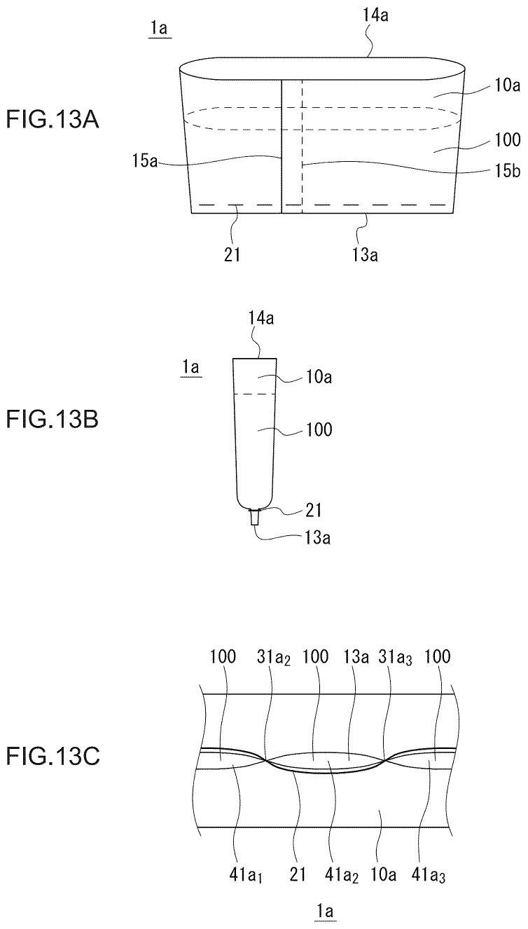

Since the insertion part 1a of the cultivation member for the first variant of the 5th embodiment is flexible, as shown in FIG. 13B, when the cultivation soil 100 is filled from the opening of the upper end 14a, the distance between the opposite sides of the part other than the lower end 13a increases and the upper end 14a expands. When irrigating from the opening of the upper end 14a after filling the cultivating soil 100 from the opening of the upper end 14a, a part of the irrigation water leaks outward (downward) from the plurality of non-bonded parts 41a₁, 41a₂, . . . that constitute the plurality of permeation channels. Since the insertion part 1a of the cultivation member for the first variant of the 5th embodiment further has variable volume, the circumferential length of the part other than the lower end 13a can be increased by filling the upper end 14a with cultivating soil 100 through the opening, as shown in FIG. 13B. When the cultivating soil 100 expands as the plant root system 301 planted in the cultivating soil 100 grows, lengths of the circumferential and volume can be increased except the lower end 13a.

That is, the insertion part 1a of the cultivation member for the first variant of the 5th embodiment constitutes an intermittent joint where the lower end 13a of pseudo-sack with a missing bottom is superimposed to and selectively rupture over time by irrigation, and water and particles such as fine sand grains are able to enter the plurality of non-bonded parts (permeation channels) 41a₁, 41a₂, and . . . , and leak to the outside through them. On the other hand, the soil clods and other particles that have been agglomerated with water are designed to remain retained no-leaking out of the plurality of non-bonded edge 41a₁, 41a₂, . . . and stored inside the pseudo-sack with a missing bottom. The insertion part 1a of the cultivation member for the first variant of the 5th embodiment is a plant cultivation container that can be filled with cultivating soil and irrigated to grow plants from the state of seeds and seedlings.

The circumferential main wall 10a made of flexible water-shielding film that constitutes the insertion part 1a of the cultivation member for the first variant of the 5th embodiment is, as shown in FIG. 11A, a cylinder that serves as a prototype for the sack by superimposing and sliding the left side end 15a and right side end 16a of at least one flexible water-shielding film so that they can be superimposed (closely together) to a cylindrical shape, which is the prototype of the sack, can be formed. The cultivating soil 100 filled into the insertion part 1a expands due to the growth of the plant root system 301. According to the sliding mechanism with the superimposed surface structure of the left side end 15a and the right side end 16a shown in FIG. 11A, the relative position can slide autonomously so that the sliding mechanism can expand the internal volume as the filled cultivating soil 100 expands, thereby suppressing the rupture of the pseudo-sack with a missing bottom. As shown in FIG. 11A, when a single flexible water-shielding film is superimposed so that the left side end 15a and the right side end 16a can slide against each other by circumambulating the film in a strip shaped, the superimposing parts of the left side end 15a and the right side end 16a in the strip shape are made up of plurality of bonded parts (constrictions) 31a₁, 31a₂, and 31a₄ at the lower end 13a in the pseudo-sack with a missing bottom, may be located at any of the opposing surfaces formed in the bottom region of the pseudo-bag with a missing bottom. The superimposing parts of the left side end 15a and the right end 16a may be of any size, but the area of the superimposing parts must be large enough to maintain the cylindrical form of the pseudo-sack with a missing bottom even if the volume of the pseudo-sack with a missing bottom is increased by sliding of the superimposing parts.

In the insertion part 1a of the cultivation member for the first variant of the 5th embodiment shown in FIG. 11A, the frontal shaped of the state in which nothing is filled inside is a rectangle, but it may be a shaped other than a rectangle. For example, a convex parts continuous with the circumferential main wall 10a made of flexible water-shielding film may be provided near the center of the upper end 14a of each of the two opposite sides of the front and back of the insertion part 1a of the first variation of the 5th embodiment, and both convex parts may function like handles of the insertion part 1a. Furthermore, in the insertion part 1a of the cultivation member for the first variant of the 5th embodiment shown in FIG. 11A, the frontal shape of the part with nothing filled inside is a horizontal rectangle, but any shape can be adopted, including a vertical shaped and a shaped that is constricted from the top to the bottom.

The insertion part 1a of the cultivation member for the first variant of the 5th embodiment has a structure illustrated in FIG. 11C, in which a plurality of bonded parts (constrictions) 31a₁, 31a₂, . . . are formed by sewing thread 21 and the bottom region of the pseudo-sack with a missing bottom, and the opposing surfaces formed in the bottom region of the pseudo-sack with a missing bottom are superimposed to each other in the vicinity of the lower end 13a, constituting an intermittent joint that is scheduled to be selectively rupture over time. One way to design the intermittent joint to rupture selectively over time due to irrigation is to use water-soluble fibers in the sewing thread 21. Instead of using water-soluble fibers for the sewing thread 21, as employed in the insertion parts 1d, 1g, 1e, 1f of the cultivation members of the first to 5th embodiments, the insertion part 1a has at least a two-layer laminated structure of a plant fiber layer and a hydrophobic material layer laminated to this plant fiber layer, where the flexible water-shielding film comprising the insertion part 1a of the composite water-shielding film may be configured with a composite water-shielding film having at least a two-layer laminated structure of a plant fiber layer and a hydrophobic material. In the case of a composite water-shielding film with a two-layer laminated structure, it is preferable to use the hydrophobic material layer so that the hydrophobic material layer is located on the inner wall of the pseudo-sack with a missing bottom that constitutes the insertion part 1a of the cultivation member in the first variation of the 5th embodiment. Even if the sewing thread 21 is a non-water soluble fiber, the plant fiber layer is exposed, albeit slightly, at the point where the sewing thread 21 penetrates the composite water-shielding film, so that the hydrogen bonds between the plant fibers are disrupted by water penetration into the exposed plant fiber layer and the intermittent joints are selectively (preferentially) ruptured. In order to make the penetration and diffusion of water into the plant fibers in a few exposed areas more efficient, a structure such as the idiot hole sewing described in the third embodiment can be adopted.

Whether the composite water-shielding film is a laminated composite water-shielding film, an applied impregnated composite water-shielding film, or an internal paper-added composite water-shielding film, similarly, water penetration into the plant fiber layer exposed at the point where the sewing thread 21 penetrates the composite water-shielding film causes the hydrogen bonds between the plant fibers to rupture, and the intermittent joints are selectively (i.e. preferential) ruptured. Using sewing thread 21, from the right or left side end of the rectangular lower end 13a of the front shape of the insertion part 1a, a plurality of bonded parts (constrictions) 31a₁, 31a₂, . . . are sewn together along a one-dimensional direction on opposite sides formed in the bottom region of the pseudo-sack with a missing bottom by wave stitching, etc. . . . are discretely arranged in a one-dimensional array. As shown in FIG. 12A, at the point where the sewing thread 21 penetrates two apparently opposing parts of the circumferential main wall 10a made of flexible water-shielding film, the two apparently opposing parts of the circumferential main wall 10a made of flexible water-shielding film are physically bound in close proximity and a plurality of bonded parts (constrictions) 31a₁, 31a₂, . . . , . . . , in a point-like manner . . . are arranged in a one-dimensional array. Between each of the plurality of bonded parts (constrictions) 31a₁, 31a₂, . . . , the two facing parts of the circumferential main wall 10a made of flexible water-shielding film are physically bounded in close proximity to each other, and the plurality of bonded parts (constrictions) 31a₁, 31a₂, . . . than a plurality of non-bound parts (permeation channels) 41a₁, 41a₂, . . . that are not constrained by physical proximity distance and can be relatively separated from each other, resulting in a discrete one-dimensional array.

A plurality of bonded parts (constrictions) 31a₁, 31a₂, . . . and a plurality of non-bound parts 41a₁, 41a₂, . . . are alternately arranged one dimensionally in a break line at the lower end 13a, and the lower end 13a is so-called “linear mesh” and functions as a cessation of cultivating soil and irrigation. In order to arrange plurality of bonded parts (constrictions) one dimensionally in a straight line, in addition to the insertion part 1a by wave stitching with sewing thread 21 shown in FIG. 12A, there are other insertion parts 1b by sewing with two sewing threads (second variation of the 5th embodiment), which is realized by main stitching with a sewing machine shown in FIGS. 12B and 12C, insertion part 1c fixed by a stapler needle (third variant of the 5th embodiment), or insertion part 1p fixed by adhesive or heat-seal point bonding, etc. (fourth variant of the 5th embodiment), as shown in FIG. 12D. By using biodegradable materials for the sewing thread and stapler needle, low environmental load can be achieved because they biodegrade over time. Cotton or silk thread can be used as sewing thread. The sewing threads and stapler needles can be made of fatty polyester resin.

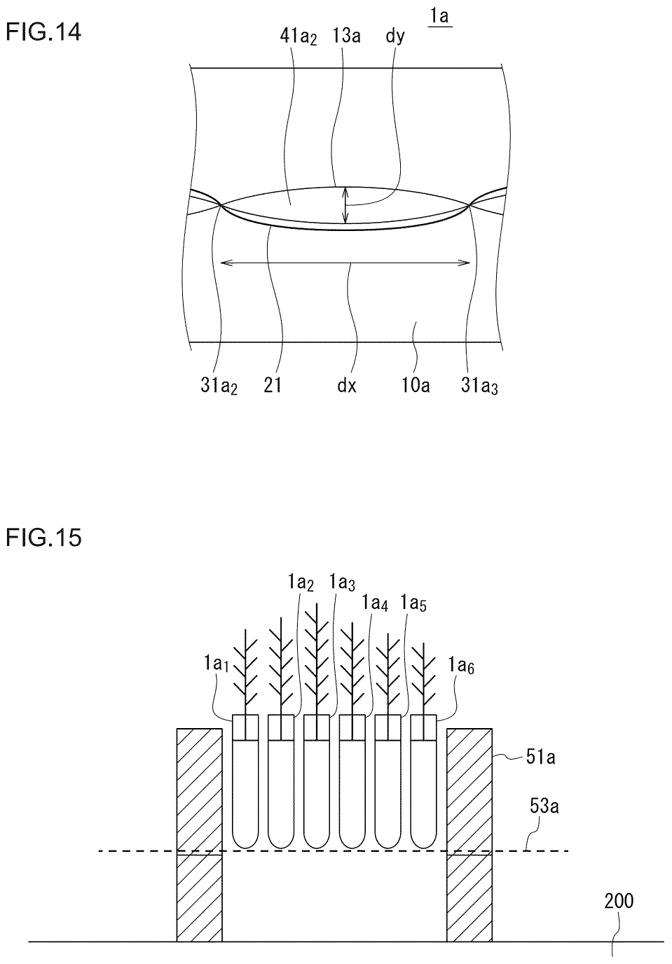

FIGS. 13A to 13C and 14 show the state of the insertion part 1a filled with cultivating soil 100. In FIGS. 13A and 13B, the cultivating soil 100 is filled from the upper end 14a of the insertion part 1a to slightly below, but the amount of cultivating soil 100 filled is arbitrary. The “split filling” is preferred, in which a small amount of cultivating soil 100 is first filled to slightly above the lower end 13a of the insertion part 1a, and finally to the top of the insertion part 1a, depending on the work process. As shown in FIG. 14, dx which is the distance between the joints 31a₂ and 31a₃, is defined as the “action length” of the non-bonded parts 41a₂, and dy which is the width of the non-bonded parts 41a₂ perpendicular to the action Length dx in the middle parts of the action length dx is defined as the “buffer width” of the non-bonded part 41a₂. Compared to when the insertion part 1a is not filled with anything, when the insertion part 1a is filled with cultivating soil 100, the buffer width dy of the non-bonded part 41a₂ is enlarged and the action length dx is reduced. The change of the gap shape in the non-bonded part 41a₂ settles at the point where the expansion force caused by the internal filling of the insertion part 1a with cultivating soil 100 is balanced by the tension in the circumferential main wall 10a, which is made of flexible water-shielding film. When a large amount of cultivating soil 100 is filled, the buffer width dy widens greatly due to the pressing force of the cultivating soil 100, and the non-bonded part 41a₂ becomes a “drum belly packed with cultivating soil”. The same is true for the action length dx and buffer width dy for the non-bonded part (plurality of permeation channels) other than the non-bonded part 41a₂.

When the insertion part 1a begins to be filled with cultivating soil 100, the smaller particle of the action length dx or the buffer width dy (hereinafter also referred to as “sieve”) may be fallout, but since the cultivating soil etc. aggregates with each other to form larger lumps due to the interaction between the particles and the pressing force, the amount of cultivating soil particles that actually fall out is very small. Once the cultivating soil 100 is deposited at the lower end 13a of the insertion part 1a, it almost never falls out of the non-bonded part 41a₂ during the subsequent filling of the cultivating soil 100. The residual accumulation rate can be increased by increasing the compaction or humidification of the cultivating soil 100 to be filled. The action length dx should be between 5 mm and 1.5 cm from the viewpoint of balance between cultivating soil retention and irrigation leakage.

When water is irrigated into the cultivating soil 100 in the insertion part 1a filled with the cultivating soil 100, the water penetrates downward through the cultivating soil 100 and is temporarily blocked by the bonded part 31a₁, 31a₂, . . . . The blocked water penetrates again so as to flow back into the upper cultivating soil 100, and also takes time to leak out to the outside through a plurality of non-bonded part 41a1, 41a2, . . . . Generally, in top irrigation of seedling containers, a specific channel is formed inside the cultivating soil in proportion to the particle size of the soil, and water tends to leak from the bottom without sufficiently penetrating the entire soil. Therefore, to achieve both water conservation and high water penetration rate into the cultivating soil, immersion bottom irrigation, in which the seedling container is immersed in a water tank from the bottom, is effective, and even in conventional seedling pots with bottoms, pseudo immersion bottom irrigation occurs due to water that remains on the bottom. Compared to conventional seedling pots having a bottom surface, in the plurality of bonded parts 31a₁, 31a₂, . . . of the insertion part 1a of the cultivation member for the first variant of the 5th embodiment, a cultivating soil 100 is densely compacted and accumulated on the small bottom area. Therefore, the blocked water reaches the top of the soil 100 and stays there for a long time, making it possible to achieve both water saving and high water penetration rate into the cultivating soil 100.

The preferred method of arranging plurality of bonded part (constrictions) in a straight line in one dimension is the sewing method using fibers or twisted yarns, as shown in FIGS. 12A and 12B. In the sewing method, the plurality of bonded part (constrictions) is point-like, such as the 31a₁, 31a₂, . . . shown in FIG. 12A, etc., so that at the lower end 13a, the plurality of non-bonded part 41a₁, 41a₂, . . . occupy a larger percentage of a cross-section view than the plurality of bonded parts 31a₁, 31a₂, . . . . Since the plurality of non-bonded parts 41a₁, 41a₂, . . . occupy a relatively large proportion of the cross-section area at the lower end 13a, the roots tend to extend downward through the multiple non-bonded part 41a₁, 41a₂, . . . , making it difficult for root curling to occur inside the insertion portion 1a. Also, as shown in FIGS. 12A, 13C, 14, the sewing thread 21 is present along one arc around each of the plurality of non-bonded parts 41a₁, 41a₂, . . . as a “pressure-applying part”, which prevents excessive expansion in the dy direction, and preventing the excessive dropout of the soil 100 and excessive leakage of irrigation water.

Although any type of soil can be used for the cultivating soil 100 to be filled into the insertion part 1a, by making the cultivating soil 100 a low permeability clayey soil or a high hydrophilic material, the leakage time through the plurality of non-bonded parts 41a₁, 41a₂, . . . . It is possible to extend the time for irrigation water to penetrate to the lower end 13a. The cultivating soil to be filled into the insertion part 1a may be molded cultivating soil. It is also possible to use a combination of molded cultivating soil and shape freedom cultivating soil as the cultivating soil to be filled into the insertion part.

The insertion part 1a of the cultivation member for the first variant of the 5th embodiment can be used, for example, for raising seedling. As shown in FIG. 15, a plurality of insertion parts 1a₁, 1a₂ . . . 1a₆ of the same structure as the insertion part 1a of the cultivation member pertaining to the first variant of the 5th embodiment can be filled with cultivating soil, seeds and seedlings (seeds, seedlings, or bulbs) can be planted and irrigated, and grown in a place where it is easy to manage the seedlings except the fixed planting site. As shown in FIG. 15, a plurality of insertion parts 1a₁, 1a₂ . . . 1a₆ with plants planted are stored inside the insertion container 51a, which is made of tubular walls, in a close proximity to each other. The partition 53a, which is horizontally provided in the middle of the cylindrical wall of the insertion container 51a, should have a mesh structure.

If the partition plate 53a has a mesh structure, excess irrigation water from the plurality of insertion parts 1a₁, 1a₂ . . . 1a₆ in which plants are planted can be discharged through the mesh structure of the partition plate 53a into the space below to prevent root rot, and the so-called “air root cutting” effect stops the downward extension of the plant root system 301 from the plurality of insertion parts 1a₁, 1a₂ . . . 1a₆, so that the plurality of insertion parts 1a₁, 1a₂ . . . 1a₆ with plants grown in them can be removed from the insertion container 51a without damaging the plant root system 301.

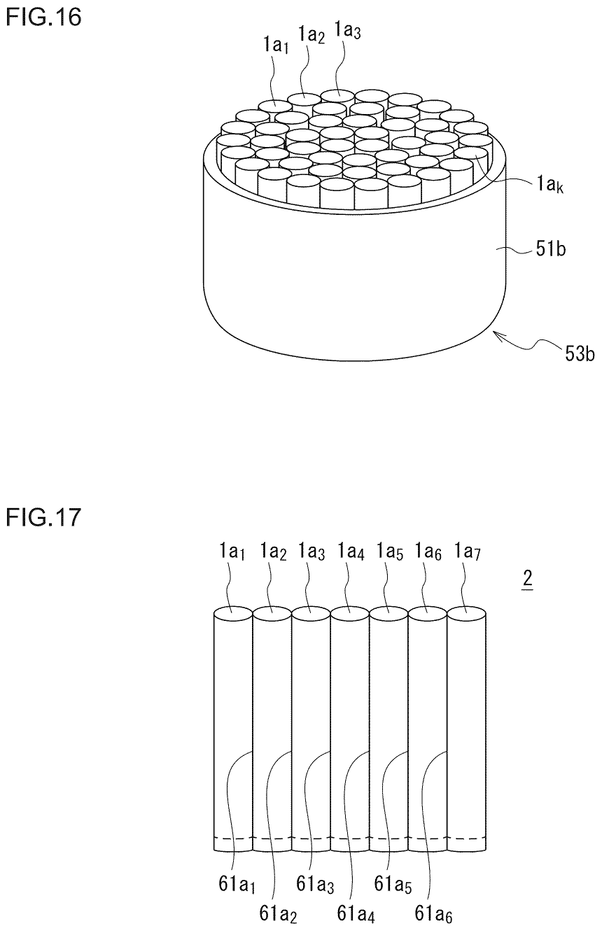

FIG. 16 shows a plurality of insertion parts 1a₁, 1a₂ . . . 1ak (k represents a natural number of 2 or more) of the same structure as the insertion part 1a of the cultivation member for the first variation of the 5th embodiment. The insertion container 51b has the same structure as the insertion container 51a shown in FIG. 15. In the method of storing plurality of insertion parts 1a₁, 1a₂ . . . 1aₖ, first, a small amount of cultivating soil is filled inside each of plurality of insertion parts 1a₁, 1a₂ . . . 1aₖ, and the weight of the cultivating soil causes each of plurality of insertion parts 1a₁, 1a₂ . . . 1aₖ are allowed to droop. Next, as shown in FIG. 16, the plurality of insertion parts 1a₁, 1a₂ . . . 1aₖ are tightly bound and stored in the insertion container 51b so that the longitudinal direction (the direction in which the roots extend) of each is vertical. Next, additional cultivating soil is filled into each of the plurality of insertion parts 1a₁, 1a₂ . . . 1aₖ. Finally, seeds, seedlings, bulbs, or cuttings (seeds and seedlings, etc.) are seeded or planted in the cultivating soil in the plurality of insertion parts 1a₁, 1a₂ . . . 1aₖ, respectively, and irrigation is performed to grow the seeds and seedlings, etc.

By storing an excessive number of the insertion parts 1a1, 1a2 . . . 1ak so that the sum of the horizontal cross-sectional area of plurality of the insertion parts 1a1, 1a2 . . . 1ak filled with a small amount of soil is larger than the cross-sectional area of the cylindrical internal space of the insertion container 51b, a twist, i.e., vertical wrinkles in the vertical direction, is created in the flexible water-shielding film of the plurality of the insertion parts 1a₁, 1a₂ . . . 1aₖ to eliminate the difference in cross-sectional area. The cross-section part of each of the plurality of insertion parts 1a₁, 1a₂ . . . 1aₖ becomes smaller than before being stored in the insertion container 51b. The insertion part 1a with vertical a twist, i.e., vertical wrinkles, which is removed from the insertion container 51b for planting and planted, serves as a buffer against the enlargement of the plant root system 301 after planting, prevents the rupture of the insertion part 1a and the root curling.

The insertion part 1a of the cultivation member for the first variant of the 5th embodiment can be removed from the container, such as the insertion container 51a shown in FIG. 15 or the insertion container 51b shown in FIG. 16, after growing seedlings in the container, etc., and planted directly in the planting site, or planted in another insertion part 1a filled with cultivating soil in the planting site. In these cases, the seeds and seedlings can be planted in the same manner. In these types of planting, the insertion part 1a in which seeds and seedlings are planted is planted as is, thereby reducing damage to the plant root system 301 caused by de-molding of the seedling container, etc. and enabling a reduction in work steps such as de-molding of the seedling container, etc.

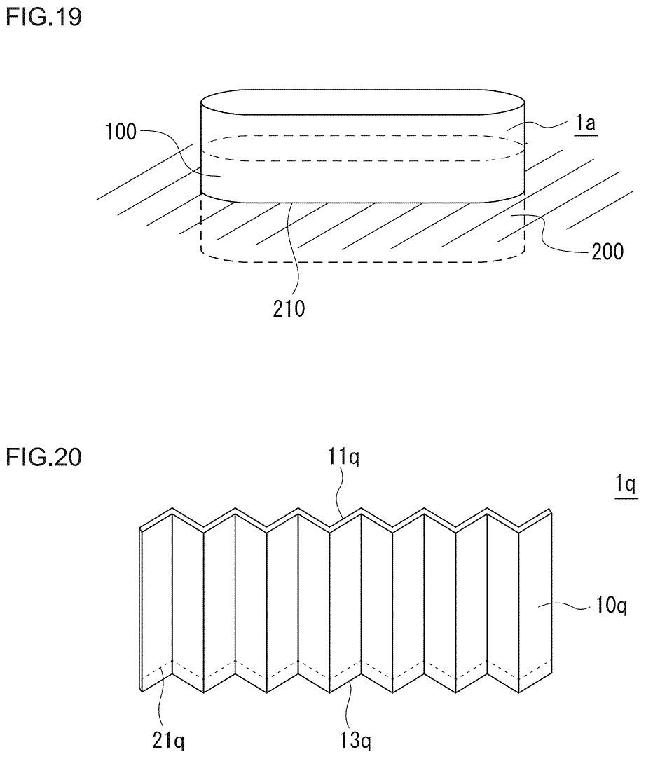

In addition, the insertion part 1a of the cultivation member pertaining to the first variant of the fifth embodiment is used to insert the insertion part 1a filled with a small amount of cultivating soil 100 inside the planting furrow 210 formed by digging in the ground 200 of the planting site, fill the insertion part 1a with additional cultivating soil 100, and plant seeds and seedlings, etc. without going through a seedling growing process outside the planting site, as shown in FIG. 19. The method of planting (FIG. is omitted), irrigating (FIG. is omitted), and growing plants can also be employed. The surface level of the cultivating soil finally filled into the insertion part 1a can be set at any level, equal to, above, or below the surface level of the ground 200 at the planting site, indecently of the surface level of the ground 200 at the planting site.

Root systems 301 of the seeded or planted seeds and seedlings penetrate into the ground 200 of the cultivating place from the lower end 13a through plurality of non-bonded parts 41a₁, 41a₂, . . . of intermittent joints shown in FIG. 12A, etc. At the lower end 13a, the plurality of bonded parts 31a₁, 31a₂, . . . are smaller than the plurality of non-bonded parts 41a₁, 41a₂, . . . , so that the plant root system 301 does not cause root curling and selectively extending downward into the ground 200 in which they are planned to be planted. In particular, the selective downward extension of the plant root system 301 is facilitated because the intermittent joints are selectively (preferentially) rupture over time by irrigation. Therefore, the selective temporal rupture of the intermittent joints has the effect of preventing root curling of the plant root system 301.

By making the circumference of the flexible insertion part 1a slightly longer than the inner circumference of the planting furrow 210 and filling the interior of the insertion part 1a with cultivating soil 100 until the insertion part 1a adheres to the inner wall of the planting furrow 210, the backfilling step of the gap between the insertion part 1a and the planting furrow 210 can be omitted. Furthermore, the rupture resistance of the insertion part 1a when the root expands inside the insertion part 1a is improved.

The insertion part 1a of the cultivation member for the first variant of the 5th embodiment can be used for inducing selective downward growth of plant root systems 301 such as planted seeds and seedlings in the fixed or temporary planting sites described in the first embodiment. Furthermore, specific uses of the insertion part 1a include, similar to the insertion part 1d of the cultivation member of the first embodiment, improving the survival rate and growth rate of planted plants through effective use of water and fertilizer by vertical penetration of irrigation water, and reducing the amount and frequency of irrigation water by limiting horizontal diffusion penetration of irrigation water. In addition, planting in saline areas by shielding the salt deposited layer near the ground surface, environmental restoration technology by growth and absorption of plant root systems 301 such as seeds and seedlings planted in a layer of toxic substances at a specific depth below ground, prevention of weeds from invading plant root systems 301, prevention of pests and harmful pathogens from feeding on plant root systems 301, shape control of the root system 301, or planting techniques for preventing slope collapse, etc. are some of the uses of the insertion part 1a, but are not limited to these uses, as is the insertion part 1d of the cultivation member of the first embodiment.

As mentioned at the beginning of the embodiment, the circumferential main wall 10a comprising a flexible water-shielding film of the insertion part 1a of the cultivation member pertaining to the first variation of the 5th embodiment may be a single water-shielding film or a composite water-shielding film. If the thickness of the flexible water-shielding film of the circumferential main wall 10a is between 10 μm and 250 μm, it is flexible, so it can fit any shape of 210 planting furrows, including planting furrows 210 with an aspect ratio D/W of 5 or more, etc., by following the shape of the planting furrows 210. Furthermore, the insertion part 1a can be deformed at any time during the growth and expansion of the root inside the insertion part 1a. If the thickness of the circumferential main wall 10a exceeds 250 μm, it is difficult to follow the shape of the planting furrow 210.

When an insertion part 1a with a circumferential main wall 10a made of a flexible water-shielding film of biodegradable material is used for planting, the circumferential main wall 10a made of the flexible water-shielding film will biodegrade after a certain period of time, and the environmental load caused by the remaining of the circumferential main wall 10a made of the flexible water-shielding film in the ground 200 can be reduced. The circumferential main wall 10a comprising a flexible water-shielding film of the insertion part 1a of the cultivation member for the first variant of the 5th embodiment may include a plant-based material. The plant-based fiber material may be made from unwaxed cotton linter, kapok, or hydrophobic fibers such as banana leaves, which are made into a base material by known methods, or water-resistant paper such as kraft paper, sulfate paper, glassine paper, etc., with a minimum of 3.9 kPa as described at the beginning of this document. The insertion part 1a having a vegetable fiber base material absorbs carbon dioxide at the growth stage of the raw material plant of the vegetable fiber base material, is biodegradable, and can be expected to be used as a low environmental load container.

The component of the water-shielding film material may include a wax of biological origin. As waxes of biological origin, commercially available insect-derived waxes such as beeswax or warbler wax, and plant-derived waxes such as haze wax, carnaba wax, candelilla wax, rice bran wax, palm wax, and jojoba oil can be used. These waxes can be used as a composite water-shielding film by impregnating a vegetable fiber base material. The waxes can be applied directly to the substrate if they are in liquid form, or immersed in a hot water bath to impregnate the substrate if they are in solid form. Wax derived from living organisms exhibits hydrophobic properties, enabling the production of the insertion part 1a using the low environmental impact process of wax extraction from living organisms, its use as a container capable of “degradation treatment over time,” and its biodegradation after the mission is completed.

Hydrolysis-type biodegradable resins, which decompose into water and carbon dioxide through hydrolysis and biodegradation, are known. The circumferential main wall 10a comprising a flexible water-shielding film of the insertion part 1a of the cultivation member for the first variation of the 5th embodiment may include a hydrolysis-type biodegradable resin. Hydrolysable biodegradable resins include starch polyester, polylactic acid, poly(3-hydroxybutyrate-co-3-hydroxyhexanoate), polyglycolic acid, polybutylene adipate/terephthalate, polyethylene terephthalate succinate, polybutylene succinate, polybutylene succinate adipate, etc. are preferred. The insertion part 1a, which has a circumferential main wall 10a made of hydrolytic biodegradable resin with a flexible water-shielding film, will biodegrade and reduce environmental impact after the mission is completed.

The circumferential main wall 10a comprising a flexible water-shielding film of the insertion part 1a of the cultivation member for the first variation of the 5th embodiment may include an oxidatively degradable biodegradable resin. It is well known that oxidatively degradable biodegradable resin is obtained by adding fatty acid salts to polyolefin. As polyolefins, homopolymers or copolymers of low density polyethylene or linear low density polyethylene are preferred for their flexibility and elongation. Preferred fatty acid salts to be added include lauric acid, myristic acid, palmitic acid, stearic acid, oleic acid, and linoleic acid. Manganese, iron, cobalt, nickel, copper, etc. are preferred as metals for fatty acid salts to be added, and metal salts, metal oxides, and metal hydroxides can also be used. Particularly preferred fatty acid metal salts are iron stearate or manganese stearate. Carboxylates, animal fats containing carboxylic acids, vegetable oils, etc. can also be used.

The flexible water-shielding film 10a can be obtained by mixing 0.25 to 5.0% by weight of fatty acid salts with polyolefin in an extruder, kneader, or the like, and then subjecting the mixture to an inflation film manufacturing machine. Commercially available oxidatively degradable biodegradable films can also be used as the circumferential main wall 10a made of flexible water-shielding film. The insertion part 1a using these films as the main circumferential wall 10a made of flexible water-shielding film will biodegrade after the mission is completed, reducing the environmental burden.

The sewing thread 21 that one-dimensionally arranges the plurality of 31a₁, 31a₂, . . . of the insertion part 1a of the cultivation member for the first variation of the 5th embodiment may include a degradable material. Degradable materials include naturally derived materials such as cotton, hemp, silk, wool yarn, rayon, and tencel for biodegradable materials, and polyvinyl alcohol-based or alginate metal salts for water-soluble materials. These materials can be spun and further twisted as needed to obtain 21 sewing threads. Especially preferred are water-soluble polyvinyl alcohol-based yarns. The water dissolution time can be controlled by adjusting the degree of saponification and the thickness of the sewing threads according to the water content of the cultivating soil, the ground temperature irrigation, the growing period, and the size of the insertion part 1a. It is possible to achieve compatibility between the conflicting conditions of coarse and dense sieving: dense sieving to prevent cultivating soil from falling out and to increase the cultivating soil retention rate of irrigation water when planting in a fixed planting site, and sparse sieving after planting to allow the sewing threads to rupture down and make the sieve sparse for easier selective downward vertical penetration of the plant root system 301 into the 200 ground of the cultivating place.

Plants suitable for planting when using the insertion part 1a of the cultivation member for the first variant of the 5th embodiment to grow seedlings are preferably plants with plant root systems 301 extending deep underground in terms of saving irrigation water by using deep stable soil water and increasing the amount of stored carbon in the deep plant root system 301. Suitable planting plants for seedling cultivation using the cultivation member for the first variant of the 5th embodiment include woody plants such as pine and eucalyptus, herbaceous plants such as alfalfa and kalega, and root system utilizing plants such as yam and candlenut, as described in the first embodiment. Furthermore, the same genus of these woody plants, herbaceous plants, and root-utilizing plants can be mentioned, but are not limited to these plants. The insertion part 1a of the cultivation member for the first variant of the 5th embodiment can be inserted into a recess formed in a cultivating place by using a hoe, shovel, auger, or the like. The insertion part 1a is filled with cultivating soil, seeds and seedlings are planted and irrigated.

### —Rupture Test—

As an insertion part 1a for the growing test used in the intermittent joint temporal rupture test, a polyethylene tube with an internal circumference of 21 cm and a height of 30 cm was used as the material and the following sewing threads A, B, and C were used to make the insertion part 1a. Sewing threads A, B, and C were all Solbron (registered trademark), a water-soluble fiber manufactured by Nitvy Co. Ltd.
Sewing thread A; SS62T/18F (melting temperature 30° C. or higher, 62 decitex (dTex) thick, 18 filaments (Filament)
Sewing thread B; SS110T/30F (melting temperature 30° C. or higher, 110 decitex thick, 30 filaments) Sewing thread C; SS600T/200F (melting temperature 30° C. or higher, 600 decitex thick, 200 filaments)

Insertion part 1a made with sewing thread A is designated as rupture test sample A, insertion part 1a made with sewing thread B is designated as broken sample B, and insertion part 1a made with sewing thread C is designated as rupture test sample C. The sewing with sewing threads A, B, and C were all wave stitches, and the sewing interval was 1.5 cm in each case.

Next, cultivating soil was spread to a depth of about 5 cm in the test insertion container to hold the plurality of insertion parts 1a of the rupture test samples A to C. A small amount of cultivating soil was filled into each of the plurality of insertion parts 1a of the rupture test samples A-C, and the excess number of insertion parts 1a of the rupture test samples A-C were stored in the test insertion t container so that the total cross-section part of the plurality of insertion parts 1a of the rupture test samples A-C was larger than the cross-section part of the test insertion container. In addition, 300 g of cultivating soil (13% moisture content) was additionally filled into each of the insertion parts 1a used for the rupture test. At this point, the flexible water-shielding film had longitudinal folds in each of the 1a insertion parts used for the rupture test. One seed of barley, one seed of oats, and one seed of buckwheat were seeded into each of the cultivating soil in the plurality of insertion parts 1a of the rupture test samples A-C, and 300 cc of irrigation was applied to each of them. The plurality of insertion parts 1a of rupture test samples A to C were irrigated three times at 150 cc/times at 7 to 10 day intervals. The outside temperature during cultivation was about 13-24° C.

In the insertion part 1a of the rupture test sample A, the sewing thread A of the intermittent joint broke during filling with cultivating soil, and cultivating soil flowed out from the bottom, so the subsequent tests were cancelled. At one month after seeding, in the insertion part 1a of rupture test sample B, all the sewing threads B of the intermittent joints were ruptured, and the plant root system 301 of the plant was dispersed from the bottom and penetrated into the cultivating soil in the test insertion container. In the insertion part 1a of rupture test sample C, part of the sewing thread C of the intermittent joint was rupture, and the plant root system 301 of the plant was dispersed from the ruptured part and penetrated into the cultivating soil in the test insertion container.

### =a Coupling Cultivation Member=

The coupling cultivation member 2 for the first variation of the 5th embodiment of the present invention is a cultivation coupling in which a plurality of insertion parts 1a1 to 1a7 of cultivation members for the first variation of the 5th embodiment are connected to each other in the horizontal direction using their respective side end as boundary lines, as shown in FIG. 17. The adjacent insertion parts 1a₁ to 1a₇ comprising the growing connectors 2 are linearly fixed to each other through the joints 61a₁ to 61a₆ located at the boundary line, and the side end from the top to the bottom of each of the insertion parts 1a₁ to 1a₇. In the first variant of the 5th embodiment, each of the insertion parts 1a₁ to 1a₇ of the plurality of cultivation members 1a₁ to 1a₇ of the first variant of the 5th embodiment is used as a “child container” in the coupling cultivation member 2 for growing plants, and the plurality of insertion parts 1a₁ to 1a₇ are connected side-by-side in a linear manner. The bottom region of each of the insertion parts 1a₁ to 1a₇ has an intermittent joint to rupture selectively over time, as indicated by the break line. The joints 61a₁-61a₆ can be formed by heat sealing, high frequency bonding, adhesive bonding, etc. As insertion parts 1a₁ to 1a₇ of the cultivation member pertaining to the first variant of the 5th embodiment, as well as insertion parts 1b of the cultivation member pertaining to the second variant of the 5th embodiment, insertion parts 1c of the cultivation member pertaining to the third variant of the 5th embodiment, insertion parts 1p of the cultivation member pertaining to the fourth variant of the 5th embodiment, and the like, as insertion parts 1a that are child containers etc. can be used. The type, number, and arrangement of plurality of insertion parts 1a₁ to 1a₇ in FIG. 17 are examples, and the insertion part 1a that serves as the child container may be mixed with several types of different diameters, or a single type may be used. Furthermore, in addition to connecting the insertion parts 1a as child containers at vertical boundaries, it is also possible to connect them at diagonal boundaries, or to connect them to the front side or back side of the opposite side formed in the pseudo-sack with missing bottom region of the missing of the insertion part 1a1.

The coupling cultivation member 2 for plant growth for the first variation of the 5th embodiment can be used as an integral plant growing container, or the plurality of insertion parts 1a₁ to 1a₇, which are child containers, can be cut and separated and used independently of each other. For example, when using the coupling cultivation member 2 as an integrated plant growing container, the planting distance between the planted plants can be adjusted as desired, such as not planting anything in the insertion part 1a next to the insertion part 1a in which the seeding or planting took place, thereby preventing entanglement between the 301 root systems of the plants. An efficient method can also be employed in which the coupling cultivation member 2 is used as an integral plant growing container for seedlings, and after the seedlings are finished growing, the joints 61a1 to 61a6 of the insertion parts 1a1 to 1a7 are cut and separated for planting method. For cutting, the joints 61A₁ to 61A₆ can be easily separated by forming a break line in the joint 61A₁ to 61A₆.

### 6th Embodiment

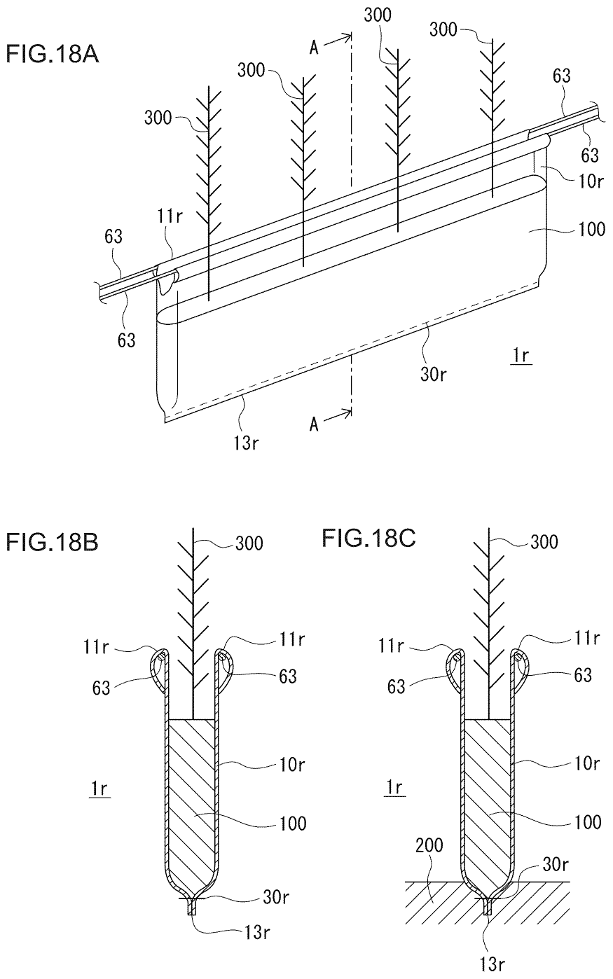

The insertion part 1r of the cultivation member of the 6th embodiment of the present invention differs from the insertion part 1a of the cultivation member of the first variant of the 5th embodiment in the structure of the upper end 11r, as shown in FIGS. 18A and 18B, and includes new uses derived from that structure. Other members, connection relationships between members, and methods of use are similar to the insertion part 1a of the cultivation member for the first variant of the 5th embodiment. As shown in FIG. 18A, the insertion part 1r of the cultivation member according to the 6th embodiment is equipped with a sliding mechanism on a part of the wall that forms the storage structure to achieve structure-supported stress-free variability. That is, at least the upper part of the storage structure can be deformed by the sliding mechanism to consume the volume of the gap space set between the planting furrow 210 and the insertion part 1r, without increasing the in-plane stress of the flexible water-shielding film. The flexible water-shielding film comprising the insertion part 1r can be either a single water-shielding film or a composite water-shielding film, as with the insertion parts 1d, 1u, 1g, 1e, 1f, etc. of the cultivation members of the first to 5th embodiments.

In FIGS. 18A and 18B, the upper end 11r of the insertion part 1r is folded outward to form a variable capacity cylindrical structure on both the front and rear sides of the facing surface formed in the bottom region of the pseudo-sack with a missing bottom, and two wires 63 are “wire-through” the variable capacity cylindrical structure. Two wires 63 are threaded through each of the variable capacity cylindrical structures as “wire threaders”. Each variable capacity cylindrical structure may be folded inwardly, and the variable capacity cylindrical structure may be fixed by any fixing method, such as by a stapler needle, etc. The two wires 63 are stretched across the pillars (FIG. is omitted). The insertion part 1r is suspended from the two wires 63. In the insertion part 1a of the cultivation member for the first variant of the 5th embodiment, it was erected inside the insertion part container or inserted inside the 210 planting furrow formed by digging in the ground 200, but for the insertion part 1r of the cultivation member for the 6th embodiment, it is a style of being suspended from the upper end 11r. As shown in FIGS. 18A, 18B, the lower end 13r of the insertion part 1r can be used without grounding, and as shown in FIG. 18C, the lower end 13r of the insertion part 1r can be grounded to a ground 200 or the like. When the lower end 13r is grounded to the ground 200, it may be stabilized by ridging the ground 200, or the lower end 13r may be buried deeper than shown in FIG. 18C. In either case, the surface level of the filled cultivating soil 100 is above the surface level of the ground 200. When the lower end 13r is separated or in contact with the ground, it can be used for seedling growth or for planting, and when the lower end 13r is buried in the ground, it can be used for planting. For the part to be grounded or buried, in addition to the ground 200, a liquid tank consisting of a culture medium can also be used.

In the insertion part 1r of the cultivation member pertaining to the 6th embodiment, the intermittent joint 30r that selectively ruptures over time is consisted of a plurality of bonded parts (constrictions) arranged one dimensionally in a straight line by sewing thread, but other construction methods are also possible. As in the case of the cultivation members of the first to 5th embodiments, when the insertion part 1r is composed of a single water-shielding film, the intermittent joints 30 are selectively rupture over time by the hydrotropism expansion effect of the plant root system 301. When the insertion part 1r is composed of a composite water-shielding film, selective temporal rupture occurs efficiently due to the cumulative effects of the disruption of hydrogen bond of the plant fibers that make up the composite water-shielding film. The selective temporal rupture of the intermittent joint 30 has the remarkable effect of promoting selective downward elongation of the plant root system 301 of the planted plant 300 with a small amount of irrigation and preventing root curling of the plant root system 301. The insertion part 1r may be provided with plurality of partitions in the main wall 10r made of flexible water-shielding film in the sense of partitioning the cultivating soil for each plant 300, and a structure such as the coupling cultivation member 2 for growing plants in the first variation of the 5th embodiment may be used instead.

According to the insertion part 1r of the cultivation member pertaining to 6th embodiment, in addition to the effect of the insertion part 1a of the cultivation member pertaining to 5th embodiment, there are effects such as securing the superiority of plant 300 in the growth competition with weeds, and reducing the labor required for the digging up work of plant root system 301 and avoiding damage to plant root system 301 in the case of root system-using plants, due to the increase in the light-receiving area for plant 300.

### <First Variant of the 6th Embodiment>

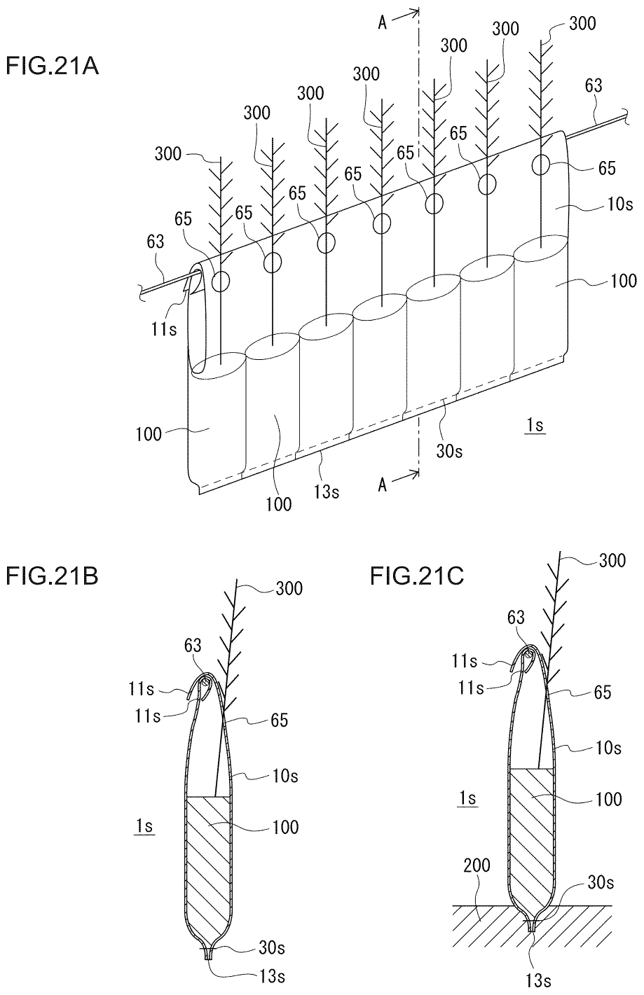

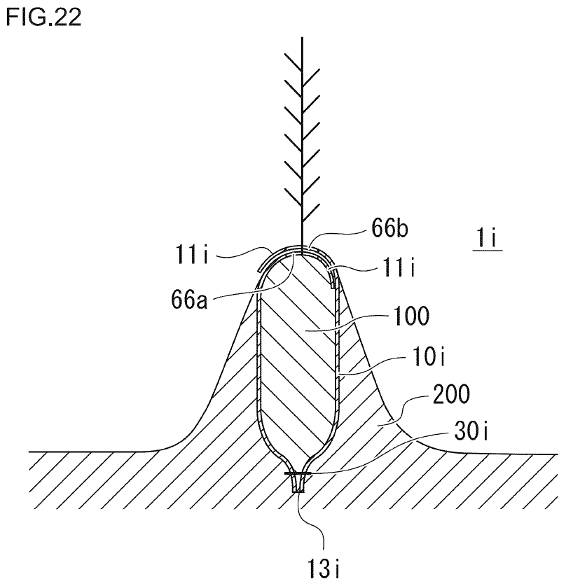

The insertion part 1s of the cultivation member pertaining to the first variant of the 6th embodiment of the present invention differs from the insertion part 1a of the cultivation member pertaining to the first variant of the 5th embodiment in the structure of the upper end 11s, as shown in FIGS. 21A and 21B, and includes new usage methods derived from the structure of the upper end 11s. Other components, connection relationships among the components, and methods of use are the same as for the insertion part 1a of the cultivation member for the first variant of the 5th embodiment. The main wall 10s made of flexible water-shielding film has a plurality of partitions vertically ascending from the lower end 13s, and the interior divided by the plurality of partitions is filled with cultivating soil 100 for cultivation, and a plurality of plants 300 are grown in each partition. In FIG. 21A, the plurality of partitions are formed from the lower end 13s to the upper end 11s, and there are no partitions from there to the upper end 11s, but the plurality of partitions may be provided to the upper side than shown in FIG. 21A. The insertion part 1s may also be formed based on a structure such as the coupling cultivation member 2 for growing plants in the first variant of the 6th embodiment. That is, a flexible water-shielding film without partitions may be connected to the top of the coupling cultivation member, which is a collection of child containers, to achieve a structure with no partitions near the upper end 11s, as shown in FIG. 21A.

In the insertion part 1s of the cultivation member for the first variant of the 6th embodiment, as shown in FIGS. 21A and 21B, the upper end 11s of one of the opposing sides of the main wall 10s made of flexible water-shielding film is folded inward to form a cylindrical structure with variable capacity. The other upper end 11s is covered by the variable-capacity cylindrical structure. A wire 63 is threaded through that variable-capacity cylindrical structure as a “wire threader”. The variable capacity cylindrical structure may be folded outward, or the variable capacity cylindrical structure may be secured with a stapler needle or any other method of securing it. Wire 63 is stretched across the pillars (FIG. is omitted), and the insertion part 1s is suspended from the wire 63. The main wall 10s, which is made of flexible water-shielding film, has a plurality of through holes 65 drilled in the upper end 11s of the wall to be covered. These plurality of through holes 65 allow plants 300 to grow upward. The through holes 65 also serve to prevent steam inside the insertion part 1s.

The insertion part 1a of the cultivation member of the first variant of the 5th embodiment is used standing on the insertion container or ground 200, but the insertion part 1s of the cultivation member of the first variant of the 6th embodiment, like the insertion part 1r of the cultivation member of the 6th embodiment, is suspended from the upper end 11s. The upper end of the member is suspended from the upper end 11s. As shown in FIGS. 21A and 21B, the cultivation system pertaining to the first variant of the 6th embodiment can be used without grounding the lower end 13s of the insertion part 1s, or as shown in FIG. 21C, the lower end 13s of the insertion part 1s can be grounded to a ground 200 or the like. When grounding the lower end 13s to the ground 200, the ground 200 may be ridged to stabilize it, or the lower end 13s may be buried deeper than shown in FIG. 21C.

In the cultivation system for the first variant of the 6th embodiment, the surface level of the cultivating soil 100 filled in the insertion part 1r will be above the surface level of the ground 200. When the lower end 13s is separated from the surface level of the ground 200, as shown in FIG. 21B, or when the lower end 13s is in contact with and slightly embedded in the surface level of the ground 200, as shown in FIG. 21C, the system can be used for seedling growth or for planting. For the point where the insertion part 1r is grounded, etc., a liquid tank consisting of culture medium can also be used in addition to the ground 200. In the insertion part 1s of the cultivation member pertaining to the first variant of the 6th embodiment, the intermittent joint 30s that selectively ruptures over time is composed of a plurality of bonded part (constrictions) arranged one dimensionally in a straight line by sewing thread, but other construction methods are also possible. According to the insertion part 1s of the cultivation member according to the first variant of the 6th embodiment, in addition to the effects of the insertion part 1a of the cultivation member according to the first variant of the 5th embodiment, the following effects can be achieved: securing the advantage of the plant 300 in the growth competition with weeds by increasing the light receiving area of the plant 300, reducing the labor required for digging work, prevents damage to plant roots, retaining the heat and moister, protecting against rain and insects etc.

### <Second Variation of the 6th Embodiment>

In the cultivation system for the second variation of the 6th embodiment of the present invention, as shown in FIG. 22, by ridging the ground 200 until the upper end 11i is almost hidden, the insertion part 1i by wire 63, which was adopted in the cultivation system for the first variation of the 6th embodiment is no longer necessary. In the insertion part 1i shown in FIG. 22, the first through hole 66a and the second through hole 66b are provided at each of the upper end 11i of the opposite side of the main wall 10i made of flexible water-shielding film. In the cultivation system for the second variant of the 6th embodiment, as in the cultivation system for the first variant of the 6th embodiment, the surface level of the cultivating soil 100 filled inside the insertion part 1i will be above the surface level of the ground 200 as shown in FIG. 22.

When the lower end 13i of the insertion part 1i is buried in the ground as shown in FIG. 22, it can be used in a cultivation system for permanent planting. For the location where the insertion part 1i is buried, in addition to the ground 200, a liquid tank consisting of a culture medium can also be used. In the insertion part 1i of the cultivation member pertaining to the second variant of the 6th embodiment, the intermittent joint 30i that selectively rupture over time is composed of a plurality of bonded part (constrictions) arranged one dimensionally in a straight line by sewing thread, but other construction methods are also possible. According to the insertion part 1i of the cultivation member according to the second variant of the 6th embodiment, in addition to the effects of the insertion part 1a of the cultivation member according to the first variant of the 5th embodiment, the following effects can be achieved: securing the advantage of the plant 300 in the growth competition with weeds by increasing the light receiving area of the plant 300, reducing the labor work required for digging work, prevents damage to plant roots, and retaining the soil heat and moistening, protecting against rain and insects etc.

### 7th Embodiment

In the insertion parts 1d, 1u, 1g, le, 1f, 1a, etc. of the cultivation members of the first to 6th embodiments, the structure-supported variability with a sliding mechanism on a parts of a wall of the wall that forms the storage structure of the insertion parts 1d, 1u, 1g, 1e, 1f, 1a, etc. was explained. In the insertion part 1s of the cultivation member of the 7th embodiment of the present invention, a part of the wall of the storage structure comprising the insertion part 1s is in an open state, which is different from the structure with a closing mechanism by superimposed structure comprising the sliding mechanism of the insertion parts 1d, 1u, 1g, 1e, 1f, 1a, etc. described in the first to 6th embodiments. However, even if a part of the wall of the storage structure comprising the insertion part 1s is in the open state, the same structure-supported stress-free variability as in the first to 6th embodiments can be realized. That is, by using the open state feature, the shape of at least the upper part of the storage structure whose ends are open can be deformed without increasing the in-plane stress of the flexible water-shielding film, thereby increasing the internal volume. The flexible water-shielding film comprising the insertion part 1s can be either a single water-shielding film or a composite water-shielding film, as with the insertion parts 1d, 1u, 1g, 1e, 1f, 1a, etc. of the cultivation members of the first to 6th embodiments.

Specifically, the insertion part 1s of the cultivation member pertaining to the 7th embodiment is a storage structure (pseudo-sack) that forms a U-shape (loincloth) shown in FIG. 23A, and this U-shaped pseudo-sack presents a structure with open ends 15s and 16s, but even this structure can realize the structure-supported stress-free variability. When the insertion part 1s is inserted into the planting furrow 210, the wall of the planting furrow 210 acts in a similar manner to the closing mechanism described for the insertion parts 1d, 1u, 1g, 1e, 1f, 1a, etc. described in the first through 6th embodiments, so that cultivating soil 100, etc. introduced from the top of the insertion part 1s is difficult to drop from the open side ends 15s and 16s. This makes it difficult for soil 100, etc. introduced from the top of the insertion parts 1s to fall out of the open side ends 15s, 16s. Furthermore, since the left side end 15s and the right side end 16s of the insertion part 1s are released, it is possible for the insertion part 1s to have the same effect as the increase in the internal volume Vᵢₙₛₑᵣₜ, V_{charge} V_{growth} described in formula (1) of the first embodiment.

The insertion part 1s of the 7th embodiment of the cultivation member is a thin film for growing plants and as shown in FIG. 23B, has a main wall surface 10s made of flexible one water-shielding film to form a U-shaped structure as shown in FIG. 23A. In the insertion part 1s of the cultivation member of the 7th embodiment, for convenience, the flexible main wall located at the back side of the U-shape in FIG. 23A is defined as the “second main wall” and the flexible main wall located at the front side is defined as the “first main wall”. That is, the main wall located on the upper side of FIG. 23A is the U-shaped second main wall, and the main wall located on the lower side is the U-shaped first main wall. One U-shaped main wall 10s of the flexible water-shielding film has a folded structure, so that the lower parts of each of the first and second main walls are joined to form a loincloth-like insertion part 1s, which is open at both side ends. With the structure shown in FIG. 23A, where a part of the wall surface is open, the effective volume formed by the storage structure can be increased as shown in formula (1), so as to consume the volume of the gap space set between the planting furrow 210 and the insertion part 1s, without increasing the in-plane stress of the flexible water-shielding film. Therefore, the effective shape of the insertion part 1s can be regarded as deformed so as to consume the gap space between the planting furrow 210 and the insertion part 1s.

In the insertion part 1s of the cultivation member of the 7th embodiment, the two side ends 15s, 16s of the opposing surfaces, which form part of the U-shaped structure, are open without intersecting each other. Therefore, the two side ends 15s and 16s of the U-shaped structure do not provide a barrier to the soil outside of the insertion part 1s by the walls of the insertion part 1s. However, by making both the height level of the cultivating soil 100 filled into the storage structure of which the insertion part 1s is composed and the soil density of the cultivating soil 100 inside the insertion part 1s lower than the ground 200 of the cultivating place that consists of the walls of the planting furrow 210, lateral penetration of irrigation from the side ends 15s, 16s to the outside of the insertion part 1s runoff infiltration will be limited. Irrigation to the cultivating soil 100 filled in the insertion part 1s then penetrates almost selectively downward through the interior of the cultivating soil 100. Thus, the narrower and longer planting furrow 210 is, the lower the rate of infiltration of water lateral runoff into the ground 200 outside the insertion part 1s.

The loincloth-shaped insertion part 1s is inserted into the interior of the planting furrow 210 in the same manner as shown in FIGS. 5 and 6A, etc., so that it is U-shaped in cross-part, etc., and the cultivating soil 100 for growing plants is filled between one U-shaped main wall of the insertion part 1s. The lower end 13s of the U-shaped main wall 10s, which is made of one flexible water-shielding film, has a plurality of non-bonded parts 41s in intermittent succession. For example, if the flexible water-shielding film is a three-layer laminated composite water-shielding film, the plant fiber layer, which is the central layer of the composite water-shielding film, is exposed in the openings as non-bonded parts 41s. In FIGS. 23A and 23B, the lower end 13s at the location of the bend line is shown as if it were a line, but it is actually a band (rectangular) two-dimensional area with an area that allows a plurality of non-bonded part 41s to be placed, which constitute a slit-like opening with a width as shown in FIGS. 23C and 23D. The insertion part 1s is folded at the center line dividing the lower end 13s into the first and second bottom regions. Therefore, the lower end 13s, shown schematically as a line in the development shown in FIG. 23B, actually has a width, and the area above the center line that fits within this width is the zonal second bottom region. The area below the centerline that fits within the width of the lower end 13s is the first bottom region of the band. When viewed from the direction of the left side end 15s or the right side end 16s, the apparent first and main walls appear to join in a U-shape at the center line dividing the first and second bottom side regions, as shown in FIG. 23A. The second main wall can be defined for convenience as the second bottom region and a third side that is perpendicular to the longitudinal direction of this second bottom region, as well as a fourth side that is separated from one end that is the third side and parallel and opposite to this one end. The first main wall is a thin-film surface of the same shape and size as the second main wall, as shown in FIGS. 23A and 23B.

The first bottom region of the first main wall surface faces the second bottom region parallel to the longitudinal direction of the second bottom region and is intermittently bonded with a part of the second bottom region at plurality of locations along the longitudinal direction of the second bottom region to form the bonded part 31s. The first main wall can be defined for convenience as the first side opposite the third side of the second main wall and separated from the third side in a U-shaped, and the second side opposite the second side of the second main wall and separated from the first side in a U-shape. However, as can be seen from FIGS. 5a, 6a, 7a, etc., the composite water-shielding film is flexible, so its shape is not defined by the U-shaped as illustrated in FIG. 23A. A plurality of non-bonded parts 41s and a plurality of bonded part 31s, which are arranged alternately with each other at the lower end 13s, are repeatedly arranged in a straight line (one-dimensional arrangement) from the left side end 15s to the right side end 16s to form an intermittent joint.

As shown in FIG. 23C, the plurality of non-bonded parts 41s are a plurality of intermittent cuts (slits) in the flexible water-shielding film, each non-bonded part 41s forming a through hole through the flexible water-shielding film. The non-bonded parts 41s have exposed edge 41s₁ and exposed edge 41s₂, which are the wall surfaces of the cut-through holes, as shown in FIGS. 23C and 23D. As in the case of the cultivation members of the first through 6th embodiments, when the insertion part 1s is consisted of a single water-shielding film, the intermittent joint 30 is selectively rupture over time by the hydrotropism expansion effect of the plant root system 301. When the insertion part 1s consisted of a composite water-shielding film, selective temporal rupture occurs efficiently due to the cumulative effects of hydrotropism expansion and the disruption in hydrogen bonding of the plant fibers that make up the composite water-shielding film. When the insertion part 1S consisted of a three-layer laminate structure including a plant fiber base layer and a hydrophobic material layer covering both sides of this plant fiber base layer, the exposed edge 41ₛ₁ and the exposed edge 41ₛ₂ each expose the three-layer laminate structure of the plant fiber base layer and hydrophobic material layer. Water penetration into the plant fiber base material layers of the exposed edge 41s₁ and 41s₂ causes selective temporal rupture of the intermittent joints. The selective temporal rupture of the intermittent joints can promote the selective downward elongation of the plant root system 301 of the planted plant 300 with a small amount of irrigation, thereby preventing root curling of the plant root system 301.

Since the composite water-shielding film is flexible, the pattern of through holes comprising the non-bonded part 41s can easily change the shape when cultivating soil for growing plants is filled between the single U-shaped main wall 10s. That is, by filling with cultivating soil, the pattern of through holes changes from a rectangular pattern in the unloaded state before filling, to an elliptical pattern with pointed tip (boat shape with both sharply angled bow and stern), as shown in FIGS. 23C and 23D. However, the pointed shapes at the bow and stern shown in FIGS. 23C and 23D are schematic; in reality, the shape of the short sides of the rectangle at no load is maintained at the bow and stern, and the upper convex surface above and the lower convex surface below are planar patterns connected to each other via the short sides of the rectangle. When the space between the first main wall and the second main wall surfaces of the insertion part 1s is filled with cultivating soil and then irrigated from above, some of the water leaks out (downward) from a plurality of through holes forming an elliptical pattern, as shown in FIGS. 23C and 23D.

In the insertion part 1s of the cultivation member of the 7th embodiment, the lower end 13s is intermittently continuous at the plurality of bonded part 31s, and if one focuses only on the lower part, water and particle such as fine sand grains introduced from the upper part of the insertion part 1s leak partly to the outside through the through holes formed by the plurality of non-bonded parts 41s. On the other hand, the two-dimensional dimensions of the through holes are designed in such a way that clumps of soil and other particles agglomerated with water do not leak out through the through holes formed by the plurality of non-bonded parts 41s, but are retained inside the insertion part 1s and can remain stored. If we look at the two side ends of the insertion part 1s shown in FIGS. 23A and 23B as a stand-alone structure, the third side end of the second bottom region and the first side end of the first main wall are separated from and opposite each other, and the second side end of the second bottom region and the second side end of the first main wall are separated from and opposite each other. That is, as shown in FIG. 23A, at the left side end 15s of the insertion part 1s, the third and first side ends are separated and open in a U-shaped, and at the right side end 16s, the fourth and second side ends are separated and open in a U-shaped, so the insertion part formed by the insertion part 1s is not strictly sack-shape. Therefore, some water, fine grains of sand, and other particles introduced from the top of the insertion part 1s in a bare state appear to drop out of the left side end 15s and right side end 16s, and some clumps of soil and other particles that have agglomerated with water also appear to drop out of the left side end 15s and right side end 16s.

However, as shown in FIGS. 5 and 6A, etc., the insertion part 1s is designed to have a width that can accommodate the insertion part 1s including the lower end 13s (see FIG. 23, etc.). Therefore, when the insertion part 1s is inserted inside the planting furrow 210, the wall of the planting furrow 210 acts as a part of the sack and becomes an obstacle for soil clods and the like to fall out. That is, the wall of the planting furrow 210 acts as an equal function to the superimposed surface structure of the first left auxiliary piece 18L₁ and the second left auxiliary piece 18L₂ constituting the left closing mechanism 19L described in the first embodiment, and furthermore, the superimposed surface structure of the first right auxiliary piece 18R₁ and the second right auxiliary piece 18R₂ constituting the right closing mechanism 19R. Formula (6) of the first embodiment explains the undesirable situation in which a larger Δl^{ho}*(t) due to the extension in the direction of the furrow length L causes a hole directly under the U-shaped flattened points at both ends of the insertion part 1d, and the cultivating soil 100 with a smaller particle size than the hole occurs with a probability of falling through the hole.

The function of the hole occurring directly under the left closing mechanism 19L and right closing mechanism 19R of the first embodiment is equivalent to the longer distance between the wall of the planting furrow 210 and the end of the insertion part 1s. Therefore, even if the loincloth-shaped pseudo-sack with a missing bottom has a structure in which both side ends 15s and 16s are open, water, fine sand grains and other particles introduced from the top of the insertion part 1s, as well as clumps of soil that have agglomerated with water, will have difficulty falling out of the open side ends 15s and 16s, to the outside of the insertion part 1s. In addition, since the left side end 15s and the right side end 16s are open due to the loincloth-like (U-shaped) structure, there is a certain degree of freedom to increase the internal volume of the insertion part 1s. Thus, the U-shaped structure allows for an increase in the internal volume Vᵢₙₛₑᵣₜ, V_{charge} V_{growth} as described in formula (1) of the first embodiment. The insertion part 1s is a plant growing container that can be filled with cultivating soil 100 and irrigated between one U-shaped main wall 10s, enabling plants to be grown from seeds and seedlings.

If a distance occurs between each of the two side ends 15s, 16s of the insertion part 1s and the wall of the corresponding planting furrow 210, and the cultivating soil 100 is likely to fall out of the two side ends 15s, 16s, then additional auxiliary pieces that fill the space between the two side ends 15s, 16s and the wall of the corresponding planting furrow 210 as fall prevention auxiliary pieces. The prevention auxiliary pieces are, for example, a rectangular piece of material. The prevention auxiliary piece should be shaped as a rectangle, for example, and placed so that one side of the rectangle is superimposed on both side ends of the bottom region of the insertion part 1s in a U-shaped. Furthermore, the length of the prevention auxiliary piece should be selected so that there is an excess length of the longitudinal component that remains in contact with the wall of the corresponding planting furrow 210. One side of the side ends where each of the fall prevention auxiliary pieces superimpose the bottom region of the insertion part 1s may be semi-fixed or fixed to the U-shape by sewing, a stapler needle, glue, etc. at the U-shaped superimposing points at both ends of the bottom region, respectively.

Alternatively, if the cultivating soil 100 is likely to drop out from the side ends 15s and 16s, the position near the side ends 15s and 16s where it is likely to drop out may be filled with pre-selected molded soil that is larger than the distance from the wall of the planting furrow 210, and the remaining area may be filled with amorphous cultivating soil 100. By first placing molded soil with large particle size on both side ends 15s, 16s of the intermittent joint 30 and then filling the remaining areas with amorphous soil, it is possible to prevent the amorphous soil from falling out of the gaps on both sides end 15s, 16s of the intermittent joint 30. The technique of using large formed cultivating soil and the technique of providing fall prevention aid pieces at both side ends of the bottom region of the insertion part 1s may be used in combination.

As shown in FIGS. 23C and 23D, etc., the insertion part 1s of the cultivation member in the 7th embodiment has a through hole formed by a plurality of non-bonded part 41s at the lower end 13s, so that moisture collected at the lower end 13s is absorbed by the exposed edge 41s₁ and 41s₂ exposed to the through holes of a plurality of non-bonded part 41s. If the insertion part 1s is consisted of a composite water-shielding film with a three-layer laminate structure, as the moisture is absorbed from the exposed edge 41s₁ and exposed edge 41s₂ of the plurality of non-bonded parts 41s, the plant fiber substrate layer, which is the central base material of the three-layer laminate structure, becomes brittle and selective temporal rupture occurs. The weight of the irrigated cultivating soil 100 is applied to the lower end 13s, and selective rupture occurs from the plant fiber base layer of the composite water-shielding film near the lower end 13s. In the case of a three-layer laminated structure where the plant fiber base material layer of the composite water-shielding film is coated with a hydrophobic material layer, the hydrophobic material layer covering the surface is extremely thin, and as the hydrogen bond of the plant fiber base material that has become brittle due to water absorption through the exposed edge 41s₁ and 41s₂ progressively rupture down, selective temporal rupture occurs. That is, the ability of the lower end 13s to retain cultivating soil 100 and irrigation water is lost, and the root systems of plants planted in the insertion part 1s are more easily extended toward the bottom of the insertion part 1s. As a result, the insertion part 1s is inserted into the interior of the planting furrow 210, which facilitates selective elongation of the plant root system 301 toward the lower part of the planting furrow 210, thereby preventing root curling of the plant root system 301.

In the insertion part 1s of the cultivation member for the 7th embodiment shown in FIG. 23A, etc., the shape viewed from the normal direction of the main wall is rectangular in the unloaded state in which nothing is filled between one U-shaped main wall 10s, but it may be a shape other than rectangular. For example, convex parts facing each other may be provided near the center of the top of each of the U-shaped single main walls 10s of the insertion part 1s of the cultivation member of the 7th embodiment, so that they can function like handles and are continuous with the composite water-shielding film. Furthermore, in the insertion part 1s of the cultivation member for the 7th embodiment shown in FIG. 23A, etc., the shape viewed from the direction normal to the main wall is a horizontal rectangle when nothing is filled between the single U-shaped main wall 10s, but any shape can be employed, including a vertical shape and a shape that is constricted from the top to the bottom.

The method of forming the through hole that functions as the non-bonded part 41s in the lower end 13s can be adopted by cutting along the lower end 13s, which is the planned crease parts of a single water-shielding film, in a break line shaped using a rotary cutter or the like already described in the first embodiment. The rotary cutter can adjust the ratio of the length measured in the longitudinal direction of the lower end 13s to the non-bonded part 41s and the bonded part 31s by changing the ratio of the circumferential length of the blade groove between the blades. The ratio of the lengths measured in the longitudinal direction of the lower end 13s to the non-bonded part 41s and the bonded art 31s, respectively, allows adjustment of the rupture resistance of the lower end 13s and the time at which selective temporal rupture begins. From the viewpoint of the rupture resistance of the lower end 13s and the time maintained until selective rupture begins, the ratio of the lengths of the non-bonded parts 41s and the bonded part 31s measured in the longitudinal direction of the lower end 13s should be such that the length of the non-bonded part 41s is longer than that of the bonded parts 31s. For example, the ratio of the non-bonded parts 41s to the bonded parts 31s is more than 2, preferably more than 10.

The length in the longitudinal direction of the through hole (length of the major axis of the ellipse) of the non-bonded part 41s shown in FIG. 23C is defined as the “action length,” and the width orthogonal to the action length at the center of the action length (length of the minor axis of the ellipse) is defined as the “buffer width” of the non-bonded part 41s. Compared to when the insertion part 1s is not filled with anything, the buffer width of the non-bonded parts 41s is enlarged and the action length is reduced when the insertion part 1s is filled with cultivating soil 100. The change in the shape of the non-bonded part 41s is settled at the point where the tension of the composite water-shielding film is balanced by the expansion force generated by the internal filling of the insertion part 1s of the cultivating soil 100. When a large amount of cultivating soil 100 is filled, the buffer width widens greatly due to the pressing force of the cultivating soil 100 against the through-hole, and the through-hole in the non-bonded parts 41s becomes a “drum belly filled with cultivating soil 100” type gap.

When the cultivating soil 100 begins to be filled into the insertion part 1s, particles smaller than the action length or the buffer width, whichever is smaller (hereinafter, also referred to as the “sieve mesh”), may fall out from the center of the through hole formed by the non-bonding part 41s. However, the actual amount of particles of cultivating soil 100 that fall outs negligible because the cultivating soil 100 and the like agglomerate with each other to form a larger mass due to the interaction of the particles and the pressing force. Once the cultivating soil 100 is deposited at the lower end 13s of the insertion part 1s, it almost never falls out of the through hole made by the non-bonded part 41s during the subsequent filling of the cultivating soil 100. The residual accumulation rate can be increased by increasing the compaction or humidification of the cultivating soil 100 to be filled. The action length should be between 5 mm and 1.5 cm from the viewpoint of balancing the retention of cultivating soil 100 and irrigation water leakage.

When water is irrigated into the cultivating soil 100 filled in the U-shaped main wall 10s of the insert part 1s, which is a loincloth-like insert part 1s with both open sides, the water penetrate downward through the cultivating soil 100 and is temporarily blocked at the lower end 13s. The blocked water then penetrates again so as to flow back into the upper cultivating soil 100, and over time leaks out from each of the through holes of the non-bonded part 41s. Generally, in top irrigation of seedling containers, specific channels are formed inside the cultivating soil 100 in proportion to the particle size of the soil particles, and water tends to leak out from the bottom without fully penetrating the entire 100. Therefore, to achieve both high water penetration rate into the cultivating soil 100 and water conservation rate, immersed bottom irrigation, in which the seedling container is immersed in a water tank from the bottom, is effective, and even in conventional seedling pots having a bottom, pseudo immersed bottom irrigation occurs due to water staying on the bottom. Compared to conventional seedling pots with bottoms, the plurality of non-bonded part 41s in the insertion part 1s are more effective for pseudo-immersed bottom irrigation, because the cultivating soil 100 is densely compacted and accumulated on the small lower end 13s, allowing the blocked water to reach the top region of the cultivating soil 100. As a result, it is possible to achieve both high penetration rate into the soil and water saving rate.

The plant fibers are not limited to fibers obtained from plant tissues such as wood pulp, recycled waste paper, cotton fibers, etc., as described in the first embodiment. As the hydrophobic material of the composite water-shielding film of the insertion part 1s of the cultivation member of the 7th embodiment, hydrophobic materials of the first or second category described in the first embodiment can be used. The composite water-shielding film of the hydrophobic material of the first category with plant fibers can be obtained by laminating a film of the hydrophobic material of the first category with plant fiber paper. Composite water-shielding film of the first category of hydrophobic materials and plant fibers can also be obtained by making pellets and compositing them by extrusion molding (T-die method) or inflation molding. Composite water-shielding film of the second category of hydrophobic materials with plant fibers can be obtained by adding the second category of hydrophobic materials at the time of papermaking, impregnating or applying the second category of hydrophobic materials to the papermaking of plant fibers.

Any type of cultivating soil 100 can be used for filling the insertion part 1s. However, by making the cultivating soil 100 a low permeability clayey soil or a high hydrophilic material, it is possible to prolong the leakage time through the through holes constituted by the plurality of non-bonded part 41s and to prolong the time for irrigation water to penetrate to the lower end 13s. The cultivating soil 100 to be filled into the insertion part 1S may be molded cultivating soil. Molded cultivating soil refers to cultivating soil 100 that has a restricted degree of freedom of shape. As the cultivating soil 100 to be filled into the insertion part 1S, it is possible to use both the molded soil and the cultivating soil 100 with a degree of freedom of shape. The same type of soil as cultivating soil 100 can be used as the “weight” for the tip of the loincloth-shaped insertion part 1s, which is open at both ends.

By using molded cultivating soil as the cultivating soil 100 for the insertion part 1s, the shape retention of the molded soil can be utilized to allow the insertion part 1s to stand upright on its own, or the elasticity of the molded soil can be used to reinforce the ground in planting methods to prevent the collapse of sloping land. Plants suitable for planting when using the insertion part 1s of the cultivation member of the 7th embodiment to grow seedlings are preferably plants with plant root systems 301 extending deep underground in terms of saving irrigation water by using deep stable soil water and increasing the amount of stored carbon in the deep root system. Suitable planting plants for seedling cultivation using the insertion part 1S of the cultivation member of the 7th embodiment include woody plants such as pine and eucalyptus described in the first embodiment, herbaceous plants such as alfalfa and kalega, and root system utilizing plants such as yam and candlenut. Furthermore, the same genus of these woody and herbaceous plant root system utilization plants may also be used, but this is only an example. Specific applications of the insertion part 1s include, but are only examples, inducing the downward growth of the plant root system of planted seeds and seedlings at the fixed or temporary planting sites described in the first embodiment.

An example of a method of planting plants by means of the insertion part 1s in the target land for planting (planting place), similar to that shown in FIGS. 5 and 6, etc., is shown below. First, the insertion part 1s shown in FIG. 23A, etc. is prepared. Next, a planting furrow 210 is dug in the ground 200 of the cultivating place. A small amount of cultivating soil is put into the lower end 13s (see FIG. 23A) of the insertion part 1s, which is a loincloth-shaped insertion part with open both side ends, and the insertion part 1s is inserted into the planting furrow 210. Next, as shown in FIGS. 5A, 6A, and 7A, the inside of the insertion part 1s, i.e., between one of the U-shaped main walls of the insertion part 1s, is filled with cultivating soil 100, a plant 300 is planted in the cultivating soil 100, and the planted plant 300 is irrigated. The amount of cultivating soil 100 to be filled is arbitrary, and the surface level of the cultivating soil 100 to be finally filled into the loincloth-shaped insertion part 1s with open both side ends of the main walls of the insertion part 1s being released can be set at any level, equal to, above, or below the surface level of the ground 200 of the cultivating place, independently of the surface level of the ground 200 of the planting place. By using the insertion part 1s for planting, it becomes possible to easily and rsurely insert the insertion part 1s to the bottom of the planting furrow 210 in the ground 200, and as the cultivating soil 100 is filled in and irrigated, the lower end 13s of the insertion part 1s, which is shaped like a loincloth with open both side ends and formed by the main wall surface of the insertion part 1s, gradually ruptures, allowing the plant root system 301 of the planted plant to selectively extend downward, with the effect of preventing the plant root system 301 from curling.

By using the insertion part 1s of the cultivation member of the 7th embodiment in the plant planting process, the following effects are produced.

(1) By preparing a rolled member in advance and cutting the rolled member on-site (at the cultivating place) to create the insertion part 1s according to the depth of the 210 planting furrows, the size of the insertion part 1s can be adapted to any depth of the 210 planting furrows. It will be difficult to generate waste of parts.

(2) Even in a relatively deep and narrow planting furrow 210, the tip of the lower end 13s of the insertion part 1s can be easily and surely inserted to the bottom of the planting furrow 210 by putting soil as a weight into the lower end 13s of the loincloth-shaped insertion part 1s with open both side ends.

(3) Since it deforms in accordance with the deformation of the planting furrow 210 and cultivating soil 100, it has a high rupture resistance when the furrow is not irrigated.

(4) By selectively temporal rupture and opening the lower end 13s of the insertion part 1s due to irrigation and the weight of the cultivating soil 100, the plant root system 301 of the planted plant 300 can be selectively extended from the lower end 13s downward in the planting furrow 210. The plant root system 301 does not cause root curling.

(5) Irrigation water can be saved because irrigation water does not penetrate except at the lower end 13s of the insertion part 1s, but only through the through holes configured by the plurality of non-bonded parts 41s arranged at the lower end 13s.

When paper is used as the plant fiber base material layer, the composite water-shielding film with a three-layer laminated structure with paper and hydrophobic material layers is difficult for water to penetrate. However, in the insertion part 1s of the cultivation member of the 7th embodiment, the non-bonded part 41s of the composite water-shielding film formed by specific mechanical means such as a rotary cutter is easily penetrated by water because the plant fiber having hydroxyl groups is exposed at the cut part, and the hydrogen bonding strength between cellulose of the plant fiber, is reduced by the penetrated water, and the plant fibers are more likely to be selectively rupture over time. By minimizing the area of the bonding parts of the lower end 13s of the insertion part 1s formed by the insertion part 1s of the cultivation member of the 7th embodiment, the bonding strength of the lower end 13s itself can be reduced. Furthermore, by exposing the plant fibers to the non-bonded part 41s by certain mechanical means, such as a rotary cutter, and allowing water from irrigation or other means to penetrate through the exposed edge 41s₁ and 41s₂, the bonding strength of the lower end 13s can be further reduced.

That is, the insertion part 1s of the cultivation member for the 7th embodiment is configured so that the lower end 13s of the insertion part 1s is ruptured and opened after the plants are planted, faster than the rupture of the composite water-shielding film. After filling the insertion part 1s with cultivating soil 100 and further introducing immersion irrigation water, a certain amount of time is required for water to penetrate the exposed edge 41s₁ and 41s₂ of the plurality of non-bonded part 41s to cause selective temporal rupture of the lower end 13s due to the decrease in hydrogen bond strength between the cellulose. During a certain time until the selective temporal rupture occurs, irrigation water is temporarily stored in the so-called “dam” at the lower end 13s, which increases the water penetration and storage rate in the cultivating soil 100 filled by the immersion bottom irrigation style. According to the insertion part 1s of the cultivation member of the 7th embodiment, at the time of planting, the weight of the cultivating soil 100 filled between one U-shaped main wall 10s of the insertion part 1s enables easy and surely insertion of the insertion part 1s to the bottom of the 210 planting furrows of the planting place of the insertion part 1s. After planting the plants 300, the lower end 13s is selectively ruptured over time by the expansion pressure of one U-shaped main wall 10s of the insertion part 1s due to the filled cultivating soil 100 and the penetration of water into the exposed edge 41s₁ and 41s₂. As a result, irrigation water penetrates from the open lower end 13s to the ground 200 further below without horizontal diffusion along the way. Therefore, the plant root system 301 of the planted plant selectively extends from the open lower end 13s to the ground 200 further below due to the root hydrotropism. Therefore, according to the insertion part 1s of the cultivation member of the 7th embodiment, it is possible for the plant root system 301 to reach the stable soil layer in the shortest possible distance at an early stage with a small amount of irrigation, and it also has the remarkable effect of preventing root curling of the plant root system 301.

### =Cultivation System=

The cultivation system for the 7th embodiment of the present invention is shown in FIG. 24, wherein the right side end 16s₁ of the first insertion part 1s₁ and the left side end 15s₂ of the second insertion part 1s₂ intersect to form a superimposed surface 18D. By having the left side end 15s₂ of the second insertion part 1s₂ intersect with the right side end 16s₁ of the first insertion part 1s₁ shown in FIG. 24 to form a superimposed surface 18D, a connected insertion part (181, 182) of cultivation member with an extended overall length can be formed. The first insertion part 1s₁ is inserted into the planting furrow 210, the second insertion part 1s₂ is superimposed and inserted into the right side end 16s₁ of the first insertion part 1s₁ to form a connecting superimposed surface 18D, and then the third insertion part 1s₃, . . . is intersected and inserted into the right side end 16s₂ of the second insertion part 1s₂ to form a connecting superimposed surface 18D, thereby creating a connecting insertion part (1s₁, 1s₂, 1s₃, . . . ) that can be used for planting furrows 210 of any length. As the length of the connecting insertion part (1s₁, 1s₂, 1s₃, . . . ) inserted into the planting furrow 210 becomes longer, the shielding effect from the external soil d by the openings on both side ends of the connecting insertion part (1s₁, 1s₂, 1s₃, . . . ) becomes negligible in practical use compared to the overall shielding effect of the connecting insertion part (1s₁, 1s₂, 1s₃, . . . ).

Another method of forming the non-bonded parts 41s at the lower end 13s is to form one composite water-shielding film equivalent to the structure shown in FIG. 23B, with the respective end faces of the respective first and second bottom regions facing each other. In this case, a pattern of recesses with a depth equal to the width of the non-bonded parts 41s may be provided in advance in one of the first or second bottom region, and either of the first or second bottom region without recesses may be joined by opposing them to form one composite water-shielding film, resulting in a plurality of intermittent joint 31s. Alternatively, the method may be to provide a pattern of recesses in each of the first or second bottom region with a depth that is half the width of the non-bonded 41s, and then bond the first and second bottom region in opposite directions to form one composite water-shielding film, resulting in a plurality of intermittent joint 31s. In the structure illustrated in FIGS. 23A to 23D, the insertion part 1s of the 7th embodiment of the cultivation member has a plurality of non-bonded part 41s and a plurality of bonded pars 31s arranged in a one-dimensional arrangement alternating in a break line at the lower end 13s, so that the lower end 13s is like a so-called “linear mesh”, which cessation of cultivating soil 100 and functions as a block dam for the cultivation soil 100 and irrigation water.

### (Variant of the 7th Embodiment)

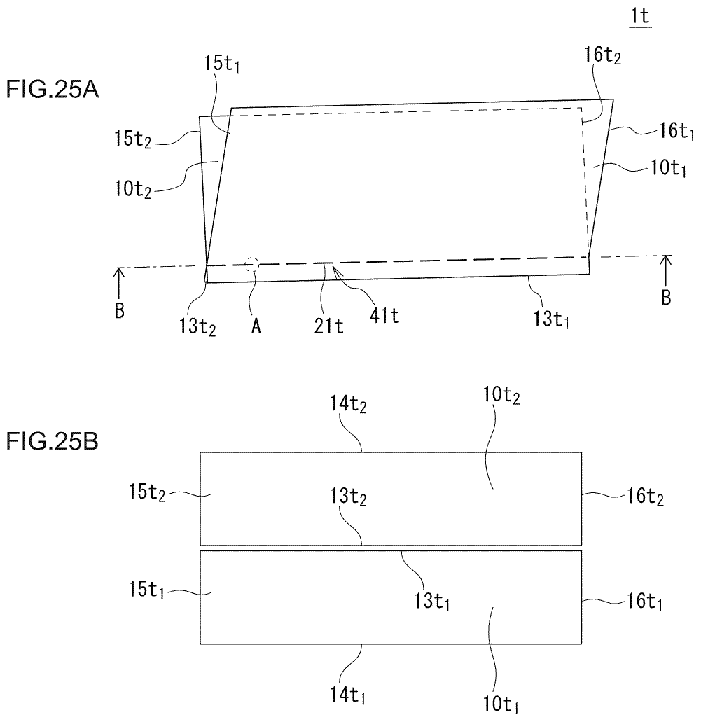

The insertion part 1t of the cultivation member for a variant of the 7th embodiment of the present invention comprises a V-shaped pseudo-sack with a missing bottom by means of one U-shaped main wall (10t₁, 10t₂) of the first main wall 10t₁ and the second main wall 10t₂ facing each other, as shown in FIG. 25A. Each of the first main wall 10t₁ and the second main wall 10t₂ is one water-shielding film or a composite water-shielding film consisting of any of the following: a laminated composite water-shielding film, a coated impregnated composite water-shielding film, and an internal paper composite water-shielding film. The second bottom region of the second main wall 10t₂ and the first bottom region of the first main wall 10t₁, as shown in FIG. 25A, are bonded to each other by a part of the second bottom region and the first bottom region, respectively, to form a V-shaped insertion part 1s, which is free at both ends. In FIG. 25A, the second bottom region is defined as a rectangular region that includes the lower end of the second main wall 10t₂ and the arrangement of sewing threads 21t parallel to this lower end, and the first bottom region is defined as a rectangular region that includes the lower end of the first main wall 10t₁ and the arrangement of sewing threads 21t parallel to this lower end. That is, the second main wall 10t₂, which is located on the far side in FIG. 25A, has a second bottom region, a third side 15t₂ orthogonal to the longitudinal direction of this second bottom region, and a fourth side end 16t₂ that is separated from one end defined by the third side end 15t₂ and is parallel and opposite to this one end.

The first bottom region of the first main wall 10t₁, located in front of the paper in FIG. 25A, is parallel and opposite to the longitudinal direction of the second bottom region of the second main wall 10t₂ and intermittently bonds a part of the second bottom side region at plurality of locations along the longitudinal direction of the second bottom region, forming an inverse V-shaped roof under the bonded part 41t. The first main wall 10t₁ has a first side 15t₁ opposite and separated from the third side end 15t₂ of the second main wall 10t₂, and further has a second side end 16t₁ opposite and separated from the fourth side end 16t₂ of the second main wall 10t₂. As in FIGS. 5 and 6A, etc., cultivating soil 100 for growing plants is filled between the first and second main walls 10t₁ and 10t₂, which comprise the V-shaped insertion part 1t with both open ends. The V-shaped insertion part 1t with both open ends are inserted inside the 210 planting furrow shown in FIGS. 5 and 6A, etc. In a part of the lower end 13b of each of the first main wall 10t₁ and the second main wall 10t₂, where the sewing threads 21t intermittently bond each other penetrate each of the first main wall 10t₁ and the second main wall 10t₂, a plant fiber layer is slightly exposed around the sewing threads 21t. The point where the insertion part 1t of the cultivation member pertaining to the variant of the 7th embodiment differs from the insertion part 1s of the cultivation member pertaining to the 7th embodiment is the structure of the lower end 13t.

The sewing with sewing thread 21t may be, for example, sewing by a sewing machine. In the case of sewing machine sewing, the sewing thread 21t as the upper thread, and the sewing thread 21t as the lower thread, are sewn while intersecting between the opposite first main wall 10t₁ and second main wall 10t₂. The sewing thread 21t may also be sewn by hand, such as by wave stitching. In either case, a plurality of through holes is made by a needle penetrating the composite water-shielding film during sewing, and the plant fiber layer is slightly exposed around the sewing threads 21t of the plurality of through holes.

That is, a gap space exists between the composite water-shielding film and the periphery of the sewing threads 21t, respectively, and the sewing threads 21t pass through the plurality of through holes with redundancy, just as shown in FIGS. 12A and 12B. Between the upper surface of the second main wall 10t₂ and the sewing thread 21t, and between the lower surface of the first main wall 10t₁ and the sewing thread 21t, there is an open space so that the plurality of permeation channels (vertical water permeation channels) where the second main wall 10t₂ and the first main wall 10t₁ are not tightly adhered and fixed can be configured gaps (non-bonded areas), so that the sewing thread 21t passes through. Since the sewing threads 21t are loosely sewn with an open space, when a particle such as a grain of sand is inserted between the second main wall 10t₂ and the first main wall 10t₁ and pressure is applied from the inside, a gap is created between the second main wall 10t₂ and the first main wall 10t₁ located in the non-bonded parts. Between the adjacent non-bonded parts, bonded parts are formed intermittently closely and tightly bonds the second bottom region of the second main wall 10t₂ and the first bottom region of the first main wall 10t₁. The plurality of non-bonded parts and the plurality of bonded parts are arranged alternately and periodically. The insertion part 1s of the 7th embodiment of the cultivation member describes a structure in which slits are opened in the flexible water-shielding film along the centerline of the first and second bottom regions of the U-shaped main wall 10s to form the non-bonded part 41s. Then, in the insertion part 1s, plurality of non-bonded part 41s and plurality of bonded parts 31s are arranged alternately and periodically. In the insertion part 1s of the 7th embodiment of the cultivation member, an example was described in which the plant fiber base material layer of the three-layer laminated structure is exposed along the centerline of the first and second bottom regions of the main wall 10s, in case the flexible water-shielding film is of a three-layer laminated structure.

In contrast, in the insertion part 1t of the cultivation member for the variant of the 7th embodiment, the surfaces of certain parts of the first and second bottom regions of the flexible water-shielding film are in close contact with each other and form a bonding part. If we focus only on the lower part of the insertion part 1t, water, fine sand grains, and other particles introduced from the upper part of the insertion part 1t leak partly to the lower part (outside) through plurality of permeation channels (vertical water permeation channels) generated in the non-bonded parts. On the other hand, the dimensions and shape of the non-bonded parts are designed in such a way that clumps of soil, etc. that have been agglomerated with water do not leak out of the plurality of permeation channels of the non-bonded parts to the outside, but are retained inside the insertion part 1t and remain stored. If we focus at the both side ends of the insertion part 1t as a stand-alone structure, the left (15t₁, 15t₂) and right (16t₁, 16t₂) side ends of the insertion part it are open and not strictly a storage structure. Therefore, it appear that some of the water, fine sand grains and other particles introduced from the top of the insertion part it will drop out of the left side ends (15t₁, 15t₂) and right side ends (16t₁, 16t₂), and some of the soil clods and other particles agglomerated with water will also drop out of the left side ends (15t₁, 15t₂) and right side ends (16t₁, 16t₂).

However, as with the insertion part 1s of the 7th embodiment of the cultivation member, by limiting the width of the planting furrow 210 to a dimension that can accommodate the first main wall 10t₁ and second main wall 10t₂ of the insertion part 1t, the walls of the planting furrow 210 act as part of the sack preventing lumps of soil and the like from falling out, and water, particles such as fine sand grains, and lumps of soil that have coagulated with water are less likely to fall out of the insertion portion 1t. The insertion part 1t becomes a plant growing container in which cultivating soil 100 is filled between the first main wall 10t₁ and the second main wall 10t₂ and irrigated, enabling plants to be grown from seeds and seedlings.

When the insertion part 1t of the cultivation member for the variant of the 7th embodiment is composed of a composite water-shielding film, as shown in FIG. 25A, the intermittent joint is a part of the lower end 13t, so that the exposed edge 41t of the intermittent joint absorbs the moisture collected at the lower end 13t. As moisture continues to permeate through the exposed edge of the intermittent joints, selective temporal rupture of the hydrogen bonds between the plant fibers that are consisted of the composite water-shielding film progress. The weight of the irrigated cultivating soil 100 is applied to the lower end 13t, and selective temporal rupture proceeds from the plant fiber base layer of the composite water-shielding film near the intermittent joint. If the insertion part 1t is composed of one water shielding film, selective temporal rupture will proceed due to the hydrotropism expansion effect already mentioned. As a result, the ability of the intermittent joint to retain cultivating soil 100 and irrigation water is lost, and the plant root system 301 planted in the insertion part 1t is more easily extended toward the bottom of the insertion part 1t. When the insertion part 1t is inserted inside the planting furrow 210 similar to that shown in FIGS. 5 and 6a, etc., the selective elongation of the plant root system 301 toward the lower part of the planting furrow 210 is facilitated, similar to the insertion part 1s of the cultivation member of the 7th embodiment. By adjusting the thickness of the sewing thread 21t and the sewing interval, it is possible to adjust the rupture resistance of the intermittent joint and the start time of the selective temporal rupture.

In addition, the selective temporal rupture of the intermittent joints may be adjusted so that tension is applied to the sewing thread 21t serving as the upper thread and the sewing thread 21t serving as the lower thread due to the expansion of the first main wall 10t₁ and the second main wall 10t₂ of the insertion part 1t caused by filling with the cultivating soil 100, and when this tension exceeds the rupture resistance of the composite water-proof film, the composite water-shielding film is cut by the sewing threads 21t and 21b, causing selective temporal rupture. In the case of hand sewing, it may be adjusted so that the composite water-shielding film is cut and selectively ruptured over time with only sewing thread 21t instead of the two types of sewing threads.

In addition to the hydrotropism expansion effect, the method can also be adopted in which the strength of the sewing thread 21t is weakened, and the sewing thread 21t itself is selectively ruptured over time due to the expansion of the first main wall surface 10t₁ and the second main wall surface 10t₂ of the insertion part 1t caused by filling with cultivating soil 100, thereby decomposing and opening the intermittent joints. In the case of sewing machine sewing, the sewing thread 21t also contributes to selective temporal rupture, as shown in FIGS. 12A and 12B. As a method to reduce the strength of sewing thread 21t, a water-soluble thread can be used for sewing thread 21t. Water-soluble yarns include polyvinyl alcohol-based or alginate metal salts as water-soluble materials. These materials can be spun and further twisted as needed to obtain the sewing yarn 21t. Especially preferred are water-soluble polyvinyl alcohol-based yarns. The water dissolution time can be controlled by adjusting the degree of saponification and the thickness of the sewing threads according to the water content of the cultivating soil 100, the ground temperature, the growing period, and the size of the insertion part 1t. Especially for polyvinyl alcohol-based yarns, because the water dissolution temperature can be changed by the degree of saponification, irrigation of cultivating soil 100 at a certain temperature or higher allows selective temporal rupture of intermittent joints, thereby increasing the options for selective temporal rupture methods.

In the insertion part 1t of the cultivation member for the variant of the 7th embodiment shown in FIG. 25A, the shape of the first main wall 10t₁ and the second main wall 10t₂, when nothing is filled between the first main wall 10t₁ and the second main wall 10t₂, is rectangular when viewed from the normal direction to the respective walls, but it may be a shape other than a rectangle. In the structure illustrated in FIG. 25A, the insertion part 1t of the cultivation member for the variant of the 7th embodiment, the bonded and non-bonded parts caused by sewing in the intermittent joint (see FIGS. 12A and 12B. The intermittent joints are alternately arranged in a so-called “linear mesh” and function as a damming of cultivating soil 100 and irrigation. The length of the non-bonded parts defined on both sides is defined as the “action length” and the width orthogonal to the action length in the middle parts of the action length is defined as the “buffer width” of the non-bonded parts. Compared to when the insertion part it is not filled with anything, the buffer width is enlarged and the action length is reduced when the insertion part 1t is filled with cultivating soil 100. The change in the shape of the insertion part 1t is balanced by the tension of the composite water-shielding film and the expansion force caused by the internal filling of the insertion part 1t with cultivating soil 100. When a large amount of cultivating soil 100 is filled, the buffer width widens greatly due to the pressing force of the cultivating soil 100, and the plurality of permeation channels (vertical moisture permeation channels) generated in the non-bonded areas shown in FIGS. 12A and 12B become “drum belly packed with cultivating soil 100”.

When the insertion part it begins to be filled with cultivating soil 100, particles, etc. smaller than the sieve of the plurality of permeation channels generated in the non-bonded parts shown in FIGS. 12A and 12B may drop out from the central part of the plurality of channels generated, but the actual amount of cultivating soil 100 particles that fall out is negligible because the particles agglomerate together to form larger clumps due to the interaction of the particles with each other and the pressing force. Also, once the cultivation soil 100 is deposited at the intermittent joints of the insertion part 1t, very little of the cultivation soil 100 falls out of the plurality of penetration channels during the subsequent filling of the cultivation soil 100. The residual deposition rate can also be increased by increasing the compaction or humidification of the cultivating soil 100. The length of the plurality of penetration channels shown in FIGS. 12A and 12B should be between 5 mm and 1.5 cm from the viewpoint of balancing the retention of cultivating soil 100 and irrigation water leakage.

Irrigation of cultivating soil 100 in the insertion part 1t filled with cultivating soil 100 causes water to penetrate downward through the cultivating soil 100, temporarily block at the intermittent joints, flow back again into the cultivating soil 100 in the upper part, and leak out through the plurality of permeation channels in the non-bonded part shown in FIGS. 12A and 12B. Generally in top irrigation of seedling containers, water channels are formed inside the cultivation soil 100 in proportion to the grain size of the soil particles, and water tend to leak out from the bottom without fully penetrating the entire cultivating soil 100. Therefore, to achieve both high water penetration rate into the cultivating soil 100 and water conservation rate, immersion bottom irrigation in which the seedling container is immersed in a water tank from the bottom, is effective, and even in conventional seedling pots having a bottom, pseudo immersion bottom irrigation is generated by water that stays on the bottom. Compared to conventional seedling pots with bottoms, the insertion part it is more effective for pseudo-bottom irrigation because the cultivating soil 100 is densely compacted and accumulated in the small intermittent joints of the insertion part 1t, so that the blocked water reaches the top of the cultivating soil 100 and stays there for a long time, enabling both a high water penetration rate into the cultivating soil 100 and water conservation rate. Since the water stays for a long period of time in the cultivating soil, it is possible to achieve both the high water penetration and irrigation rate.

Any kind of soil can be used for the cultivating soil 100 and the soil used as a weight to fill the insertion part 1t of the cultivation member for the variant of the 7th embodiment, and it can be the same composition and material as the insertion part 1s of the cultivation member of the 7th embodiment. Suitable plants to be planted when growing seedlings using the insertion part 1t of the cultivation member in the variant of the 7th embodiment are the same as those of the insertion part 1s of the cultivation member pertaining to the 7th embodiment. The series of steps involved in the method of planting plants using the insertion part 1t at the target site (planting place) may be the same as the series of steps shown in the planting method using the insertion part 1s of the cultivation member for the 7th embodiment.

The following effects are produced by using the insertion part 1t of the cultivation member in the variant of the 7th embodiment in the process of planting plants, in the same manner as the insertion part 1s of the cultivation member for the 7th embodiment.

(1) By preparing a rolled member in advance and cutting the rolled member on-site (at the planting place) to create the insertion part 1t according to the depth of the 210 planting furrows in the ground 200, the size of the insertion part it can be adapted to any depth of the 210 planting furrows. Less waste material is generated.

(2) Even in a relatively deep and narrow planting furrow 210 of the ground 200, the tip of the intermittent joint of the insertion part 1t can be easily and safely inserted to the bottom of the planting furrow 210 by placing a weight of soil in the intermittent joint of the insertion part 1t.

(3) Since it deforms following the deformation of the planting furrow 210 and cultivating soil 100, it has a high resistance to rupture in the unirrigated furrow.

(4) By selectively rupture and opening the intermittent joints of the inserting portion 1t over time due to irrigation and the weight of the cultivating soil 100, the plant root system 301 can selectively extend from the intermittent joints downward in the planting furrow 210. The plant root system 301 does not cause root curling.

(5) Irrigation water can be saved because irrigation water does not permeate except at the intermittent joints of the insertion part 1t, but only from the plurality of penetration channels that occur at the non-bonded part.

In the insertion part 1t of the cultivation member of the variant for the 7th embodiment, the through holes of the composite water-shielding film formed by a specific mechanical means such as a sewing machine is exposed plant fibers having hydroxyl group, so water easily penetrates, and the hydrogen bonding strength between the cellulose of the main component of plant fibers, is reduced by the penetrated water, and causes selective disruption of the fibers over time. The bonding force of the intermittent joint itself can be reduced by minimizing the area of the bonding parts of the intermittent joint of the insertion part 1t can be further reduced by exposing the plant fibers by certain mechanical means such as a sewing machine and by water penetration due to irrigation, etc.

In other words, the insertion part 1t of the cultivation member in the variant of the 7th embodiment is configured to rupture and open the intermittent joints of the insertion part 1t after the plant is planted, before the composite water-shielding film itself ruptures. After introducing cultivating soil 100 and irrigation into the insertion part 1t, a certain amount of time is required for the selective and temporal rupture of the intermittent joints to occur due to the reducing of the hydrogen bonding force between the cellulose as a result of the water permeating into the plurality of non-bonded parts 41t. During the time before selective temporal rupture occurs, irrigation water is temporarily stored in the so-called “dam” of the intermittent joint, so the rate of water penetration and water storage in the cultivating soil 100 filled in the insertion part 1t is improved by the bottom irrigation style. According to the insertion part 1t of the cultivation member of the variant of the 7th embodiment, at the time of planting, the weight of the cultivating soil 100 filled between the first main wall surface 10t₁ and the second main wall surface 10t₂ of the insertion part it enables easy and sure insertion of the tip of the insertion part 1t into the bottom of the planting furrow 210 of the cultivating place. After the plant 300 is planted, the expansion pressure of the first main wall 10t₁ and second main wall 10t₂ of the insertion part 1t due to the filled cultivating soil 100 and the penetration of water such as irrigation cause the intermittent joints to rupture selectively over time, and the irrigation penetrates to the ground 200 further down from the open intermittent joints without horizontal diffusion in the middle. As a result, the plant root system 301 of the planted plant selectively extends from the open intermittent joints to the ground 200 below, according to the root hydrotropism, so that early arrival at the shortest distance to the stable soil layer is possible with a small amount of irrigation.

### (Other Embodiments)

Although the present invention has been described above by means of the first through 7th embodiment, etc., the description and drawings that form part of this disclosure should not be understood as limiting the invention. Various alternative embodiments, examples, and operational techniques will be apparent to those skilled in the art from this disclosure. It is also possible to combine the respective technical ideas described in each embodiment with each other. For example, the structure with the extension part 61 described in the second embodiment can be applied to and combined with the structures of the third through the 7th embodiment and related pluralities of variations, respectively. And when inserted inside a cylindrical planting furrow 210 as described in the 5th embodiment, the planting furrow 210 can be placed in the center of a circular depression. In the case of a circular depression, by forming a break line in the extension part 61 to give it a conical shape, it is possible to give the shape of the extension 61 a structure that can effectively collect irrigation and condensation water.

Similarly, the structure in which the insertion part 1q of the cultivation member described in the fifth variant of the 5th embodiment of the present invention is consist of a flexible water-shielding film with longitudinal folds and vertical wrinkles is also applicable to other variants of the 5th embodiment, the first to 4th embodiments and related plurality of variants, or the 6th and 7th embodiments and related plurality of are also applicable. Thus, of course, the present invention includes various embodiments, etc., which are not described here. Therefore, the technical scope of the present invention is defined only by the particulars of invention pertaining to the claims, which can be reasonably interpreted from the above description.

### DESCRIPTION OF THE REFERENCE NUMERALS

1, 1a, 1a₁ to 1a₇, 1b, 1c, 1d, 1e, 1f, 1g, 1i, 1p, 1q, 1r, 1s, 1t, 1u . . . insertion part, 1s₁ . . . first insertion part, 1s₂ . . . second insertion part, 1s₃ . . . third insertion part, 2 . . . coupling cultivation member, 10, 10i, 10q, 10r, 10s . . . main wall, 10a, 10f . . . circumferential main wall, 10t₁, 10d₁, 10s₁ . . . first main wall, 10t₂, 10d₂, 10s₂ . . . second main wall, 10f₁ . . . left auxiliary wall, 10f₂ . . . right auxiliary wall, 11i, 11r, 11s, 14a2, 14a . . . upper end, 13a, 13b, 13d, 13i, 13r, 13s, 13t . . . lower end, 15a, 15s . . . left side end, 15d₁, 15t₁ . . . first side end, 15d₂, 15t₂ . . . third side end, 15s₂ . . . left side end, 16a, 16s . . . right side end, 16d₁, 16t₁ . . . second side end, 16d₂, 16t₂ . . . fourth side end, 16s₁ . . . right side end, 18D . . . connecting superimposed surface, 18L₁ . . . first left auxiliary piece, 18L₂ . . . second left auxiliary piece, 18R₁ . . . first right auxiliary piece, 18R₂ . . . second right auxiliary piece, 19L . . . left closing mechanism, 19R . . . right closing mechanism, 21, 21t . . . sewing thread, 30, 30i, 30r, 30s . . . intermittent joint, 31a₁, 31a₂, 31d, 31s . . . bonded part, 33 . . . lifting mechanism, 34 . . . rotating mechanism, 41, 41a₁, 41a₂, 41d, 41s, 41t . . . non-bonded part, 41s₁, 41s₂, 42a . . . exposed edge, 51a, 51b . . . insertion container, 51c . . . component storage box, divider 53a . . . divider plate, 60 . . . laying member, 61 . . . extension part, 61a₁ to 61a₆ . . . joint, 63 . . . wire, 65 . . . through hole, 66a . . . first through hole, 66b . . . second through hole, 71 . . . auger, 73 . . . auger mounting cylinder, 75 . . . rotating mechanism, 77 . . . lifting mechanism, 100 . . . cultivating soil, 150 . . . transport means, 155 . . . towing 5 tool, 160 . . . cargo bed, 200 . . . ground, 210 . . . planting furrow, 250 . . . solar panel, 251a . . . lower support, 251b . . . upper support, 300 . . . plant, 301 . . . plant root system

1. A cultivation member comprising an insertion part that forms a storage structure, at least a part of which is surrounded by a wall made of a flexible water-shielding film and is inserted in an inside of a planting furrow formed by digging in a cultivating place,
wherein the insertion part has a non-planar bottom region,
the insertion part has an open state or a sliding mechanism in a part of the wall, and the shape of at least an upper part of an external shape defined by the storage structure can be deformed without increasing in-plane stress of the flexible water-shielding film, thereby increasing an internal volume,
a plurality of water penetration channels is arranged in a one-dimensional array in the bottom region, and
an inside of the insertion part is filled with cultivating soil, to which a plant is planted and grown.

2. The cultivation member according to claim 1, having a structure in which, when the plant is grown by irrigation, a part of the bottom region near the penetration channel selectively ruptures over time due to the irrigation.

3. The cultivation member according to claim 2, wherein the flexible water-shielding film forms two opposing surfaces facing each other in the bottom region, and an intermittent joint is formed between the two opposing surfaces via the penetration channel.

4. The cultivation member according to claim 3, wherein the planting furrow is formed by digging at the bottom of the recesses in the planting site and further comprises an extension part connected so that the cultivation member is continuous with the upper end of the insertion part, and the extension part is arranged on the slope facing the bottom of the recesses.

5. The cultivation member according to claim 3, wherein the sliding mechanism comprises superimposed surfaces of the flexible water-shielding films crossing each other from opposite directions.

6. The cultivation member according to claim 1, wherein the flexible water-shielding film is a composite water-shielding film made of hydrophobic material and plant fiber.

7. The cultivation member according to claim 1, wherein the flexible water-shielding film has a plurality of longitudinal folds.

8. A cultivation system comprising:
a ground formed by digging so that an opening of a planting furrow is located at a lower end of a sloping slope, which is in a cultivating place with an uneven slopes,
an insertion part of a cultivation member inserted in a form of a storage structure inside the planting furrow,
wherein the planting furrow has a depth that is at least five times greater than the furrow width, which is measured as the narrowest width on a cross-section cut vertically,
the insertion part is capable of increasing internal volume by deforming the shape of at least an upper part of an external shape defined by the storage structure without increasing in-plane stress of the flexible water-shielding film, due to an open state or a sliding mechanism in a part of the wall, and
an inside of the insertion part is filled with cultivating soil, to which a plant is planted and grown.

9. The cultivation system according to claim 8, further comprising an extension part connected to the upper end of the insertion part so that the cultivation member is continuous with the extension part, and the extension part is arranged on the slope.

10. The cultivation system according to claim 8, wherein a solar panel is arranged on at least part of the slope.

11. A planting method comprising the steps of:
digging a planting furrow so that the opening is located at the level of the lower end of the slope in a cultivating place with the slope,
inserting an insertion part having a storage structure made of a flexible water-shielding film into the planting furrow,
filling the cultivating soil into the insertion part,
seeding or planting a seed in the cultivating soil, and
irrigating on the planted seeds and seedlings,
wherein the planting furrow has a depth that is at least five times greater than the furrow width, which is measured as the narrowest width on a cross-section cut vertically,
the insertion part is capable of increasing internal volume by deforming the shape of at least an upper part of an external shape defined by the storage structure without increasing in-plane stress of the flexible water-shielding film, due an open state in a part of the wall or a sliding mechanism in a part of the wall.

12. A planting method comprising the steps of:
preparing an insertion part that forms a storage structure, at least a part of which is surrounded by a wall made of a flexible water-shielding film, and having a plurality of water penetration channels arranged in a one-dimensional array in the bottom region,
elevating and rotating an auger having an openable and closable drilling tip and a hollow part, drilling and inserting the auger into the ground of the cultivating place to form a planting furrow in the ground,
inserting the insertion part filled with cultivating soil in the hollow part from the opening of the insertion part located on the opposite side of the bottom region,
removing the auger from the ground while leaving the insertion part inside the hollow part,
planting seeds in the cultivating soil, irrigating through the opening, and allowing some of the water to leak out through the plurality of water penetration channels,
wherein the insertion part has a sliding mechanism on a part of the wall, and the shape of at least the upper part of the external shape defined by the storage structure can be deformed without increasing the in-plane stress of the flexible water-shielding film, thereby increasing the internal volume.
